(19) United States
(12) Patent Application Publication
(10) Pub. No.: US 2025/0193559 A1
(43) Pub. Date: Jun. 12, 2025

(54) COUPLING-INDEPENDENT, REAL-TIME WIRELESS RESISTIVE SENSING THROUGH NONLINEAR PT-SYMMETRY

(71) Applicants: CHAN ZUCKERBERG BIOHUB, INC., San Francisco, CA (US); THE BOARD OF TRUSTEES OF THE LELAND STANFORD JUNIOR UNIVERSITY, Stanford, CA (US)

(72) Inventors: Ada Shuk Yan Poon, Stanford, CA (US); Siavash Kananian, Stanford, CA (US); George Alexopoulos, Stanford, CA (US)

(21) Appl. No.: 18/036,088

(22) PCT Filed: Dec. 1, 2021
(86) PCT No.: PCT/US21/61472

§ 371 Date: May 9, 2023

Related U.S. Application Data
(60) Provisional application No. 63/119,872, filed on Dec. 1, 2020.

(51) Int. Cl. H04Q 9/00

(52) U.S. Cl. CPC H04Q 9/00

(57) ABSTRACT

An example system for passive sensing includes a coupled pair of resonators including a sensor resonator and a reader resonator, the sensor resonator including a resistor a loss associated with the resistor, and the reader resonator including a MOS cross-coupled pair that implements a nonlinear gain of the reader resonator via compressive saturation of negative resistance. An amplitude detector measures the amplitude of oscillations associated with the reader resonator, and the negative resistance is determined based on the measured amplitude of oscillations associated with the reader resonator when the measured amplitude reaches a steady state, i.e., when the gain of the reader resonator balances the loss of the sensor resonator. The resistance associated with the resistor of the sensor resonator may be determined based on the determined negative resistance. When the resistor is a resistive sensor, indications of measurements by the resistive sensor may be determined in this way.

### CROSS-REFERENCE TO RELATED APPLICATIONS

The present application is a U.S. National Phase of International Application No. PCT/US2021/061472, entitled “COUPLING-INDEPENDENT, REAL-TIME WIRELESS RESISTIVE SENSING THROUGH NONLINEAR PT-SYMMETRY”, and filed Dec. 1, 2021, which claims priority to pending U.S. Provisional Application No. 63/119,872, entitled “COUPLING-INDEPENDENT, REAL-TIME WIRELESS RESISTIVE SENSING THROUGH NONLINEAR PT-SYMMETRY”, and filed Dec. 1, 2020, the entirety of each which is incorporated herein by reference.

### FIELD OF THE DISCLOSURE

The present disclosure generally relates to systems and methods for resistive sensing.

### BACKGROUND

The background description provided herein is for the purpose of generally presenting the context of the disclosure. Work of the presently named inventors, to the extent it is described in the background section, as well as aspects of the description that may not otherwise qualify as prior art at the time of filing, are neither expressly nor impliedly admitted as prior art against the present disclosure.

Fully passive sensors consist of an antenna (inductor) and a sensing element, either in the form of a capacitor or a resistor, whose value varies in response to a measurable parameter. Therefore, fully passive sensors are much less costly and complex than their active counterparts. Fully passive sensors are measured through the magnetic coupling of a primary coil (reader coil) to the sensor coil. The fluctuations in the impedance profile of the reader correspond to variations in the sensor through which a sensor measurement can be performed. Measuring such impedance fluctuations conventionally requires bulky lab equipment, such as a vector network analyzer, to directly characterize the input impedance profile and its fluctuations. Such a technique therefore does not lend itself to the practical implementation of a fully functional, handheld sensing system. Additionally, such fluctuations vary with the measurement distance and orientation, making the measurement prone to errors at different distances/orientations.

It has been shown that a resonant reader (inductive-capacitive) which is tuned to the same resonant frequency as the sensor improves the sensitivity of the reader to such fluctuations. Further, it has been shown that if the loss in the sensor is balanced with equal gain in the reader, the resulting impedance fluctuations exhibit sharper features, and hence more accurate measurements can be made. Existing electronic systems adopt a variety of techniques to achieve these conditions, falling under two broad categories: those with forced excitation sources and those with nonlinear self-oscillating gain mechanisms. In the former, capacitance sweeps equate resonant frequencies while negative resistance tuning realizes gain/loss balance. Subsequent frequency sweeping of a complex excitation source, typically a network analyzer (VNA), provides sensing through the measurement of spectral fluctuations in the impedance profile, which are coupling dependent. Alternatively, a nonlinear gain allows for automatic gain/loss balance and self-oscillation, obviating the need to gain sweeping and forced excitation. Provided the initial gain induces exponential growth, the system undergoes transient evolution such that the steady-state gain automatically matches the evolving effective loss. A capacitance sweep then provides frequency-equalization, enabling capacitive sensing. The reliance on sweeping in both approaches prohibits real-time wireless sensing as each sweep point requires a finite transient settling time; a single-point sensing method is, therefore, desirable as it simplifies readout and achieves real-time operation.

### SUMMARY

The present disclosure provides a sensing method which enables real-time, distance/orientation immune, and robust measurement applied to resistive sensing. A system of two coupled resonators, one with an explicit resistor or loss (sensor side) and one with a negative resistor or gain (reader side) can exhibit either one or three resonant frequencies, depending on the coupling strength, k, and sensor resistance, meaning that there are one or three resonant frequencies, at which the imaginary part of the input impedance falls to zero. The impedance at these frequencies is therefore is purely real and related to the sensor resistance which can be exploited for resistive sensing. If the loss presented by the sensor resistance to the reader is balanced with equal gain through the negative resistance, the system turns into an oscillator and will self-oscillate at one of the above-mentioned resonant frequencies. A nonlinear gain implemented using an MOS cross-coupled pair enables this gain/loss equalization via compressive saturation of its negative resistance. As the amplitude of oscillations grows, the nonlinear resistance experiences compression until gain and loss in the circuit are balanced, at which point amplitude growth stops and becomes constant. The saturated negative resistance at the steady state will be equal to the real part of the input impedance at the frequency of oscillation; this value is equal to the sensor resistance when the sensor and reader resonators have equal inductance/capacitance values. The amplitude of oscillations, which determines the saturated negative resistance value, is directly related to the sensor resistance and can be simply measured by means of an amplitude detector.

Additionally, so long as the reader and sensor have equal resonant frequencies, beyond a certain coupling strength (primarily determined by the sensor resistance), the real part of the impedance remains constant with variations in the coupling strength. This enables a distance- and orientation-independent measurement of the sensor resistance. This coupling-independence is achieved when both sensor and reader have the same topology (series/series or parallel/parallel).

Moreover, self-oscillation still occurs when resonant frequencies are unequal and sensor measurements can be made, albeit with some error due to variations in distance (˜10% over the operation range −1 cm). The present disclosure provides a correction scheme based on making multiple discrete measurements of both the amplitude and frequency of self-oscillation at different distances between the reader and sensor in order to improve the k-dependence to ˜1% within the operation range ˜1 cm.

One of the main applications for this technology is in bedside and point-of-care health monitoring and sensing. Using this reader technology, a fully functional system for sensing vital signs, such as blood pressure, heartbeat, sweat and temperature can be realized. The sensors can be made out of wearable electronics which are flexible and stretchable. The reader can be a handheld device which the user can directly point to the sensor to do the measurement or can be placed in the user's surroundings, e.g. it can be embedded in a mattress for sleep monitoring or sleep-related studies. The reader can be designed such that it can interface to the cloud (using legacy technologies, such as BLE or WiFi) or interface to an edge device, such as a cellphone (using either BLE, WiFi or sound waves), so that the healthcare provider can have real-time access to patients health records. As this system can be used for a suite of different stretchable and wearable health monitoring and tracking sensors, a personal health body area network of sensors can be realized and supported using this approach.

Another application for this technology is in health-care consumer devices. Passive sensors offer low-cost and manufacturing simplicity as well as versatility in sensing parameter. For example, passive biosensors have emerged using Graphene-based field-effect transistors (GFETs) which can be used as an effective point-of-care tool for the rapid detection of the Coronavirus Disease COVID-19. Using this reader technology, a fully functional system for rapid self-testing of COVID-19 can be realized. Moreover, combined with other biosensors, the reader technology allows for simple, handheld measurement of user's health conditions. The reader can be a handheld device which the user can directly point to the sensor to do the measurement or can be placed in the user's surroundings. The reader can be designed such that it can interface to the cloud (using legacy technologies, such as BLE or WiFi) or interface to an edge device, such as a cellphone (using either BLE, WiFi or sound waves), so that the healthcare provider can have real-time access to patients health records.

Another major application is in food safety, where sensors can be designed to contain information about how well the product is handled or stored in transportation. Shoppers can use the proposed reader to interrogate the sensor and access the required information. In this case, the reader can be designed as a thin sticker attached to the smartphone which communicates directly to the phone and is powered using the NFC radio-frequency waves from the smartphone.

Compared to legacy hybrid (active/passive) sensor and reader systems which rely on NFC/RFID, the system provided herein offers simplicity in implementation. The sensor is fully passive, does not employ NFC/RFID protocols, and can be made with flexible/printable electronics, dramatically reducing the cost. The reader does not rely on legacy protocols, offering further cost and size reduction.

Second, existing electronic systems rely on a number of sweeps to perform sensing measurements. For example, in one existing electronic system, a manual sweep of negative resistance is required to guarantee gain/loss equalization, while in another implementation which is applied to capacitive sensing, the manual sweep of the reader resonance frequency is required to make sensor measurement. Multiple sweeps require a finite settling time to allow for system transients to decay and sensor measurements to be performed. The system provided herein offers real-time sensing which is distance and orientation immune. Additionally, error-correction algorithms to improve the measurement robustness in presence of non-idealities in the system (such as frequency-imbalance between the resonators) are provided herein.

The theoretical framework, nonlinear method, correction algorithm, and simple reader/sensor implementation provided herein ultimately offer an alternative to available technologies such as radio-frequency identification (RFID) and near-field communication (NFC), simplifying the measurement of fully passive sensors.

In an aspect, a system is provided, comprising: a coupled pair of resonators including a sensor resonator and a reader resonator, the sensor resonator including a resistor, and the sensor resonator having a loss associated with the resistor, and the reader resonator including a metal-oxide-semiconductor (MOS) cross-coupled pair, wherein the MOS cross-coupled pair is configured to implement a nonlinear gain of the reader resonator via compressive saturation of negative resistance; an amplitude detector configured to measure an amplitude of oscillations associated with the reader resonator; a processor; and a memory storing instructions, that, when executed by the processor, cause the processor to: receive the measured amplitude of oscillations associated with the reader resonator from the amplitude detector; determine the negative resistance provided by the MOS cross-coupled pair based on the measured amplitude of oscillations associated with the reader resonator when the measured amplitude of oscillations associated with the reader resonator reaches a steady state; and determine the resistance associated with the resistor of the sensor resonator based on the determined negative resistance provided by the MOS cross-coupled pair when the measured amplitude of oscillations associated with the reader resonator reaches the steady state.

In some examples, the sensor resonator has a series topology and the reader resonator also has a series topology. Moreover, in some examples, the sensor resonator has a parallel topology and the reader resonator also has a parallel topology.

Furthermore, in some examples, the resistor of the sensor resonator is a resistive sensor. Additionally, in some examples, the instructions, when executed by the processor, further cause the processor to determine an indication of a measurement made by the resistive sensor based on the determined negative resistance provided by the MOS cross-coupled pair when the measured amplitude of oscillations associated with the reader resonator reaches the steady state.

Moreover, in some examples, the sensor resonator further includes a capacitor. Furthermore, in some examples, the capacitor is a capacitive sensor. Additionally, in some examples, the instructions, when executed by the processor, further cause the processor to determine an indication of a measurement made by the capacitive sensor based on the determined negative resistance provided by the MOS cross-coupled pair when the measured amplitude of oscillations associated with the reader resonator reaches the steady state.

Additionally, in some examples, the system further includes a divider configured to measure a frequency of oscillations associated with the reader resonator. Furthermore, in some examples, the instructions, when executed by the processor, further cause the processor to: receive respective measured amplitudes of oscillations associated with the reader resonator from the amplitude detector when the reader resonator and sensor resonator are placed at each of a plurality of distances apart; receive respective measured frequencies of oscillations associated with the reader resonator from the divider when the reader resonator and sensor resonator are placed at each of the plurality of distances apart; and determine an error in the determined resistance based on the respective measured amplitudes and respective measured frequencies at each of the plurality of distances apart.

In another aspect, a method is provided, comprising: implementing, by a metal-oxide-semiconductor (MOS) cross-coupled pair, a nonlinear gain in a reader resonator, of a coupled pair including the reader resistor and a sensor resistor, via compressive saturation of negative resistance, wherein the sensor resonator includes a resistor and has a loss associated with the resistor; and measuring, by an amplitude detector, an amplitude of oscillations associated with the reader resonator; determining, by a processor, the negative resistance provided by the MOS cross-coupled pair based on the measured amplitude of oscillations associated with the reader resonator when the measured amplitude of oscillations associated with the reader resonator reaches a steady state; and determining, by a processor, the resistance associated with the resistor of the sensor resonator based on the determined negative resistance provided by the MOS cross-coupled pair when the measured amplitude of oscillations associated with the reader resonator reaches the steady state.

In some examples, the sensor resonator has a series topology and the reader resonator also has a series topology. Moreover, in some examples, the sensor resonator has a parallel topology and the reader resonator also has a parallel topology.

Additionally, in some examples, the resistor of the sensor resonator is a resistive sensor. Moreover, in some examples, the method further includes determining an indication of a measurement made by the resistive sensor based on the determined negative resistance provided by the MOS cross-coupled pair when the measured amplitude of oscillations associated with the reader resonator reaches the steady state.

Furthermore, in some examples, the sensor resonator further includes a capacitor. Additionally, in some examples, the capacitor is a capacitive sensor. Moreover, in some examples, the method further includes determining an indication of a measurement made by the capacitive sensor based on the determined negative resistance provided by the MOS cross-coupled pair when the measured amplitude of oscillations associated with the reader resonator reaches the steady state.

Additionally, in some examples, the method further includes measuring, by a divider, a frequency of oscillations associated with the reader resonator. Furthermore, in some examples, the method further includes receiving respective measured amplitudes of oscillations associated with the reader resonator from the amplitude detector when the reader resonator and sensor resonator are placed at each of a plurality of distances apart; receiving respective measured frequencies of oscillations associated with the reader resonator from the divider when the reader resonator and sensor resonator are placed at each of the plurality of distances apart; and determining an error in the determined resistance based on the respective measured amplitudes and respective measured frequencies at each of the plurality of distances apart.

### BRIEF DESCRIPTION OF THE DRAWINGS

The figures described below depict various aspects of the systems and methods disclosed herein. Advantages will become more apparent to those skilled in the art from the following description of the embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive. Further, wherever possible, the following description refers to the reference numerals included in the following figures, in which features depicted in multiple figures are designated with consistent reference numerals.

FIG. 1A illustrates an example of how forced excitation methods sweep a capacitance, a negative resistance, and the excitation frequency to induce measurable spectral changes in impedance profiles.

FIG. 1B illustrates an example of how a non-linear gain (NLG) element reduces complexity, requiring only one sweep for resonant frequency-based capacitive sensing.

FIG. 1C illustrates an example of how the resistive sensing method provided herein obviates sweeping through constant operation at exact PT-symmetry. As shown in FIG. 1C, amplitude measurements identify changes in the effective resistance, R_{eff}, due to fluctuations in the sensor resistance, R₂.

As shown in FIGS. 1A-1C, red boxes indicate the sensing element.

FIG. 2A illustrates real modes (or, resonance frequencies), ω_{λ}, vs. κ, with ω₂=1.1ω₁ and γ₂=0.2.

FIG. 2B illustrates a three-dimensional plot of ω_{λ} for ω₂=ω₁ versus κ and γ₂, with slice showing specific solutions for γ₂=0.2.

FIG. 2C illustrates normalized effective resistance,

$$\frac{{R}_{e f f}}{{R}_{2}} ,$$

vs. κ for ω₂=1.1ω₁ and γ₂=0.2.

FIG. 2D illustrates a three-dimensional plot of

$$\frac{{R}_{e f f}}{{R}_{2}}$$

for ω₂=ω₁ versus κ and γ₂, with slice showing specific solutions for γ₂=0.2; note that beyond κ_{EP}, R_{eff(h,l)} coincide.

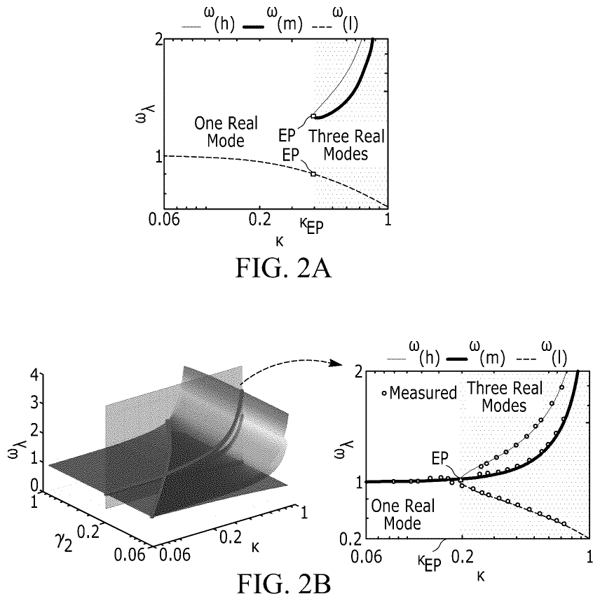

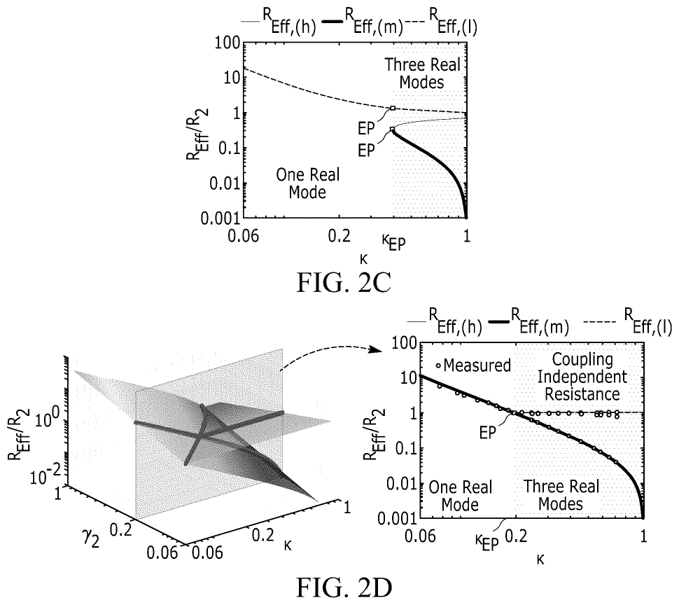

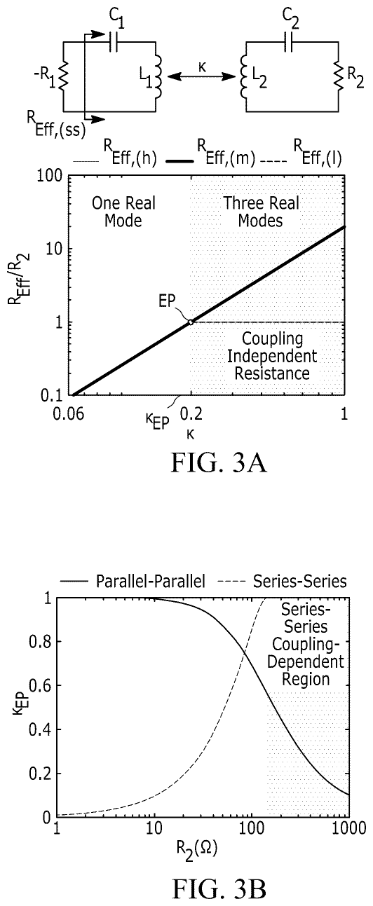

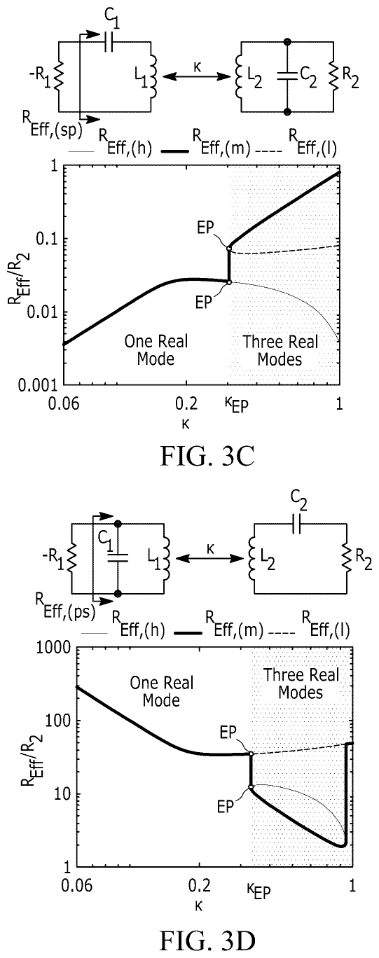

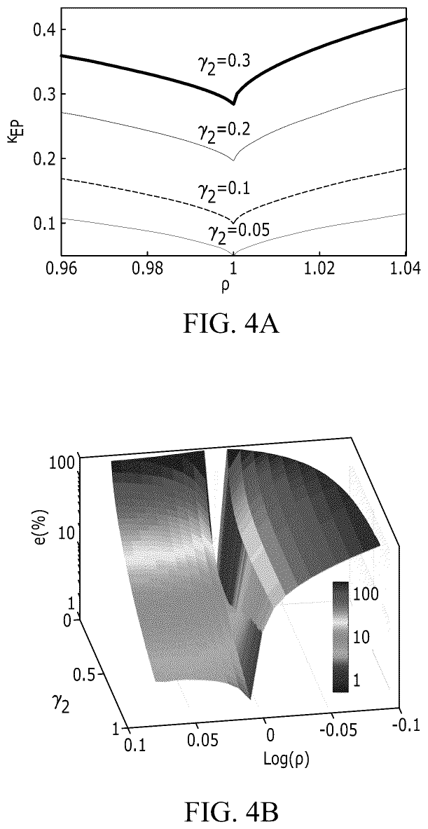

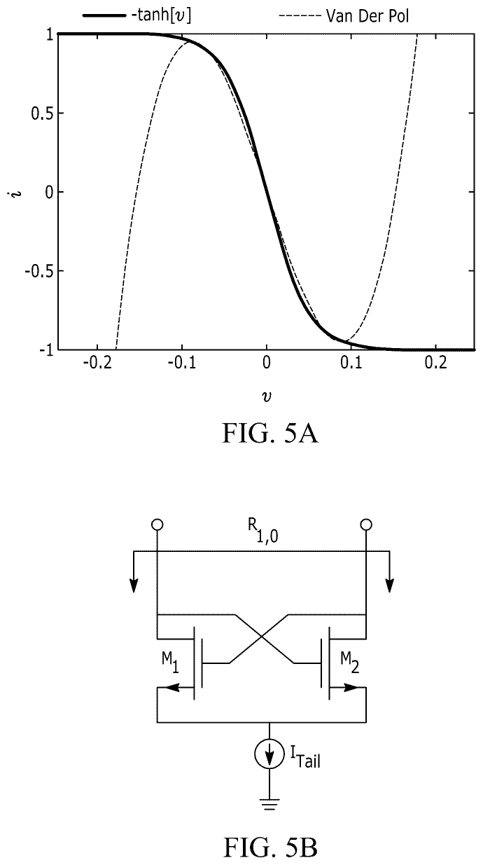

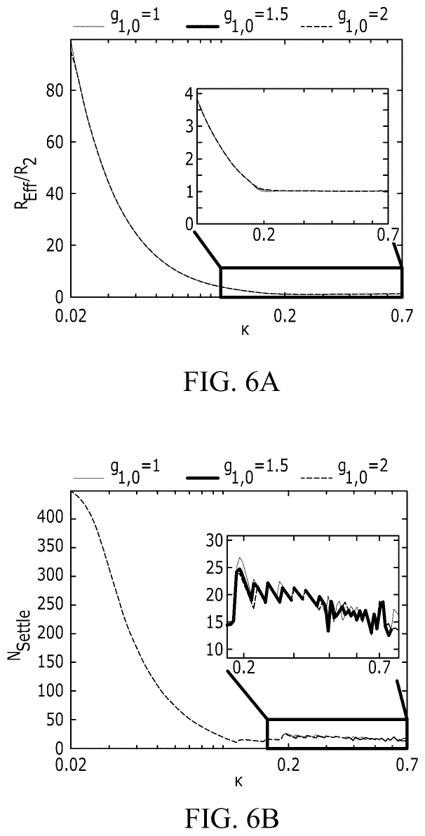

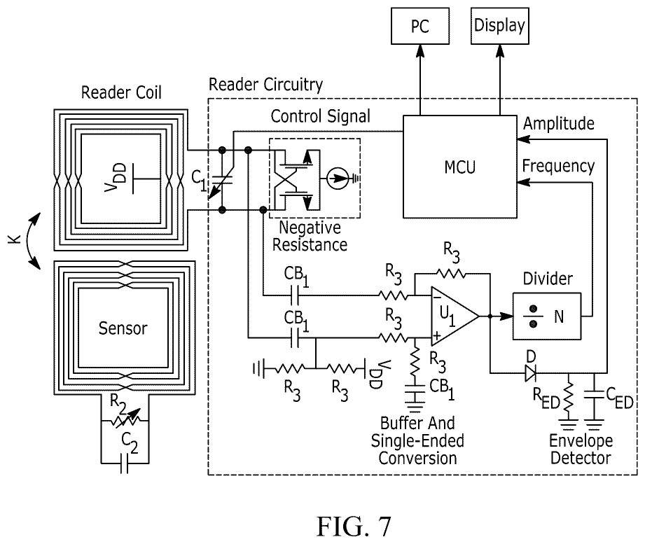

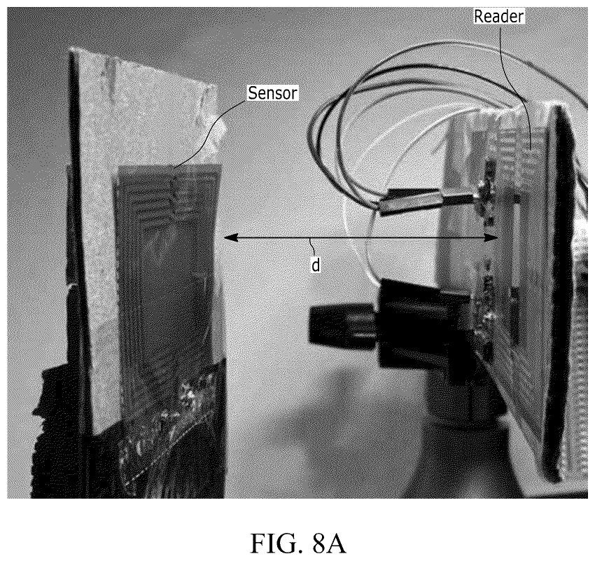

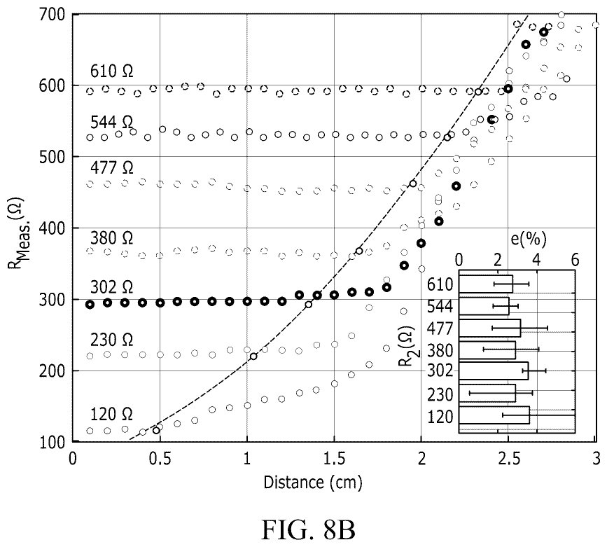

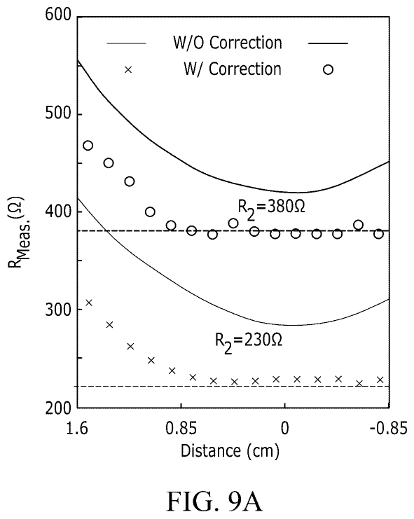

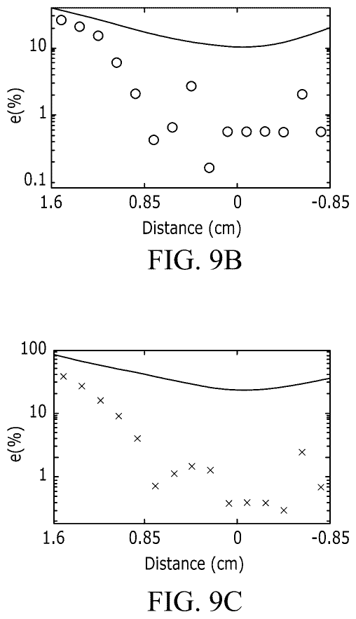

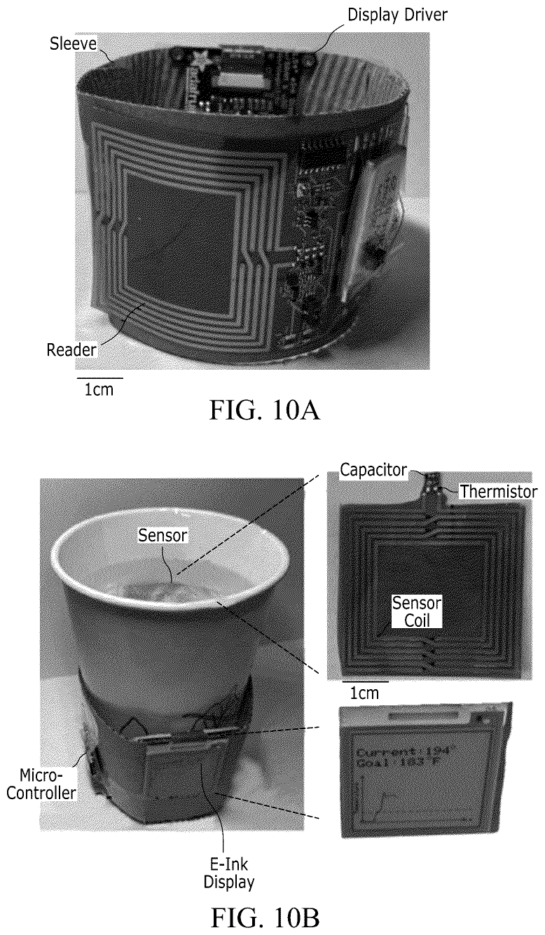

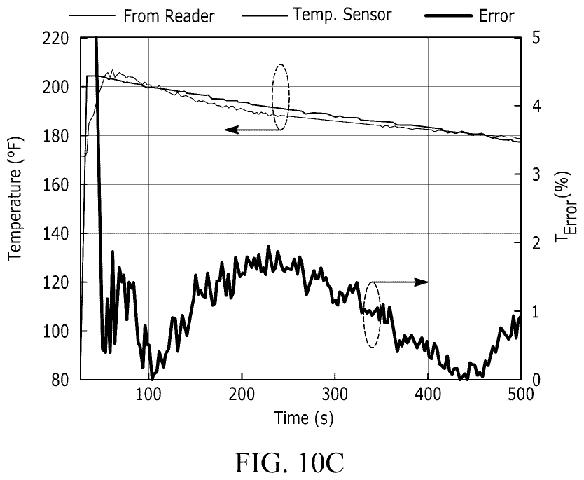

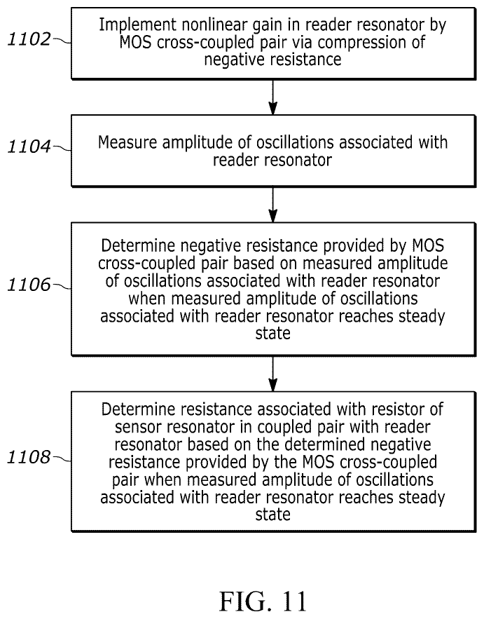

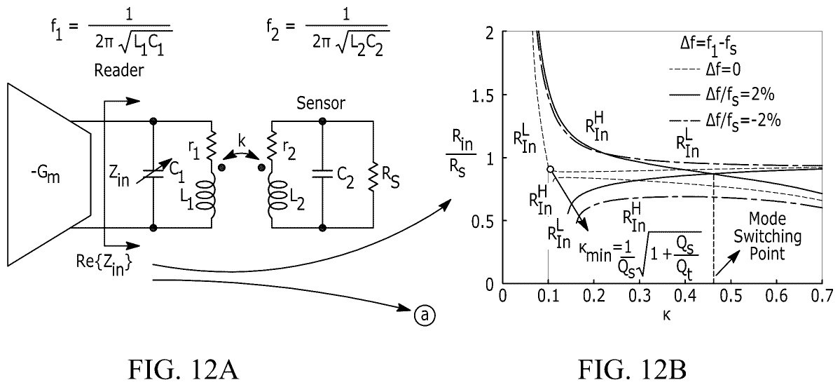

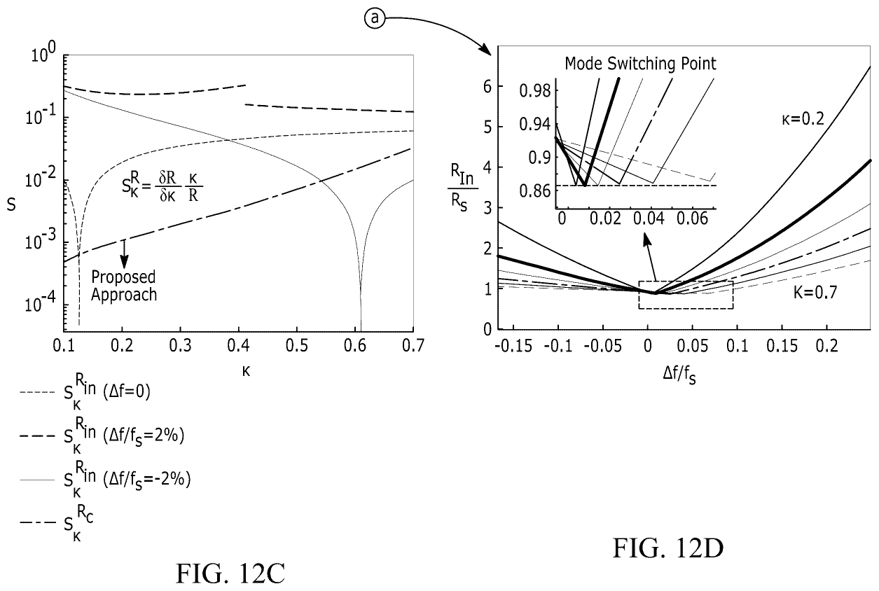

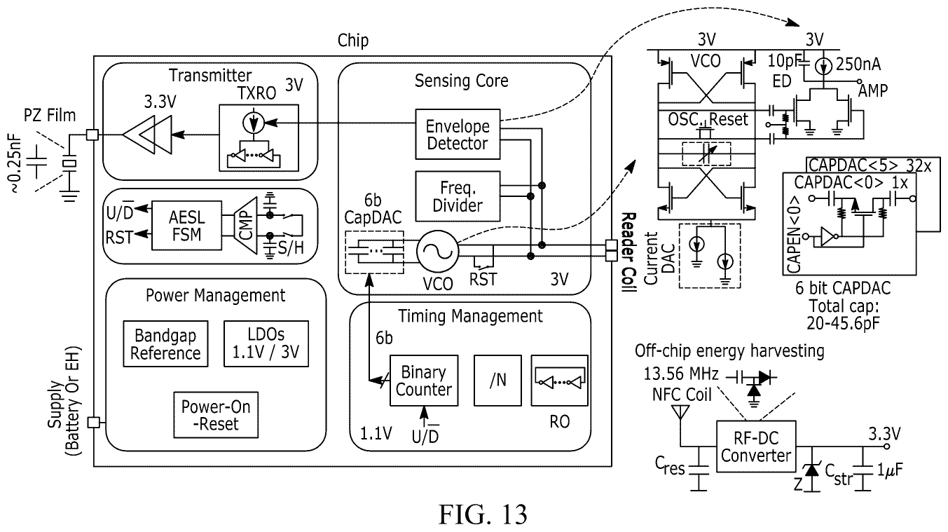

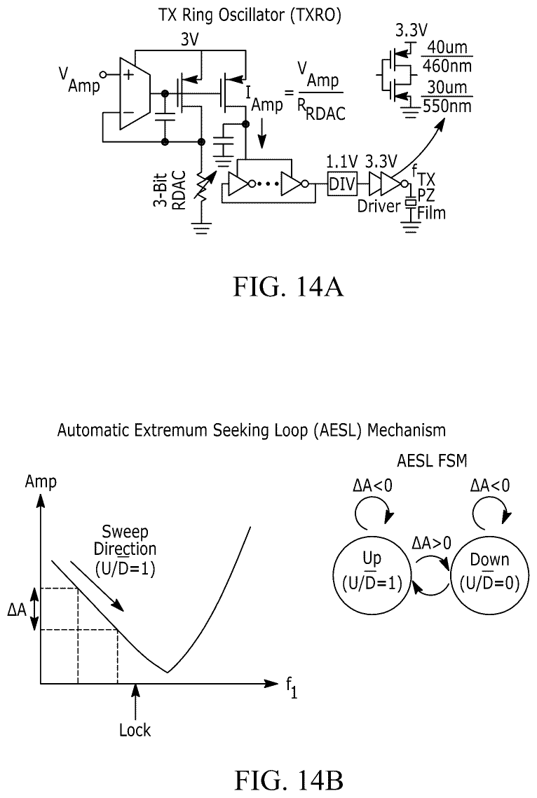

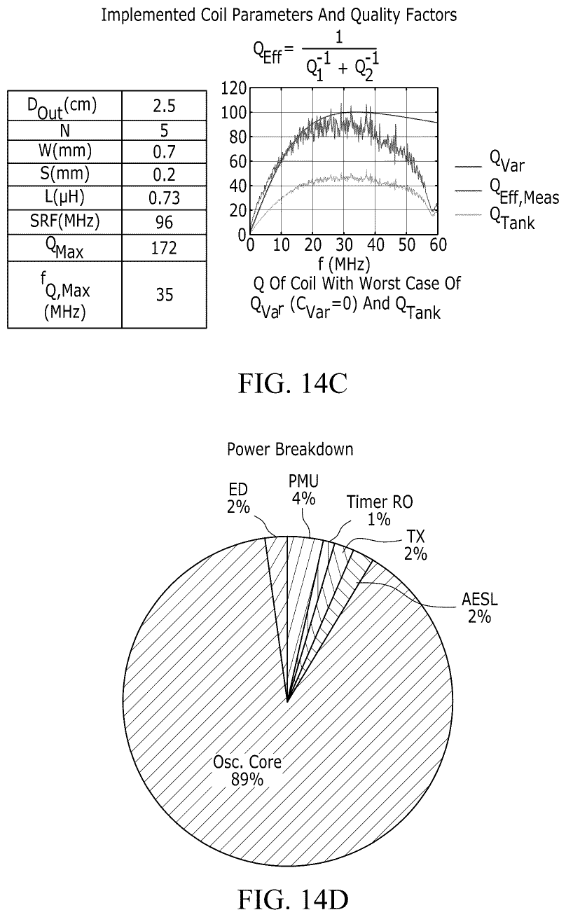

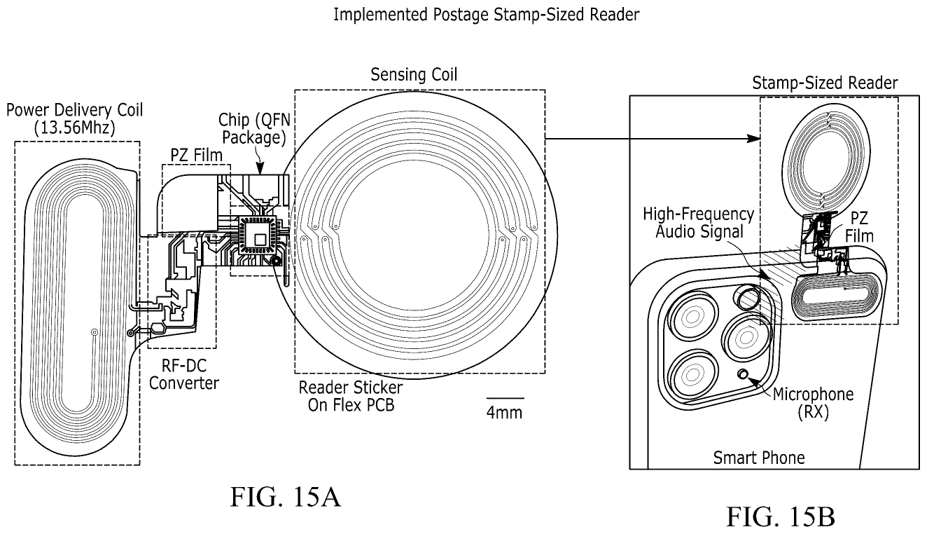

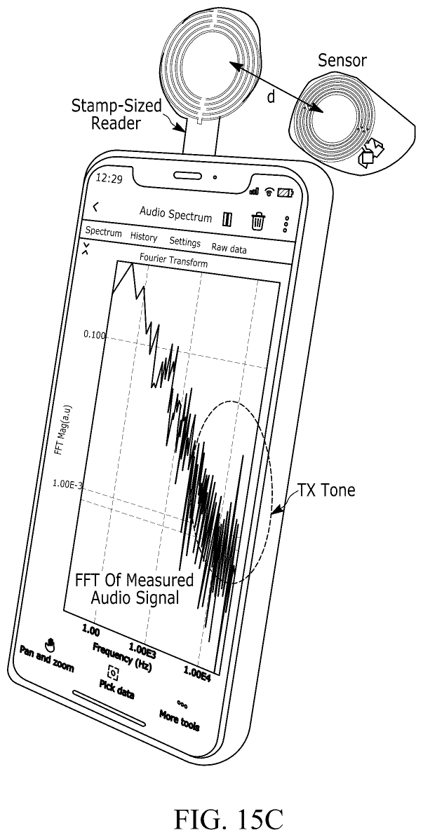

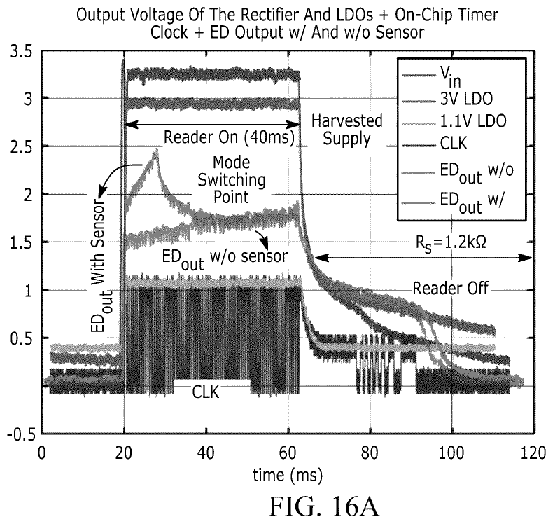

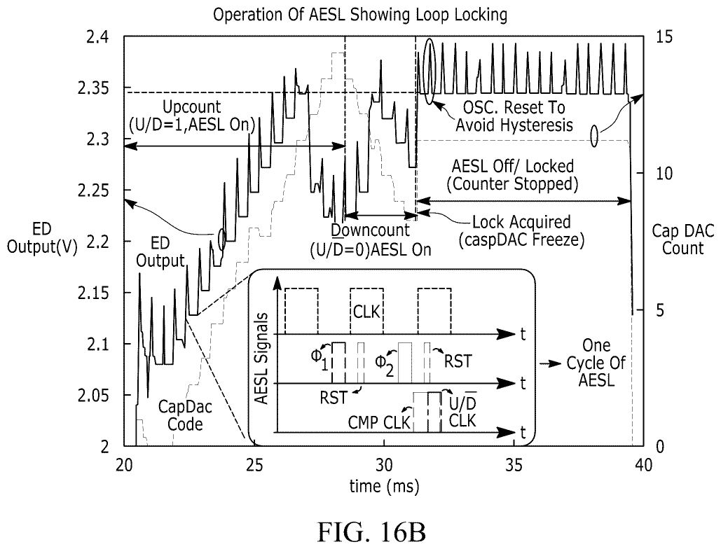

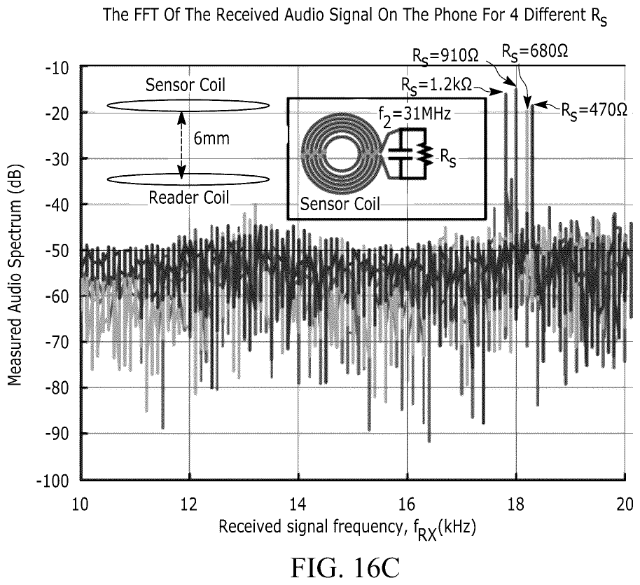

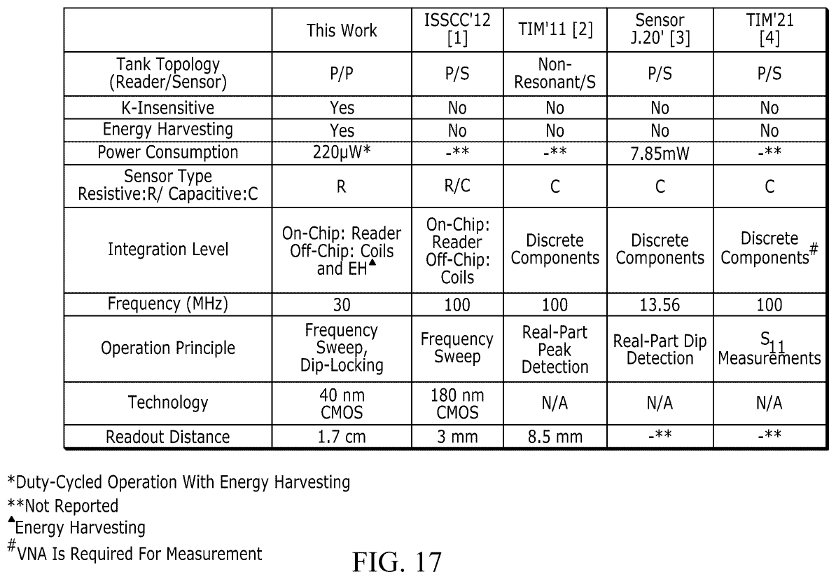

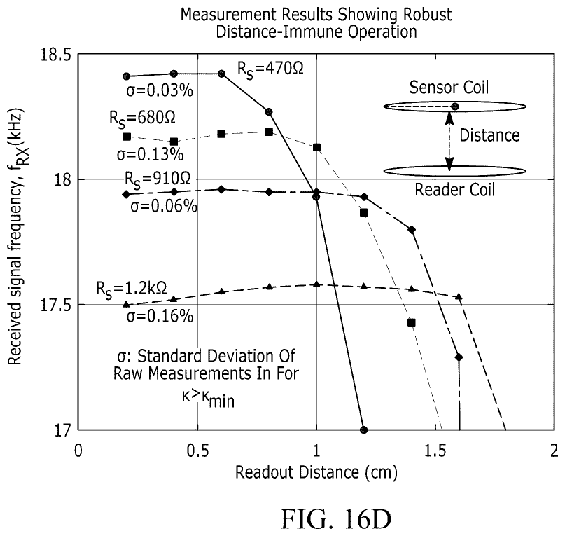

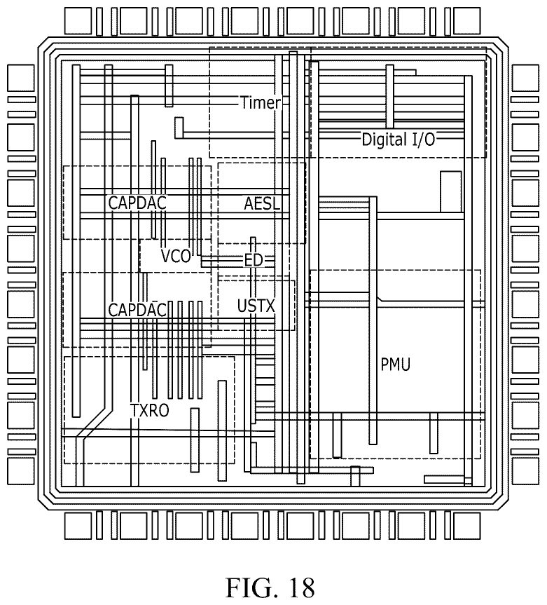

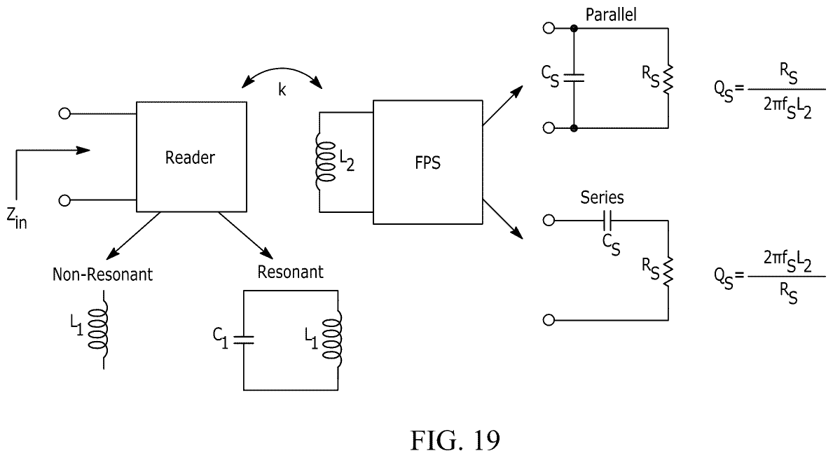

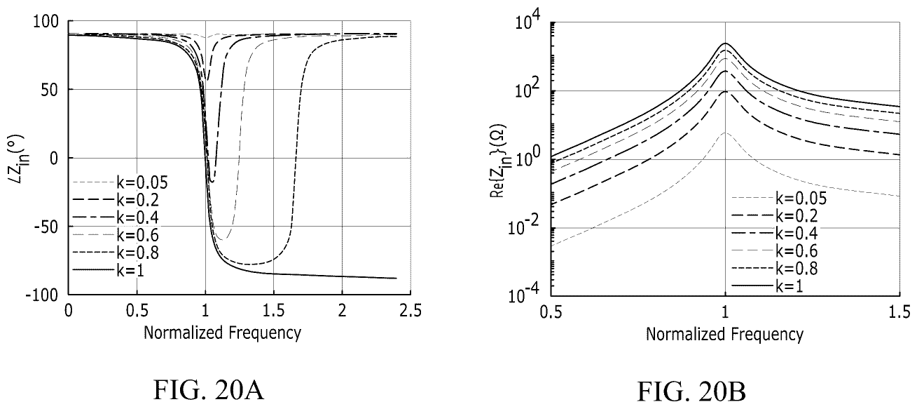

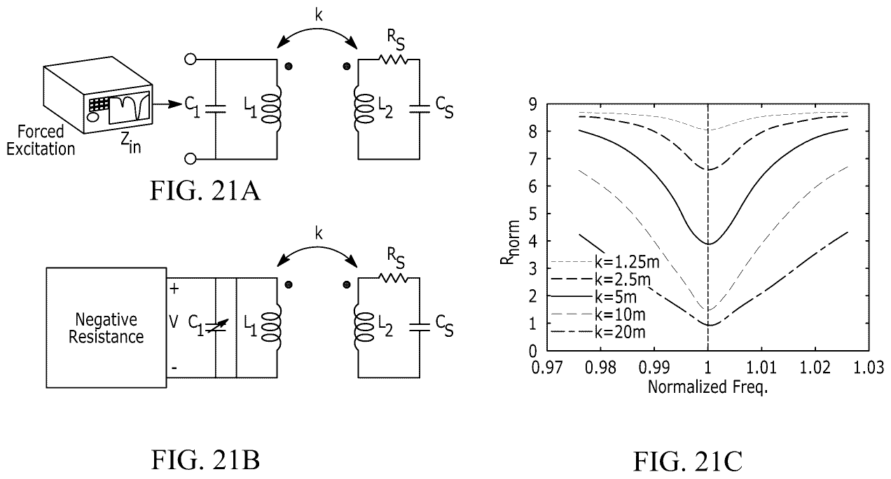

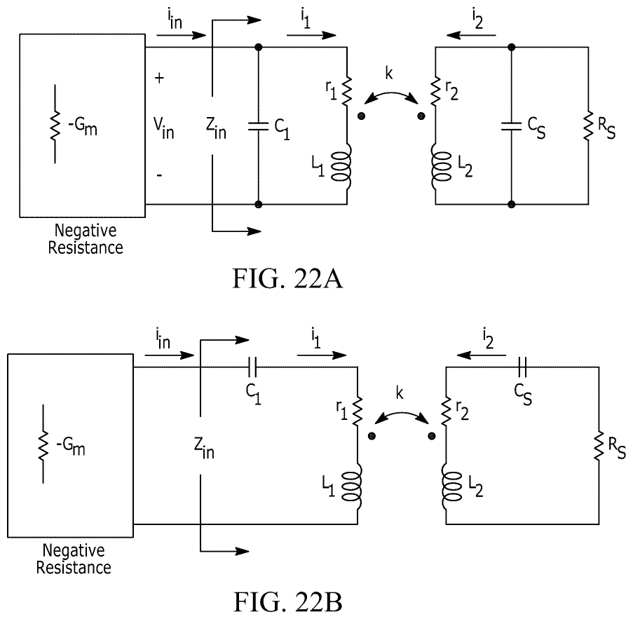

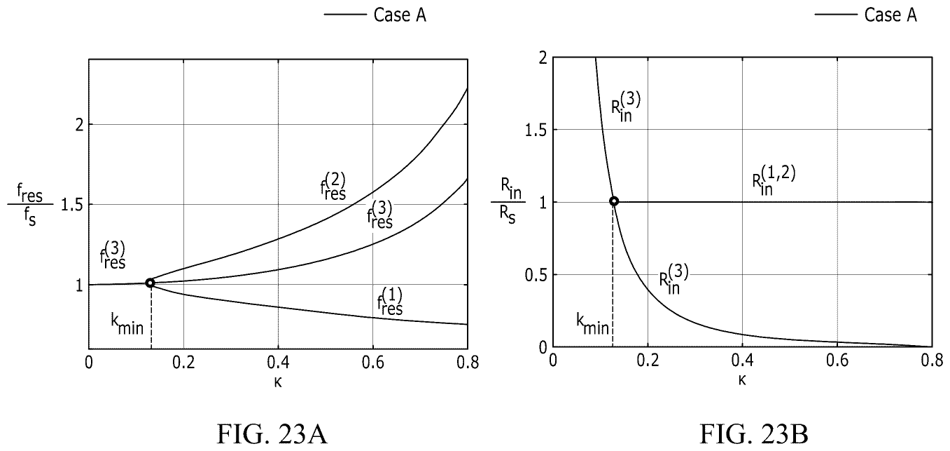

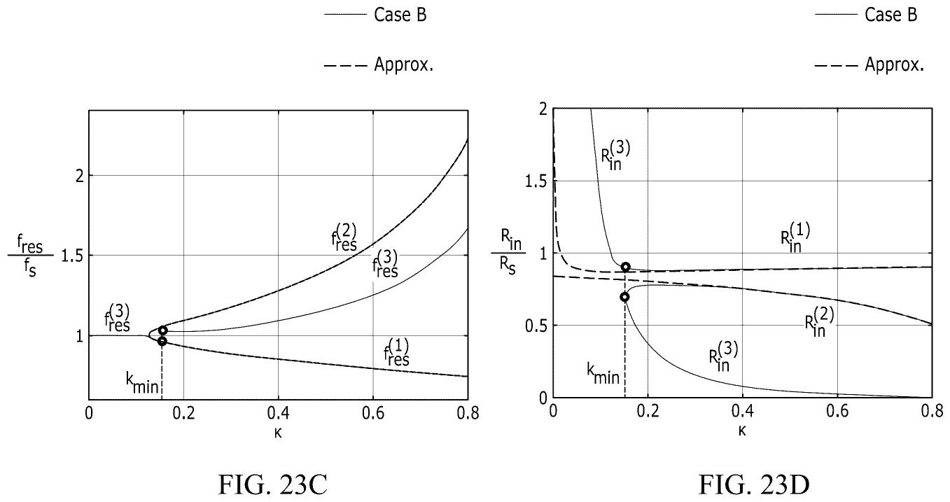

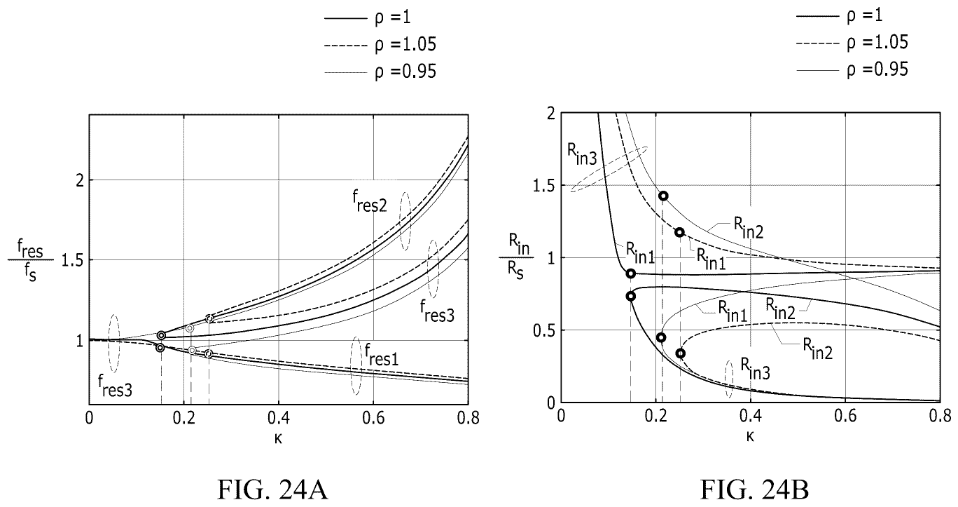

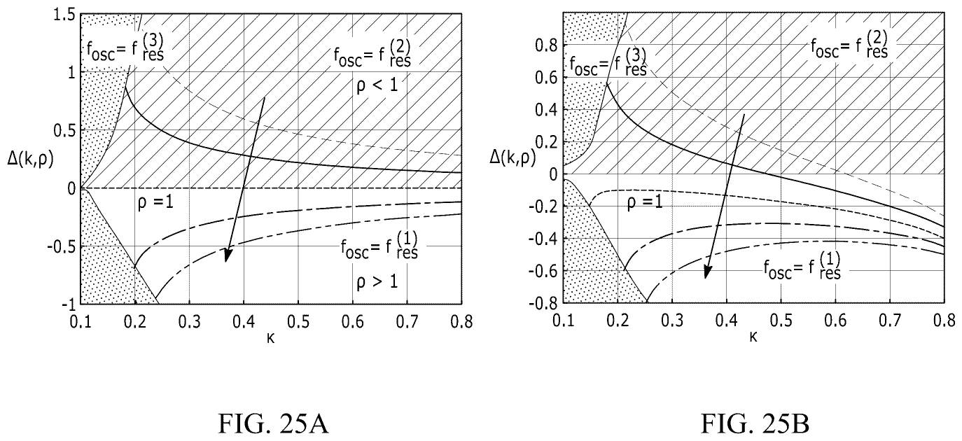

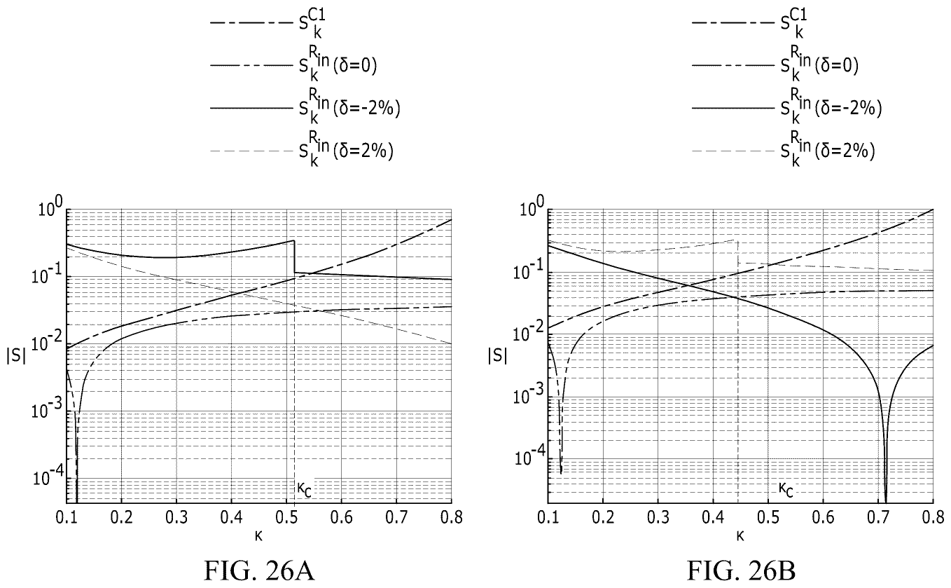

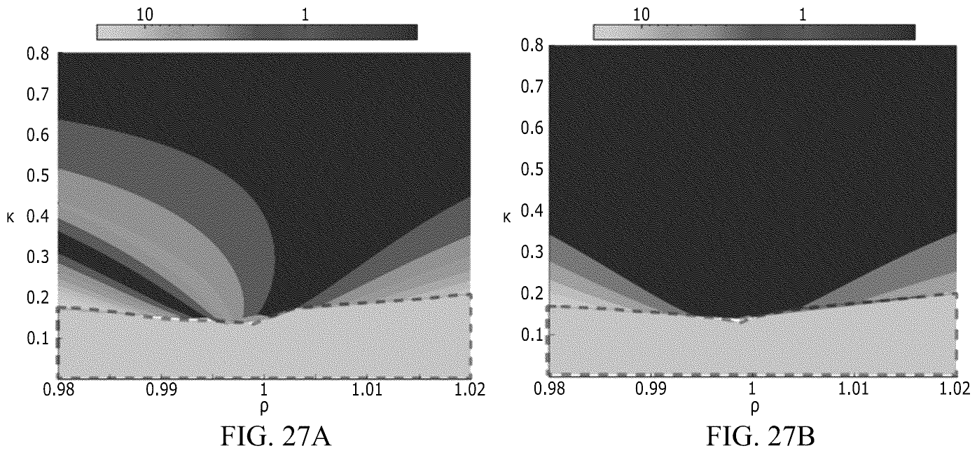

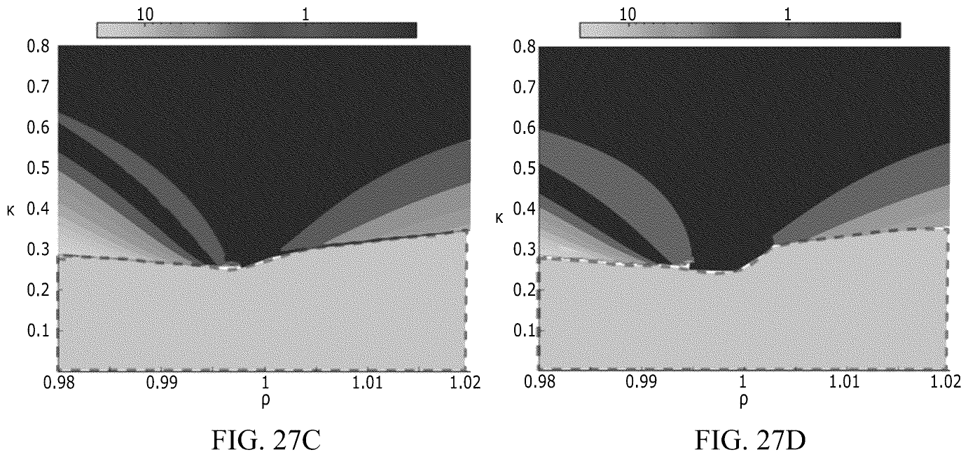

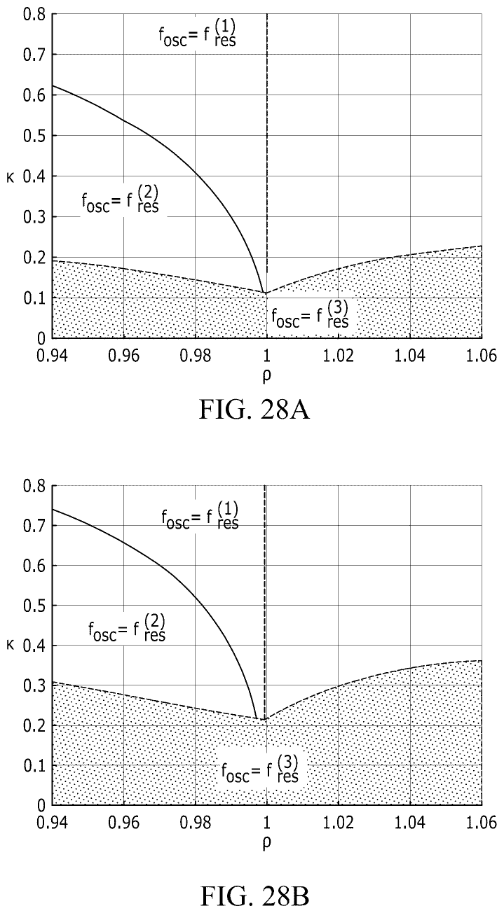

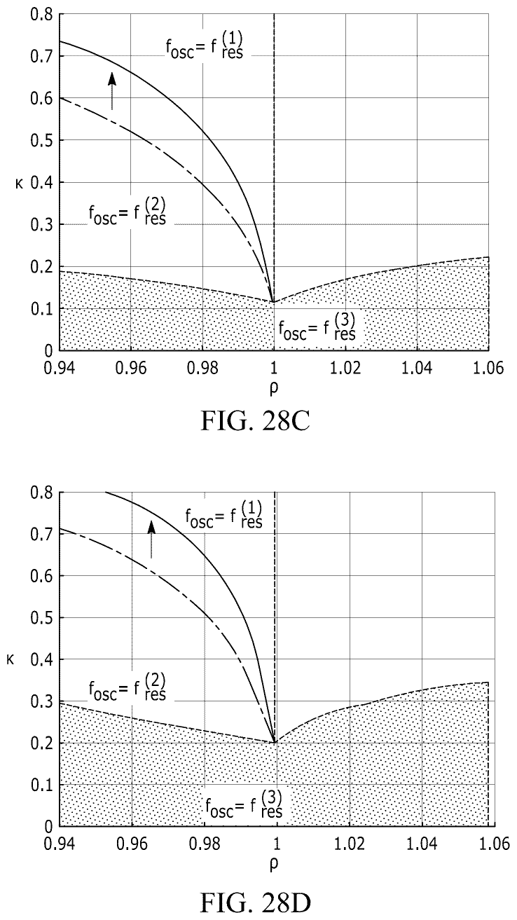

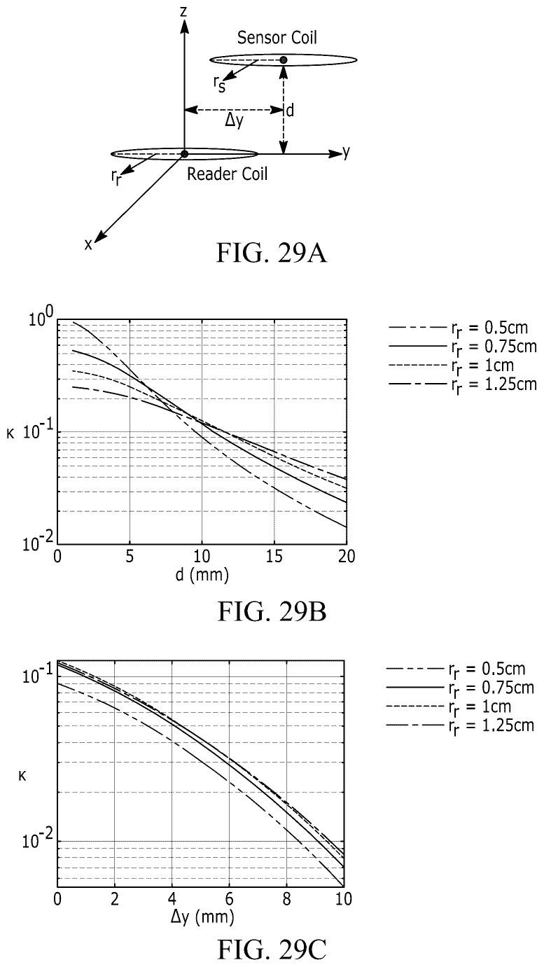

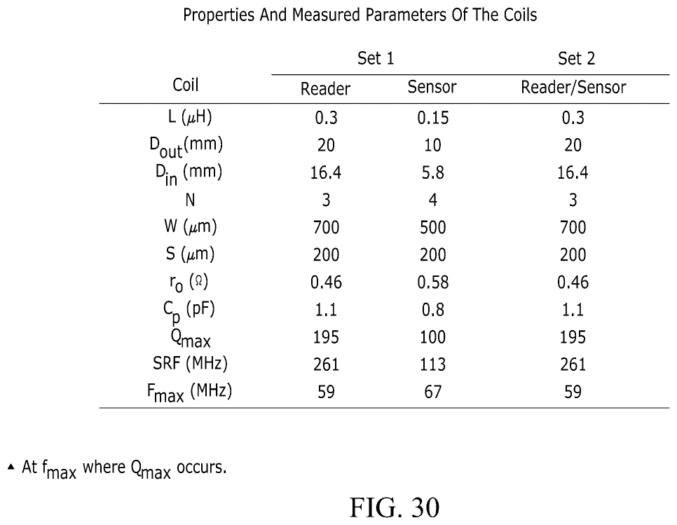

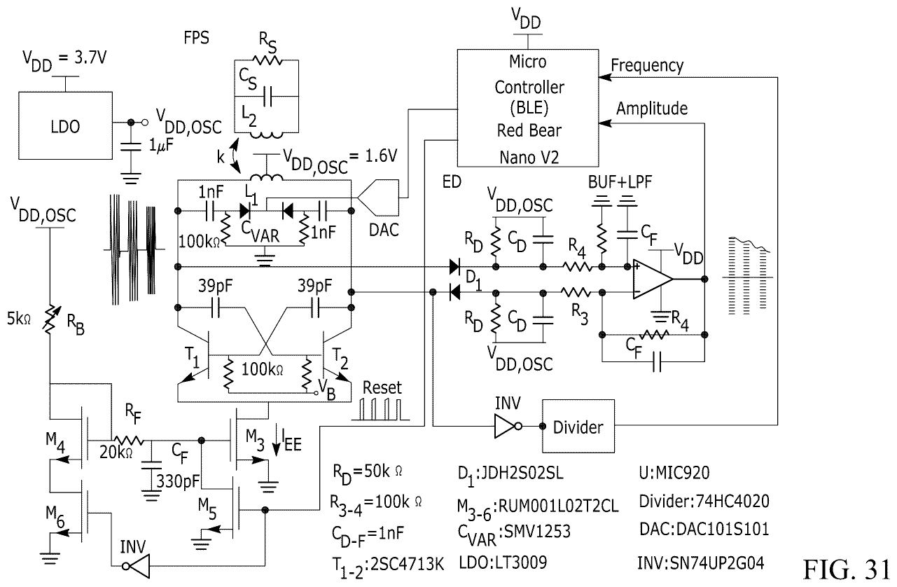

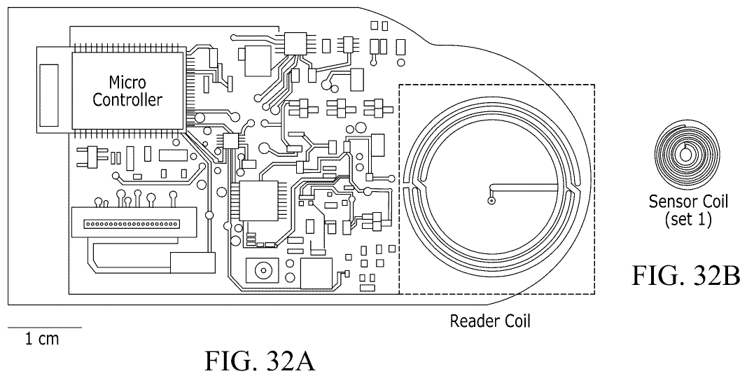

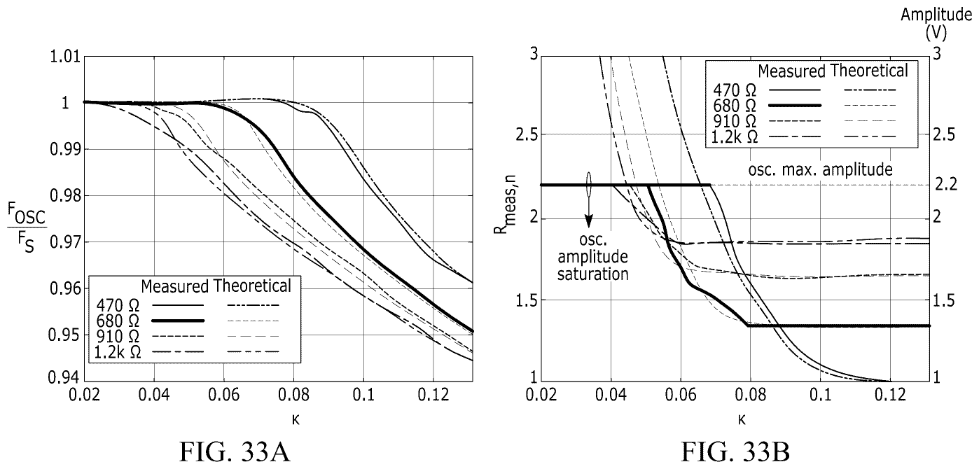

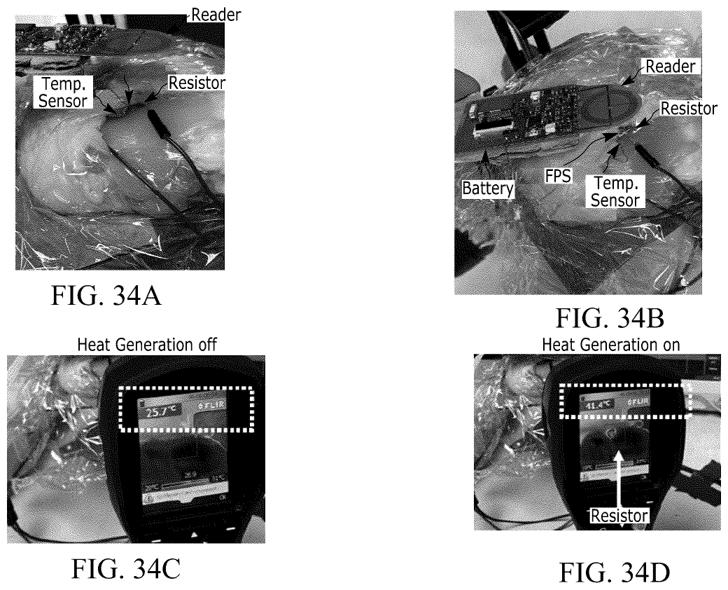

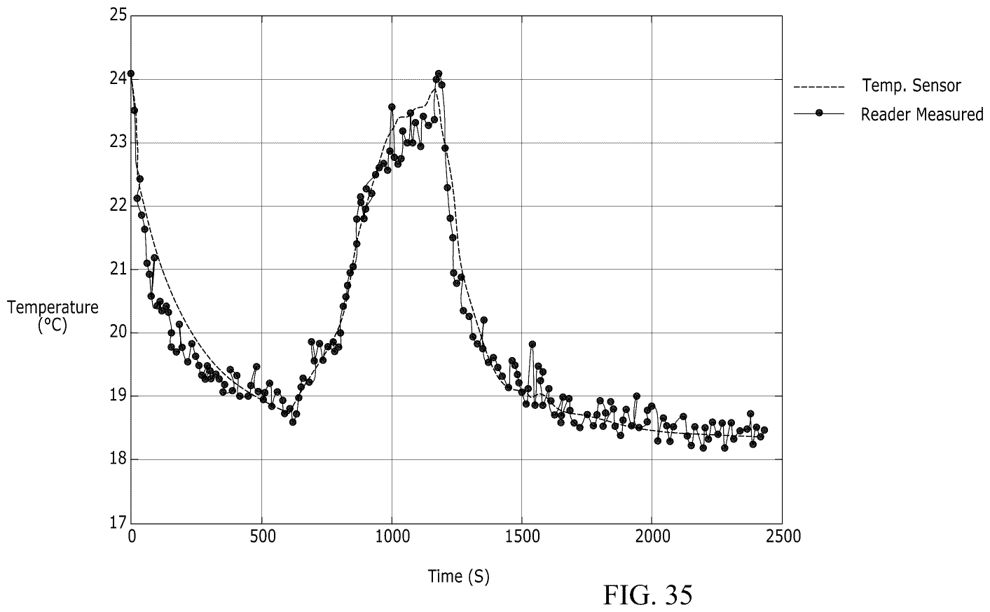

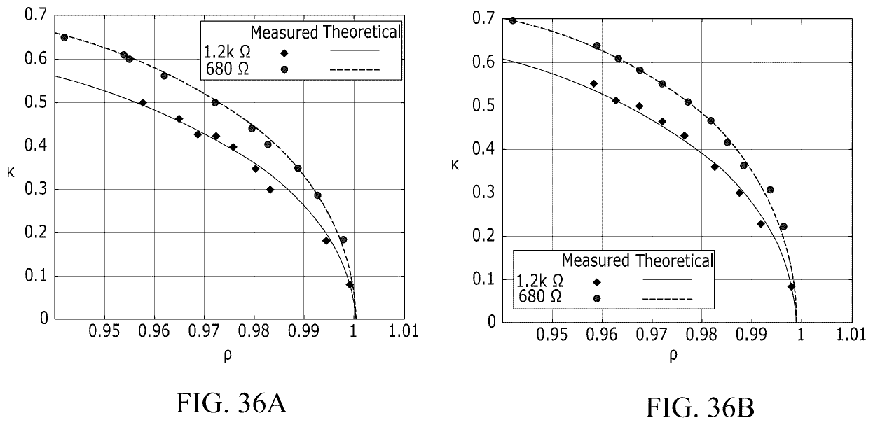

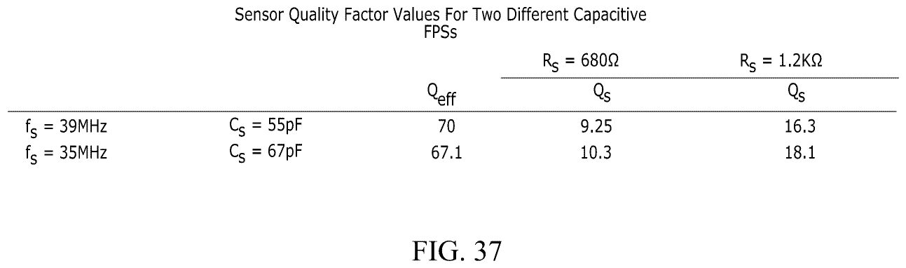

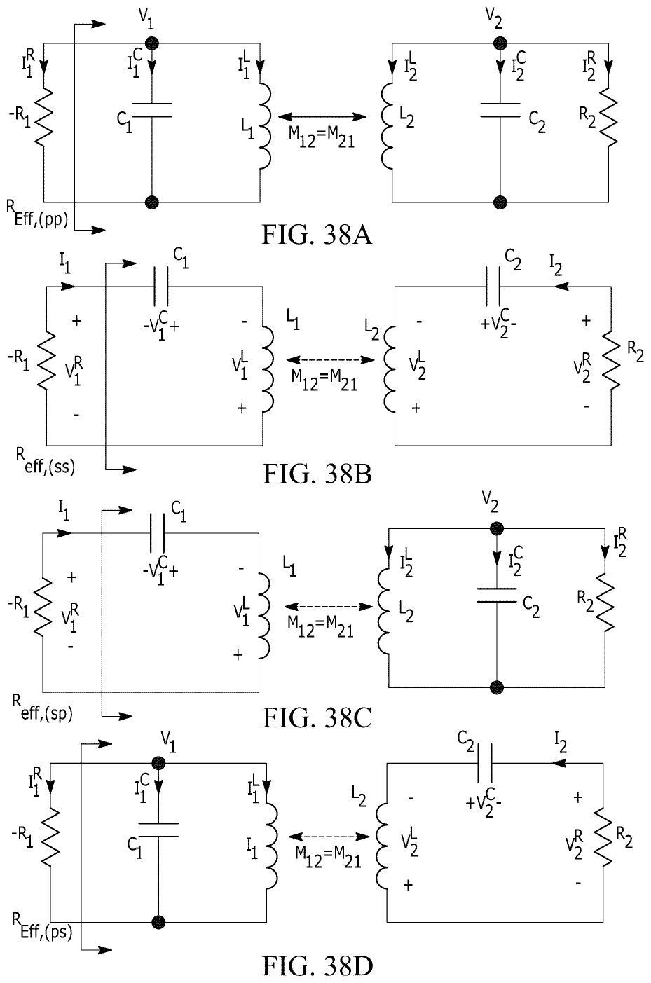

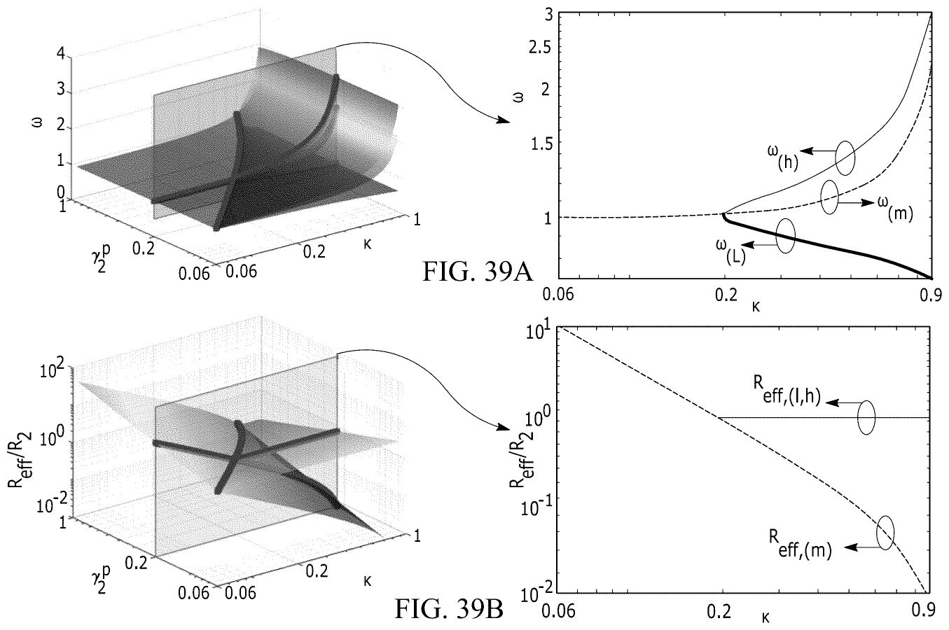

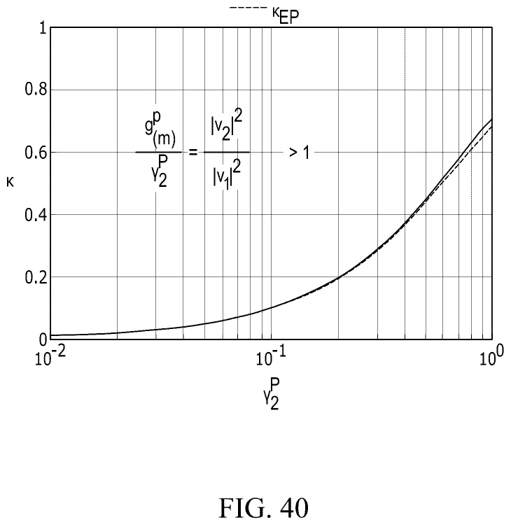

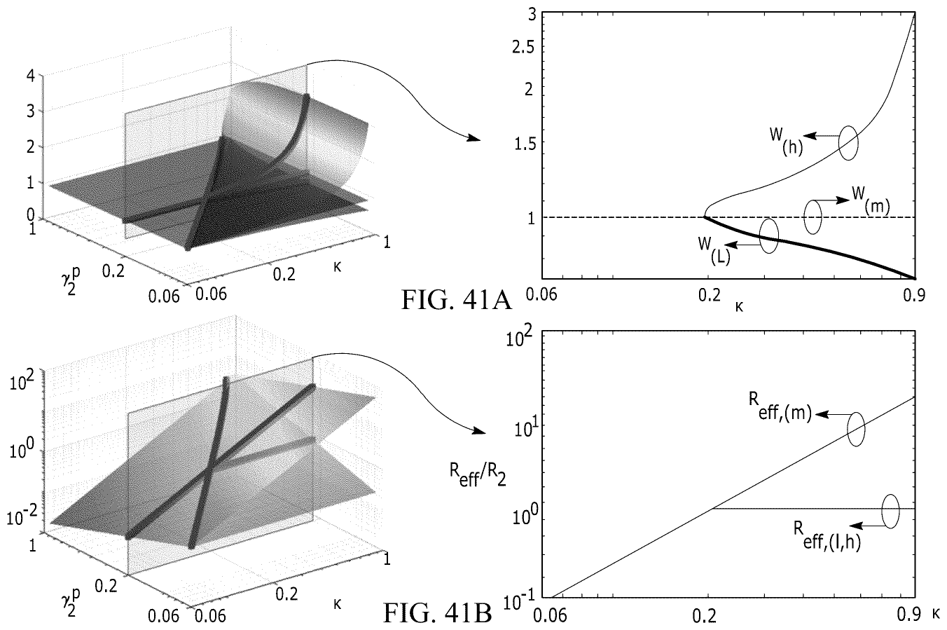

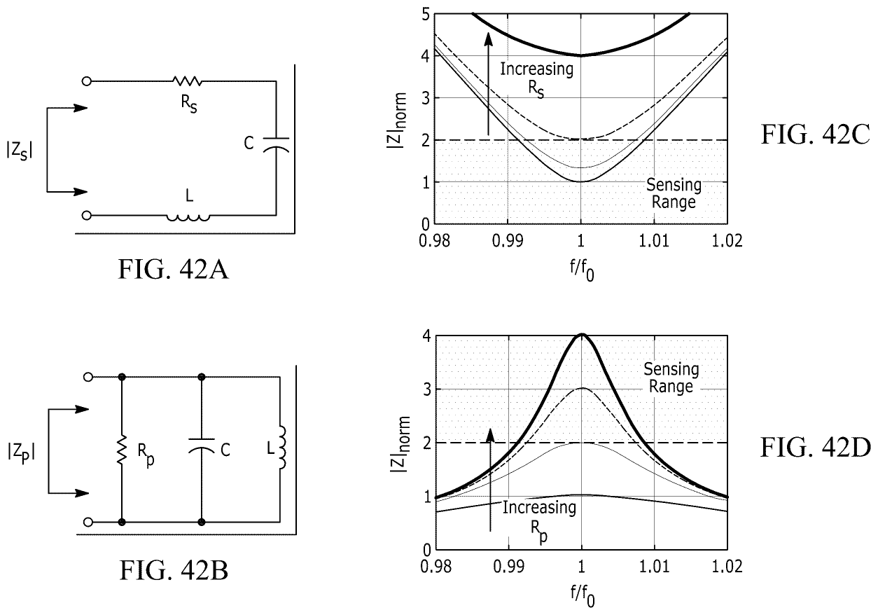

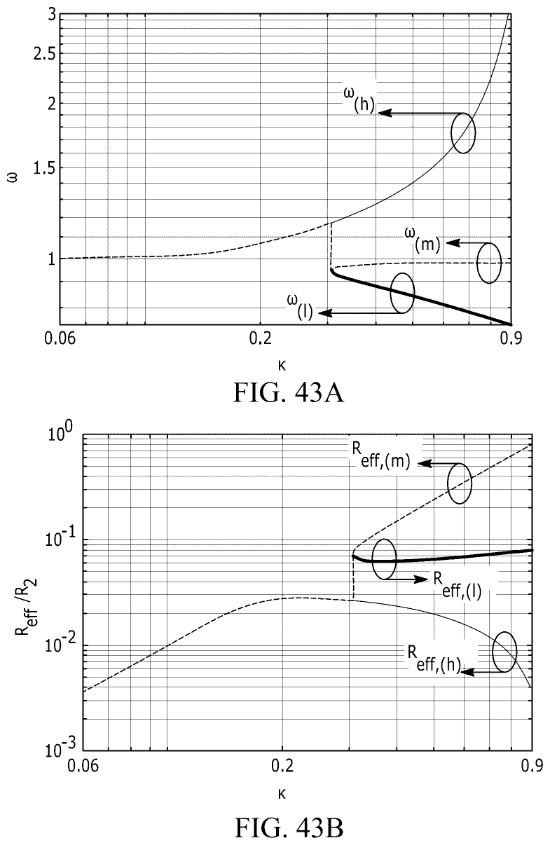

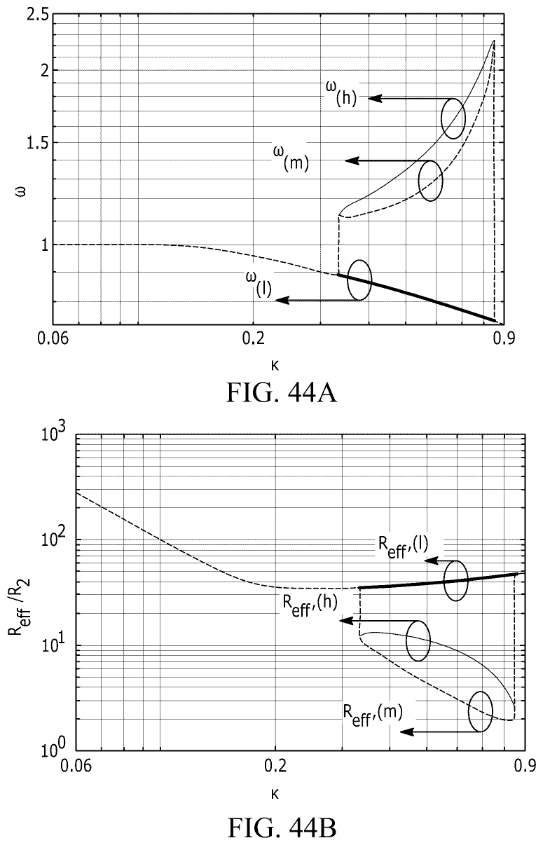

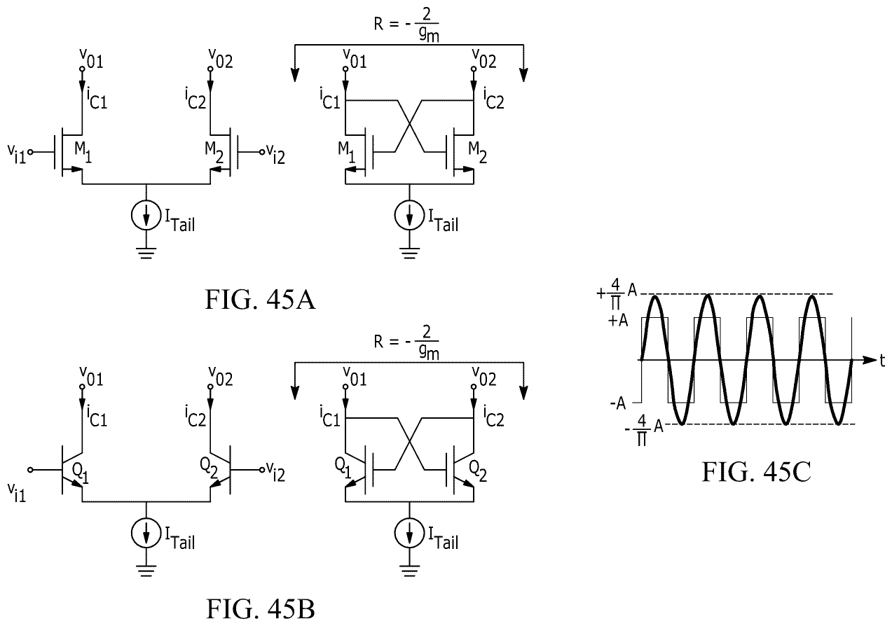

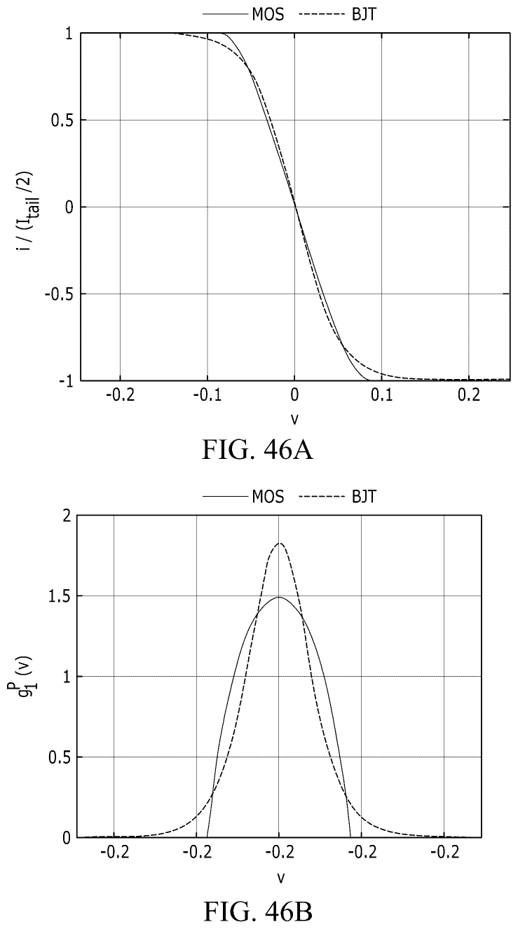

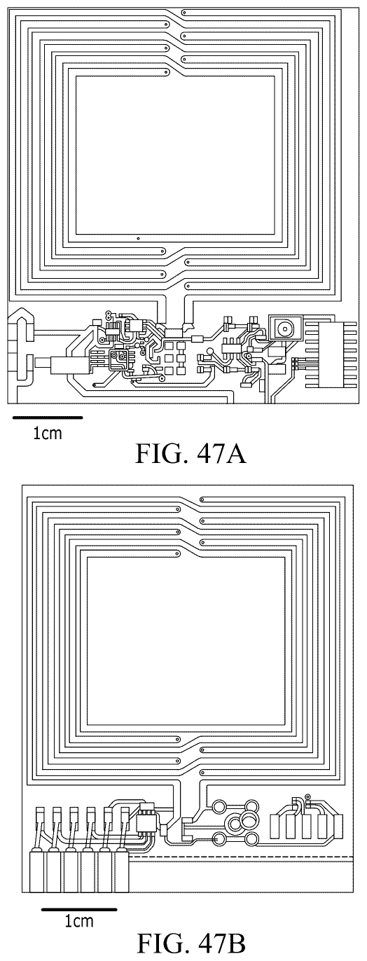

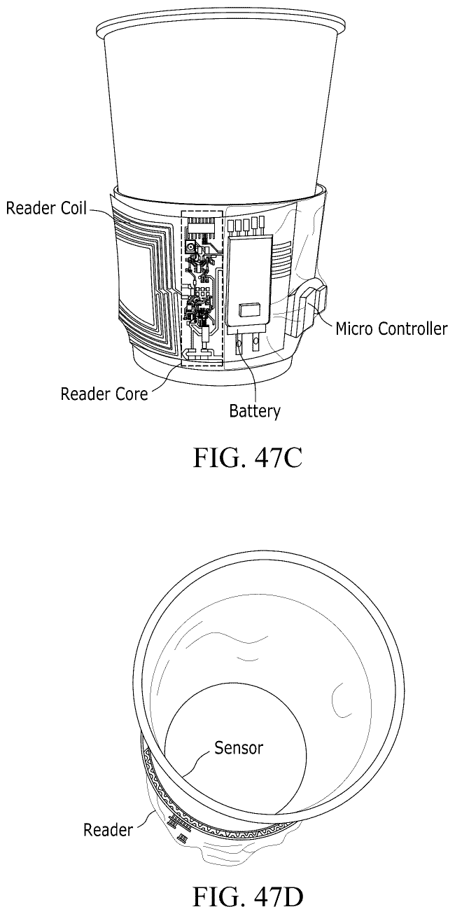

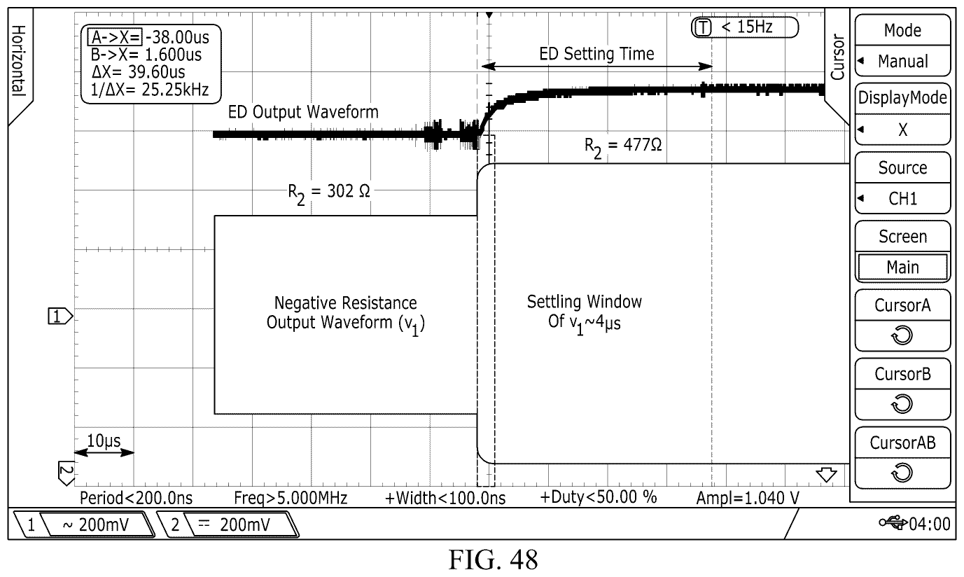

As shown in FIGS. 2A-2D, the presence of EPs is marked by empty squares in the two-dimensional plots and by the red line in the three-dimensional plots, denoting the transition from one to three real modes. ω_{(h,m,l)} and R_{eff}_{_{(h,m,l)}} denote the high, middle, and low eigenfrequencies and effective resistances, respectively. Measurement results for

$$ρ = \frac{{ω}_{2}}{{ω}_{1}} = 1$$

are shown by green circles in FIGS. 2B and 2D, showing excellent correspondence to the theoretical values. The corresponding circuit parameters are L=2.3 μH, and C=220 pF.

FIG. 3A illustrates a circuit schematic and normalized effective resistance,

$$\frac{{R}_{eff}}{{R}_{2}} ,$$

for the series-series case; note that coupling independence is maintained ∀κ>κ_{EP}.

FIG. 3B illustrates minimum coupling, κ_{EP}, for the series-series and parallel-parallel resonator topologies assuming the same resistance; note the opposing trend.

FIG. 3C illustrates a circuit schematic and a normalized effective resistance,

$$\frac{{R}_{eff}}{{R}_{2}} ,$$

for the series-parallel case;

$$\frac{{R}_{eff}}{{R}_{2}}$$

is now coupling-dependent ∀_{κ}.

FIG. 3D illustrates a circuit schematic and a normalized effective resistance,

$$\frac{{R}_{eff}}{{R}_{2}} ,$$

for the parallel-series case;

$$\frac{{R}_{eff}}{{R}_{2}}$$

is now coupling-dependent ∀_{κ}.

As shown in FIGS. 3A-3D, the corresponding circuit parameters are L=2.3 μH and C=220 pF. In FIGS. 3A, 3C, and 3D, γ₂=0.2.

FIG. 4A illustrates κ_{EP} VS ρ for four values of γ₂; note that if ρ=1, then κ_{EP}≤γ₂, and when ρ≠1, then κ_{EP}>γ₂.

FIG. 4B illustrates measurement error defined as e(%)=(R_{eff,κ=κ}_{_{EP}}−R₂)/R₂|×100 as a function of ρ and γ₂. For ρ=1, e=0; as ρ deviates from unity, e increases.

FIG. 5A illustrates normalized i-v curves for tanh and van der Pol nonlinearities.

FIG. 5B illustrates a negative resistance circuit with cross-coupled MOSFET pair, in accordance with some examples provided herein.

FIG. 6A illustrates transient simulations of normalized R_{eff} in cycles versus coupling for several g_{1,0}, and γ₂=0.2 and ρ=1, and FIG. 6B illustrates transient simulations of 99% settling time in cycles versus coupling for several g_{1,0}, and γ₂=0.2 and ρ=1. As shown in FIGS. 6A and 6B, the normalized effective resistance is coupling-independent at unity and fast settling is confirmed ∀κ≥κ_{EP}.

FIG. 7 illustrates an example of implemented reader circuitry with measurement of self-oscillating frequency and voltage amplitude via MCU, in accordance with some examples provided herein.

FIG. 8A illustrates an example measurement setup, in accordance with some examples provided herein.

FIG. 8B illustrates measurement results for a single-point, real-time, wireless measurement, in accordance with some examples provided herein, where the shaded area marks the theoretical coupling-independent sensing region (the dashed curve represents the boundary), κ>κ_{EP}, for each R₂ setting, and the circles show the theoretical distance for κ=κ_{EP}.

FIG. 9A illustrates multiple-point measurement with imbalanced resonant frequencies (ρ=1.15) while the sensor is moved toward (positive distance) and away (negative distance) from the reader for two R₂ settings (230Ω and 380Ω).

FIG. 9B illustrates measurement error with and without correction for R₂=380Ω, and FIG. 9C illustrates measurement error with and without correction for R₂=230Ω. As shown in FIGS. 9B and 9C, error correction reduces the measurement error from 20% to <1% over a range of 1 cm for R₂=230Ω and from 10% to <1% over a range of 1.5 cm for R₂=380Ω.

FIG. 10A illustrates a flexible reader mounted on a paper sleeve operating from a 100 mAh/3.7 V battery.

FIG. 10B illustrates a side view of the wireless measurement setup with the E-ink display showing real-time temperature profile measured by the reader and the fully passive thermistor based resistive sensor inside the cup; the sensor and the reader are both warped to conform to the shape of the cup.

FIG. 10C illustrates real-time measurement of a fully passive thermistor-based sensor. The technique provided herein is shown to exhibit a low percent error in temperature measurement compared to an independent temperature sensor.

FIG. 11 illustrates a flow diagram 1100 of an example method associated with coupling-independent real-time wireless resistive sensing through nonlinear PT-symmetry, in accordance with some examples provided herein.

FIGS. 12A-12D illustrate a dual-mode oscillator formed with coupled resonators (FIG. 12A), the input resistance for different Δf and k (FIGS. 12B and 12D), and the sensitivity function for different frequency mismatch conditions and the proposed point of operation (Sₖ^{Rc}) (FIG. 12C), for a stamp-sized reader for distance-independent wireless interrogation of fully passive RLC sensors, in accordance with some examples provided herein.

FIG. 13 illustrates a block diagram of the implemented chip for a stamp-sized reader for distance-independent wireless interrogation of fully passive RLC sensors, along with the off-chip energy harvesting circuit, in accordance with some examples provided herein.

FIGS. 14A-14D illustrate an example TX ring oscillator and PZ driver (FIG. 14A) along with an automatic extremum seeking loop (AESL) mechanism (FIG. 14B), parameters of the implemented coils (FIG. 14C) and the power breakdown (simulated) (FIG. 14D) of an example stamp-sized reader for distance-independent wireless interrogation of fully passive RLC sensors, in accordance with some examples provided herein.

FIGS. 15A-15C illustrate a stamp-sized reader for distance-independent wireless interrogation of fully passive RLC sensors, on a flexible PCB, in accordance with some examples provided herein.

FIGS. 16A-16D illustrate measured waveforms of a stamp-sized reader for distance-independent wireless interrogation of fully passive RLC sensors, with energy harvesting with f₂=31 MHz, in accordance with some examples provided herein. FIG. 16A illustrates the output voltage of the rectifier, the LDOs with on-chip timer clock, the output of the ED with and without a sensor, showing the point of mode crossing (without AESL). FIG. 16B illustrates the operation of the AESL, showing loop locking. FIG. 16C illustrates the FFT of the received audio signal on the mobile device (phone), for four different Rₛ. The measurement results showing robust distance-immune operation is shown in FIG. 16D for four different Rₛ.

FIG. 17 is a table illustrating a summary of the performance of a stamp-sized reader for distance-independent wireless interrogation of fully passive RLC sensors, compared to previous readers, in accordance with some examples provided herein.

FIG. 18 is a diagram of a 1 mm×1 mm die for a stamp-sized reader for distance-independent wireless interrogation of fully passive RLC sensors, in accordance with some examples provided herein.

FIG. 19 illustrates an example of interrogation of a fully passive sensor (FPS) through inductive coupling using a single coil (non-resonant reader) or a resonator (resonant reader), in which Rₛ and Cₛ are the resistance and capacitance of the FPS, in accordance with some examples provided herein.

FIG. 20A illustrates the phase of input impedance for a non-resonant reader, and FIG. 20B illustrates the real part of the input impedance for Qₛ=30 and varying k for a non-resonant reader. As shown in FIGS. 20A and 20B, the frequency axis is normalized to fₛ, in accordance with some examples provided herein.

FIG. 21A illustrates the measurement of resonant frequency of an FPS for a resonant reader, using forced excitation (S₁₁ minima), and FIG. 21B illustrates the measurement of resonant frequency of an FPS for a resonant reader, using self-oscillation (dip reader), in accordance with some examples provided herein.

FIG. 21C illustrates the input resistance of the coupled resonator system in weak coupling as a function of

$$\frac{{f}_{1}}{{f}_{s}}$$

(normalized frequency), where Cₛ is kept constant and C₁ is swept, with

$${R}_{norm} = \frac{{R}_{in}}{{R}_{s} {Q}_{s}^{2}} ,$$

Qₛ=75, and Rₛ=2Ω, in accordance with some examples provided herein.

FIG. 22A illustrates a parallel-parallel configuration used for derivation of resonance frequencies and input resistance, and FIG. 22B illustrates a series-series configuration used for derivation of resonance frequencies and input resistance, in accordance with some examples provided herein.

FIG. 23A illustrates resonance frequencies (fᵣₑₛ), and FIG. 23B illustrates the corresponding Rᵢₙ for the ideal case (ρ=1, Q_{1,2}→∞); while FIG. 23C illustrates fᵣₑₛ and FIG. 23D illustrates the corresponding Rᵢₙ for case B (ρ=1, Q_{1,2}=80, Qₛ=8), in accordance with some examples provided herein. The green dashed line shows the approximation given by Eq. (21), suggesting a close agreement for k>kₘᵢₙ.

FIG. 24A illustrates fᵣₑₛ and FIG. 24B illustrates the corresponding Rᵢₙ for case C (ρ≠1, Q_{1,2}=80, Qₛ=8), in accordance with some examples provided herein. The empty circles show kₘᵢₙ.

FIG. 25A illustrates Δ(k, ρ) as a function of k for different ρ values for Q₁, Q₂→∞, while FIG. 25B illustrates Δ(k, ρ) as a function of k for different ρ values for a) and Q₁, Q₂=80, in which case Δ(k, ρ)>0 even when ρ<1, in accordance with some examples provided herein. In both cases, Qₛ=8. Shaded regions show the steady-state oscillation frequency of the oscillator. The arrow points to increase in ρ.

FIGS. 26A and 26B illustrate a sensitivity comparison of capacitive sensing and resistive sensing (with δ=0 and |δ|=2%) for Qₛ=10, Q₀=120 in FIG. 26A, and Qₛ=10, Q₀=80 in FIG. 26B, in accordance with some examples provided herein.

FIGS. 27A-27D illustrate resistive sensing percentage error defined as

$$e ( \% ) = \frac{{R}_{in} - {R}_{s}}{{R}_{s}} \times 100 ,$$

with frequency mismatch (ρ≠1) for (FIG. 27A) Qₛ=8, Q₀=80, (FIG. 27B) Qₛ=8,Q₀=120, (FIG. 27C) Qₛ=4, Q₀=80, and (FIG. 27D) Qₛ=4, Q₀=120, in accordance with some examples provided herein.

FIGS. 28A-28D illustrate frequency of oscillation (f_{osc}) as a function of ρ for different values of k. The shaded gray areas show the weak-coupling region, wherein fᵣₑₛ⁽³⁾ emerges, for for (FIG. 28A) Qₛ=10, Q₀=80, (FIG. 28B) Qₛ=10, Q₀=160, (FIG. 28C) Qₛ=5, Q₀=80, and (FIG. 28D) Qₛ=5, Q₀=160, in accordance with some examples provided herein. The red and green lines in FIGS. 28C and 28D, respectively, show the boundary between frequencies in FIGS. 28A and 28B for comparison.

FIG. 29A illustrates vertical and lateral displacement denoted by d and Δy, respectively, between two coils, in accordance with some examples provided herein.

FIGS. 29B and 29C illustrate calculated coupling strength between two coils with rₛ=0.5 cm for four different reader coils vs. vertical distance, d in FIG. 29B, and vs. lateral distance, Δy with d=1 cm, in accordance with some examples provided herein.

FIG. 30 is a table illustrating properties and measured parameters of the coils, in accordance with some examples provided herein.

FIG. 31 illustrates a circuit schematic of an example reader using off-the-shelf components, in accordance with some examples provided herein.

FIG. 32A illustrates an example reader (with the reader coil), and FIG. 32B illustrates the sensor coils from set 1 on the flexible PCB, in accordance with some examples provided herein.

FIGS. 33A and 33B illustrate measured and theoretical oscillation frequency normalized to the sensor resonance frequency (FIG. 33A) and amplitude of oscillation and the normalized measured resistance (FIG. 33b), in accordance with some examples provided herein.

FIG. 34A illustrates a measurement setup for resistive FPS sensing in chicken meat, with FIG. 34B illustrating the setup in FIG. 34A when a different measurement was being taken, and FIG. 34C illustrating the local temperature of the heat generating resistor (referred to as the resistor in the figures), with excitation on and off to verify heat generation, in accordance with some examples provided herein.

FIG. 35 illustrates measurement results from the resistive FPS compared with the temperature recorded from the temperature sensor chip, in accordance with some examples provided herein.

FIGS. 36A-36B illustrate measured and theoretical ρ at which the frequency branch jump occurs (from fᵣₑₛ⁽¹⁾ to fᵣₑₛ⁽²⁾ or vice versa) for two different capacitive FPS with different Rₛ of 680Ω and 1.2 kΩ for (in FIG. 36A) fₛ=35 MHZ (Cₛ=94 pF) and (in FIG. 36B) fₛ=39 MHz (Cₛ=67 pF), in accordance with some examples provided herein.

FIG. 37 is a table illustrating sensor quality factor values for two different capacitive FPSs, in accordance with some examples provided herein.

FIG. 38A illustrates an example parallel-parallel resonator topology, showing relevant branch currents and loop voltages, in accordance with some examples provided herein.

FIG. 38B illustrates an example series-series resonator topology, showing relevant branch currents and loop voltages, in accordance with some examples provided herein.

FIG. 38C illustrates an example series-parallel resonator topology, showing relevant branch currents and loop voltages, in accordance with some examples provided herein.

FIG. 38D illustrates an example parallel-series resonator topology, showing relevant branch currents and loop voltages, in accordance with some examples provided herein.

FIG. 39A illustrates positive modes for the parallel-parallel resonator topology as shown in FIG. 38A and ρ=1, and FIG. 39B illustrates normalized effective resistances corresponding to each mode shown in FIG. 39A. Slices show solutions for γ₂^{p}=0.2. Mode-splitting past κ_{EP} (red markers) allows the lower and upper modes to exhibit a coupling-independent effective resistance. Dashed lines (impedance solutions) confirm Liouvillian solutions (solid lines). The corresponding circuit parameters are R₂=511.25Ω, L=2.3 μH, and C=220 pF.

FIG. 40 illustrates a parametric plot of κ_{EP} VS γ₂^{p}. The shaded region shows where

$$\frac{{g}_{( m )}^{p}}{{γ}_{2}^{p}} < 1 ,$$

which is identical to the region of exact PT-symmetry as specified by κ_{EP}. The middle mode, ω₍ₘ₎, violates energy conservation in exact PT-symmetry and can therefore only exist in the under-coupled region (κ<κ_{EP}).

FIG. 41A illustrates positive modes for the series-series resonator topology as shown in FIG. 38B and ρ=1, and FIG. 41B illustrates normalized effective resistances corresponding to each mode shown in FIG. 41A. Slices show solutions for γ₂^{p}=0.2. Mode-splitting past κ_{EP} (red markers) allows the lower and upper modes to exhibit a coupling-independent effective resistance. Dashed lines (impedance solutions) confirm Liouvillian solutions (solid lines). The corresponding circuit parameters are R₂=20.45Ω, L=2.3 μH, and C=220 pF.

FIG. 42A illustrates series resonators, while FIG. 42B illustrates parallel resonators.

FIG. 42C illustrates normalized impedance magnitude vs. frequency and increasing resistance for series resonators, while FIG. 42D illustrates normalized impedance magnitude vs. frequency and increasing resistance for parallel resonators. As shown in FIGS. 42C-42D, lines with identical color correspond to the same loss parameter; Rₛ and Rₚ are calculated using identical resonant frequencies and loss parameters. At resonance, |Zₛ|=Rₛ and |Zₚ|=Rₚ. Minimum coupling restricts viable series sensor resistances to the interval [0, R_{2,max}) and viable parallel sensor resistances to the larger, more favorable interval, (R_{2,min}, ∞). Assuming R₂=2[a. u.] (denoted by the dashed line in FIGS. 42C-42D), the series and parallel resistances are normalized to their minimum and maximum values, respectively.

FIG. 43A illustrates positive modes for the series-parallel resonator topology as shown in FIG. 38C, ρ=1, and γ₂^{p}=0.2, and FIG. 43B illustrates normalized effective resistances corresponding to each mode shown in FIG. 43A. For κ>κ_{EP}=0.31>γ₂^{p}=0.2, mode-splitting is present yet none of the mode solutions exhibits a coupling-independent effective resistance. Dashed lines (impedance solutions) confirm Liouvillian solutions (solid lines). The corresponding circuit parameters are R₂=5115.25Ω, L=2.3 μH, and C=220 pF.

FIG. 44A illustrates positive modes for the parallel-series resonator topology as shown in FIG. 38D, ρ=1, and γ₂^{p}=0.2, and FIG. 44B illustrates normalized effective resistances corresponding to each mode shown in FIG. 44A. For κ>κ_{EP}=0.33>γ₂^{p}=0.2, mode-splitting is present yet none of the mode solutions exhibits a coupling-independent effective resistance. Furthermore, this splitting only happens up to a maximum coupling, κ≈0.85. Dashed lines (impedance solutions) confirm Liouvillian solutions (solid lines). The corresponding circuit parameters are R₂=20.45Ω, L=2.3 μH, and C=220 pF.

FIG. 45A illustrates MOS differential-pair and cross-coupled pair implementations, while FIG. 45B illustrates BJT differential-pair and cross-coupled pair implementations.

FIG. 45C illustrates the first harmonic of a square wave with a voltage amplitude, A, or 4A/π.

FIG. 46A illustrates normalized i−v relationships for the MOS and BJT cross-coupled pair implementations. The significant similarity between the two cases allows the approximation of the piece-wise MOS current with the hyperbolic tangent BJT current.

FIG. 46B illustrates nonlinear gain versus voltage for the MOS and BJT cross-coupled pair implementations; the non-smooth nature of the MOS gain results in discontinuous second derivatives.

FIGS. 47A-47B illustrate reader and sensor implementations for single-point measurements using off-the-shelf components on a flexible PCB (for measurements shown in FIG. 8B).

FIG. 47C illustrates a side view of the wireless temperature measurement setup shown in FIG. 10C, and FIG. 47D illustrates a top view of the wireless temperature measurement setup shown in FIG. 10C.

FIG. 48 illustrates the settling response of the output waveform of the negative resistance (yellow trace) and the output voltage of the ED (blue trace). This suggests that the output of the ED settles within 40 μs (around 30 cycles of the reader frequency at 7.1 MHZ).

### DETAILED DESCRIPTION

The present disclosure provides coupling-independent, robust wireless sensing of fully passive resistive sensors. PT-symmetric operation obviates sweeping, permitting real-time, single-point sensing. Self-oscillation is achieved through a fast-settling nonlinearity whose oscillation's voltage amplitude is proportional to the sensor's resistance. These advances markedly simplify the reader. A dual time-scale theoretical framework generalizes system analysis to arbitrary operating conditions and a correction strategy reduces errors due to detuning from PT-symmetric conditions by an order of magnitude.

The discovery that a large subclass of quantum mechanical systems exhibiting non-Hermitian properties possesses entirely real eigenspectra has spurred renewed investigations into coupled-resonator systems. Contradicting the Dirac-von Neumann axioms, non-Hermitic systems exhibit purely real eigenspectra provided they are pseudo-Hermitic, or more specifically, jointly PT-symmetric (invariant to joint spatial reflection and time reversal). A range of spectral phenomena and applications has recently been observed in coupled electronic resonator systems, including coherent perfect absorption directed transport, anti-PT-symmetry, wireless power transfer, and the focus of this work: wireless sensing.

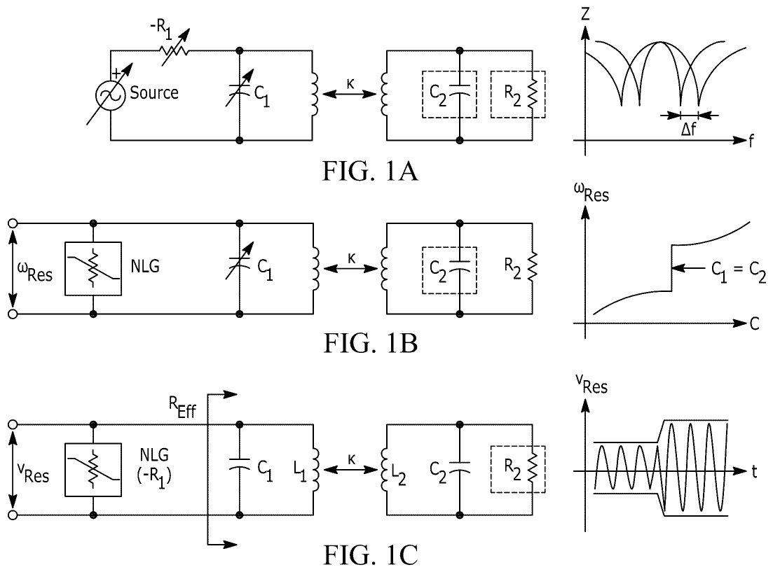

The dynamics of PT-symmetric operation generate a symmetric pitchfork bifurcation in the eigenfrequency spectrum, contingent on two rigorous conditions: equal resonant frequencies in both resonators (frequency-equalization) and strict gain/loss balance. Existing PT-symmetric electronic systems adopt a variety of techniques to achieve these conditions, falling under two broad categories: those with forced excitation sources and those with nonlinear self-oscillating gain mechanisms. In the former (see FIG. 1A) capacitance sweeps equate resonant frequencies while negative resistance tuning realizes gain/loss balance. Subsequent frequency sweeping of a complex excitation source, typically a network analyzer (VNA), provides sensing through the measurement of spectral fluctuations in the impedance profile or reflection parameters (S₁₁ minima). Alternatively, a nonlinear gain allows for automatic gain/loss balance and self-oscillation, obviating the need for gain sweeping and forced excitation. Provided the initial gain induces exponential growth, the system undergoes transient evolution such that the steady-state gain automatically matches the effective loss. A capacitance sweep then provides frequency-equalization, enabling capacitive sensing (see FIG. 1B). The continual reliance on sweeping prohibits real-time wireless sensing as each sweep point requires a finite transient settling time; a single-point sensing method is therefore desirable as it simplifies readout and achieves real-time operation.

The present disclosure demonstrates that wireless resistive sensing can be achieved by operation at the point of symmetric bifurcation (exact PT-symmetry) where the effective resistance seen by the gain element is automatically coupling-independent and equal to the fully passive sensor's resistance (see FIG. 1C). The adoption of a nonlinear gain further provides for self-oscillation. As a whole, no sweeping is required, reducing reader complexity and leading to real-time, single-point measurements. A fast-settling nonlinear gain is introduced; measuring the steady-state voltage amplitude at this gain element detects the sensor's resistance. In contrast to prior efforts whose exact oscillation amplitude and nonlinearity profile do not affect operation, the approach described herein dramatically simplifies resistive sensing. The present disclosure demonstrates that self-oscillation remains even when the system is not exactly PT-symmetric; an error-correction technique is introduced to enhance the robustness of sensing.

Resistive Sensing with Coupled Resonators

Consider the coupled parallel-parallel resonator topology in FIG. 1C with resonant frequencies ω₁=1/\sqrt{L₁C₁} and ω₂=1/\sqrt{L₂C₂}, where one resonator has gain, g₁=R₁⁻¹\sqrt{L₁C₁}, and the other has loss, γ₂=R₂⁻¹\sqrt{L₂C₂}. Define the coupling coefficient as κ=M/\sqrt{L₁L₂}, where M is the mutual inductance between L₁ and L₂, and the inductance and capacitance ratios as μ=\sqrt{L₁/L₂} and χ=\sqrt{C₁/C₂}, respectively. Applying Kirchoff's Current Law (KCL), the charges on each resonator, q₁ and q₂, and their derivatives, are related through the coupled equations:

$${\ddot{q}}_{1} = {g}_{1} ( {q}_{1} ) {\dot{q}}_{1} + \frac{1}{1 - {κ}^{2}} {q}_{1} - \frac{{μκχ}^{2}}{1 - {κ}^{2}} {q}_{2} = 0 , \qquad ( 1 a )$$

$${\ddot{q}}_{2} = {γ}_{2} μχ {\dot{q}}_{1} + \frac{μκ}{1 - {κ}^{2}} {q}_{1} + \frac{{μ}^{2} {χ}^{2}}{1 - {κ}^{2}} {q}_{2} = 0 , \qquad ( 1 b )$$

where g₁(q₁(t)) models the crucial time-varying nonlinear gain. Eqs. 1a and 1b can be recast into the Liouvillian formalism,

$$\frac{d}{dr} Q = ℒ Q ,$$

where Q=[q₁ q₂ \dot{q}₁ \dot{q}₂]^{T}, L is the Liouvillian matrix of system parameters,

$$ℒ = [ \begin{matrix}0 & 0 & 1 & 0 \\ 0 & 0 & 0 & 1 \\ - \frac{1}{1 - {κ}^{2}} & \frac{{κμχ}^{2}}{1 - {κ}^{2}} & {g}_{1} ( {q}_{1} ) & 0 \\ \frac{κμ}{1 - {κ}^{2}} & - \frac{{μ}^{2} {χ}^{2}}{1 - {κ}^{2}} & 0 & - {γ}_{2} μχ\end{matrix} ] \qquad ( 2 )$$

and τ=ω₁t. This formalism is based on exact circuit-level analysis; hence, the low-κ and low-γ₂ approximations made in couple-mode theory (CMT), that would otherwise restrict the dynamic range and accuracy of wireless resistive sensing, are avoided.

The coupled system exhibits two time scales: a fast-time governing the steady-state frequency and gain/loss balance of the sinusoidal oscillations corresponding to resistive sensing; and a slow-time, over which the amplitude envelope settles, dictating the sensing speed.

### Fast-Time Scale

Assuming time harmonic solutions, e^{iω}^{_{λ}}^{t}, the eigenfrequencies, ω_{λ}, may be found using the characteristic equation, det( [symbol] −iωλI)=0. The real modes are solved by setting the real and the imaginary parts of the characteristic polynomial to zero,

$$( 1 - {κ}^{2} ) {{ω}_{λ}}^{4} + {{ω}_{λ}}^{2} [ {g}_{1 , ∞} {γ}_{2} ρ ( 1 - {κ}^{2} ) - 1 - {ρ}^{2} ] + {ρ}^{2} = 0 , \qquad ( 3 a )$$

$${g}_{1 , ∞} = {γ}_{2} ρ \frac{1 - {{ω}_{λ}}^{2} ( 1 - {κ}^{2} )}{{ρ}^{2} - {{ω}_{λ}}^{2} ( 1 - {κ}^{2} )} , \qquad ( 3 b )$$

where ρ=μχ=ω₂/ω₁. In Eqs. 3, g_{1,∞} is the steady-state value of the nonlinear gain implemented by the negative resistance; specifically,

$${g}_{1 , ∞} = {lim}_{t \to ∞} {g}_{1} ( {q}_{1} ( t ) ) .$$

The effective resistance due to the sensor as seen by the negative resistance, R_{eff}, is completely cancelled by the steady-state negative resistance; that is R_{eff}=g_{1,∞}⁻¹\sqrt{L₁/C₁}. Self-oscillating modes are obtained by substituting g_{1,∞} from Eq. 3b into Eq. 3a. The resulting equation can be reduced to a third-order equation, suggesting one or three real modes depending on the system parameters κ, γ₂, and ρ. Eqs. 3 also reveal that real modes are possible even absent PT-symmetric conditions, provided that the gain automatically adjusts to the value in Eq. 3b.

From Eq. 3b, the effective resistance may be calculated as follows,

$${R}_{eff} = \frac{{R}_{2}}{{χ}^{2}} \frac{{ρ}^{2} - {{ω}_{λ}}^{2} ( 1 - {κ}^{2} )}{1 - {{ω}_{λ}}^{2} ( 1 - {κ}^{2} )} . \qquad ( 4 )$$

FIGS. 2A and 2C depict the real modes and their corresponding normalized R_{eff} for ρ≠1, respectively. An exceptional point (EP) exists; below κ_{EP}, only one real mode exists whereas above κ_{EP}, three real modes exist. At exact PT-symmetry (ρ=1), the dependence of R_{eff} on the coupling coefficient, κ, is eliminated. Moreover, from Eq. 4, if μ=χ=1, then R_{eff}=R₂. Under these conditions, for κ>κ_{EP}, the following steady-state resonant frequencies, ω_{(l,m,h)}, and steady-state saturated gain values, g_{(l,m,h)}, arise from Eq. 3,

$${g}_{( l , h )} = {γ}_{2} , \qquad ( 5 a )$$

$${g}_{( m )} = \frac{1}{{γ}_{2}} ( \frac{1}{1 - {κ}^{2}} - 1 ) , \qquad ( 5 b )$$

$${ω}_{( l , h )} = \pm \sqrt{\frac{2 - ξ ∓ \sqrt{{( ξ - 2 )}^{2} - 4 ( 1 - {κ}^{2} )}}{2 ( 1 - {κ}^{2} )}} , \qquad ( 5 c )$$

$${ω}_{( m )} = \pm \sqrt{\frac{1}{1 - {κ}^{2}}} , \qquad ( 5 d )$$

where ξ=γ₂²(1−κ²); for κ≤κ_{EP}, only g₍ₘ₎ and ω₍ₘ₎ emerge. The location of the EP is derived from Eqs. 5,

$${κ}_{EP} = \sqrt{1 - \frac{2 ( {γ}_{2}^{2} + 1 ) - 2 \sqrt{2 {γ}_{2}^{2} + 1}}{{γ}_{2}^{4}}} , \qquad ( 6 )$$

where κ_{EP} defines the minimum coupling, above which mode-splitting occurs, and coupling-independent sensing is possible. Below κ_{EP}, ω_{(l,h)} branch out into the complex plane while ω₍ₘ₎ remains purely real; complex modes cannot sustain steady-state oscillation and are henceforth ignored.

At the exact phase (κ>κ_{EP}), the two modes, ω_{(l,h)}, exhibit lower saturated gains, g_{(l,h)}<g₍ₘ₎, and satisfy conservation of energy, whereas ω₍ₘ₎ does not and is hence unstable. Stable oscillation occurs at either of ω_{(l,h)} with an effective resistance, R_{eff,(l,h)}=R₂, independent of κ. Unlike capacitive sensing, where variations in C₂ alter ω₂ (presenting frequency-imbalance), variations in R₂ do not affect ω₂. Therefore, ω₁ and ω₂ can be equalized and fixed a priori, precluding the need for a time-intensive frequency sweep to detect the condition ω₁=ω₂ and hence, enabling single-point sensing. Prior frequency-swept methods are based on measuring the minima in reflection coefficients; since ω₍ₗ₎ and ω₍ₘ₎ vary with κ (see FIG. 2B), the locations of the minima are coupling-dependent.

While here the discussion has been focused on the parallel-parallel resonator topology, the series-series resonator topology (see FIG. 3A) exhibits similar properties. Applying Kirchoff's Voltage Law (KVL) yields the following coupled rate equations,

$${\ddot{q}}_{1} - \frac{{g}_{1} ( {q}_{1} )}{1 - {κ}^{2}} {\dot{q}}_{1} - \frac{{γ}_{2} κ χ}{1 - {κ}^{2}} {\dot{q}}_{2} + \frac{1}{1 - {κ}^{2}} {q}_{1} - \frac{κ μ {χ}^{2}}{1 - {κ}^{2}} {q}_{2} = 0 \qquad ( 7 a )$$

$${\ddot{q}}_{2} + \frac{{g}_{1} ( {q}_{1} ) κ μ}{1 - {κ}^{2}} {\dot{q}}_{1} + \frac{{γ}_{2} μ χ}{1 - {κ}^{2}} {\dot{q}}_{2} - \frac{κ μ}{1 - {κ}^{2}} {q}_{1} + \frac{{μ}^{2} {χ}^{2}}{1 - {κ}^{2}} {q}_{2} = 0 \qquad ( 7 b )$$

where this time the gain and loss are defined as the duals of the parallel-parallel topology, g₁=R₁\sqrt{C₁/L₁} and γ₂=R₂\sqrt{C₂/L₂}. Eqs. 7 can be recast into the Liouvillian formalism,

$$ℒ = [ \begin{matrix}0 & 0 & 1 & 0 \\ 0 & 0 & 0 & 1 \\ - \frac{1}{1 - {κ}^{2}} & \frac{κ μ {χ}^{2}}{1 - {κ}^{2}} & \frac{{g}_{1} ( {q}_{1} )}{1 - {κ}^{2}} & \frac{{γ}_{2} κ χ}{1 - {κ}^{2}} \\ \frac{κ μ}{1 - {κ}^{2}} & - \frac{{μ}^{2} {χ}^{2}}{1 - {κ}^{2}} & - \frac{{g}_{1} ( {q}_{1} ) κ μ}{1 - {κ}^{2}} & - \frac{{γ}_{2} μ χ}{1 - {κ}^{2}}\end{matrix} ] \qquad ( 8 )$$

Solving for the real modes and corresponding R_{eff} shows that the series-series resonator topology also achieves coupling-independent sensing beyond the EP (see FIG. 3A) However, based on Eq. 6, the desire for a large coupling-independent sensing range restricts κ_{EP} and hence γ₂ (R₂). For the series-series resonator topology, R₂ is confined to [0, R_{2,max}), whereas for the parallel-parallel resonator topology, R₂ is confined to the larger, more favorable range, (R_{2,min}, ∞) (see FIGS. 42A-42B). The restricted sensing range of the series-series resonator topology limits κ_{EP} in the high R₂ limit. Finally, series-parallel and parallel-series resonator topologies such as that in FIGS. 3C-3D are not considered due to their coupling-dependence beyond low-κ approximations.

### Robust Operation

Coupling-independent operation requires identical resonant frequencies in both resonators; this occurs when ρ=1 in Eq. 4. However, naturally-occurring deviations from these conditions induce coupling dependence in R_{eff}. Though self-oscillation persists provided the initial gain exceeds γ₂, a larger κ_{EP} is required (see FIG. 4A). Additionally, maintaining low κ-dependence requires a larger coupling, limiting the readout range. To capture this deviation, FIG. 4B shows the measurement percent error in R_{eff}, e, as a function of ρ and γ₂. For example, for ρ=1.15 and γ₂=0.42, e=15%, and for γ₂=0.25, e=31%.

To maintain sensing accuracy, the present disclosure provides a technique where multiple discrete measurements are taken to mitigate the error due to coupling dependence. Unknown system parameters from Eqs. 3 can be determined through multiple measurements; for example, assuming μ=1 and known L₁, measurements of the mode (ω_{λ}) and the coupling-dependent R_{eff}, leave χ, γ₂, and κ unknown, temporarily rendering the problem unsolvable. Nonetheless, by performing measurements at two different coupling strengths, κ₁ and κ₂, a system of four equations and four unknowns (γ₂, χ, κ₁, and κ₂) results; the solution can be found using the generalized iterative Newton-Raphson method for multiple non-linear equations. The vector of initial conditions is defined as x⁽⁰⁾=[R₂ ω₂ κ₁ κ₂]^{T}; the algorithm iteratively calculates x⁽ⁱ⁺¹⁾=x⁽ⁱ⁾+Δx⁽ⁱ⁾ where

$$Δ {x}^{( i )} = - {[ {J}^{( i )} ]}^{- 1} f ( {x}^{( i )} ) \qquad ( 9 )$$

Here, f is formed from Eqs. 3 for the two measurements and J is the Jacobian matrix of f. Iterations continue until |Δx⁽ⁱ⁾|≤ax⁽ⁱ⁾, where typically, a<<1. In practice, these separate, discrete measurements are made while the user moves the reader toward the sensor; additional discrete measurements and post-processing provide enhanced accuracy.

### Slow-Time Scale

The transient envelope of the response to Eqs. 1 affects the settling time and determines the sensing speed. Understanding this time scale requires a proper model for the nonlinear gain, g₁(·). Traditional models constrain themselves to lower-order van der Pol nonlinearities; however, as a relaxation oscillator, variations in the van der Pol damping term primarily affect the transient waveform shape and the slope of the nonlinearity is not monotonically negative (see FIG. 5A). Instead, sensing measurements are simplified by monitoring the steady-state voltage amplitude; hence, a monotonically compressive nonlinearity is desirable.

Such nonlinearity can be implemented through the MOS transistor cross-coupled pair circuit (see FIG. 5B) whose amplitude, in contrast to previous compressive gain mechanisms, is not fixed. The MOS cross-coupled pair exhibits a differential current approximated by 2V_{T}(_{R1,0})⁻¹tanh[(q₁C₁⁻¹)/(2V_{T})], where V_{T} is the thermal voltage and R_{1,0} is the initial negative resistance defined by the transconductance of identical transistors M₁ and M₂. The nonlinear gain in Eqs. 1 is related to the differential current through its time-derivative. The chain rule gives

$$( \frac{{di}_{1}}{d τ} ) = ( \frac{{di}_{1}}{{dq}_{1}} ) ( \frac{{dq}_{1}}{d τ} ) .$$

Since i₁ is the time-derivative of q₁,

$${\ddot{q}}_{1} = ( \frac{{di}_{1}}{{dq}_{1}} ) {\dot{q}}_{1} ;$$

matching these terms to the first-derivative term in Eq. 1a, the charge-derivative of the current gives the dynamic nonlinear model for g₁(·),

$${g}_{1} ( {q}_{1} ) = {g}_{1 , 0} {sech}^{2} [ \frac{{q}_{1}}{2 {C}_{1} {V}_{T}} ] \qquad ( 10 )$$

where g_{1,0}=−(R_{1,0})⁻¹\sqrt{L/C} is the initial gain. The transistors switch on and off producing a square-wave that is filtered at the steady-state, resonant frequency. From Fourier analysis, the amplitude of the fundamental component of the resulting voltage is V₁=(2/π)I_{Tail}R_{eff}, where I_{Tail} is the bias current that sets the initial gain. For κ>κ_{EP}, R_{eff}=R₂, predicting a coupling-independent steady-state amplitude,

$${V}_{1} = \frac{2}{π} {I}_{Tail} {R}_{2} , \qquad ( 11 )$$

that is directly proportional to R₂.

FIG. 6A shows transient simulations of Eqs. 1 with g₁(·) modeled by Eq. 10. The settled steady-state amplitude in Eq. 11 demonstrates the coupling-independence of R_{eff}=R₂ beyond the EP. The settling time is estimated by measuring the number of cycles it takes for the amplitude to settle within ±δ of V₁ where δ represents the desired fraction of settling. With the given nonlinearity, at the exact phase of PT-symmetry, settling times of 25 cycles suffice for δ=0.01 (see FIG. 6B). For reader resonant frequencies in the High Frequency (HF) range (>5 MHz), this corresponds to settling times of <5 μs, enabling real-time sensing.

### Experimental Verification

The proposed single-point sensing mechanism with compressive nonlinearity and self-oscillation allows for a simple reader implementation. As a proof-of-concept, a system prototype was built using off-the-shelf components, where the core reader circuitry consists of the MOS cross-coupled pair with a programmable capacitor and a coil (see FIG. 7). The differential oscillation signal is buffered and converted to single-ended using an op-amp and applied to a diode-based envelope detector. The frequency is also measured by dividing the signal to within the sampling range of the micro-controller unit (MCU). The reader coil is a planar copper inductor (L=2.3 μH) implemented on the flexible circuit board as shown in FIG. 47A. On the sensor side, an identical inductor and a fixed capacitor are used along with a programmable resistor to emulate the resistive sensor (FIG. 10B). The distance between the sensor and reader is varied over a range of 1 mm to 3 cm (FIG. 8A). FIG. 8B shows the measurement results along with the error at each measurement point for each resistance setting. For each setting, the theoretical κ_{EP} is calculated using Eq. 6 and then converted to distance based on full-wave EM simulations. The amplitude of oscillations settles within 4 μs, allowing for real-time measurement of variations in the sensor resistance (see FIG. 48).

Next, the fixed sensor capacitor is replaced by a variable capacitor to introduce frequency mismatch. In this mode of operation, the reader makes multiple discrete measurements of (V₁, ω₁) at different distances as it moves towards or away from the sensor. A system of four equations and four unknowns is solved for each two consecutive measurements. FIG. 9 shows that even for a significant frequency mismatch of ω₂=1.15ω₁, the correction algorithm improves the measurement error by more than an order of magnitude.

### Demonstration of Wireless Sensing

The flexible reader is embedded on a paper sleeve to provide real-time wireless measurements of the temperature of hot beverages in a paper cup using a thermistor as a resistive sensor (see FIGS. 10A-10B). The sensor resonator is wrapped in an air-tight plastic layer in order to alleviate dielectric loading from water. In this case, the sensor exhibits a 4% drop in resonant frequency, requiring a scaling factor to account for the resulting measurement error. FIG. 10C demonstrates wireless sensor measurements, showing that the converted temperature from the sensor faithfully follows that of an independent temperature sensor in real-time.

### Example Method

FIG. 11 illustrates a flow diagram 1100 of an example method associated with coupling-independent real-time wireless resistive sensing through nonlinear PT-symmetry. For a system of two coupled resonators including a sensor resonator having an explicit resistor or loss and a reader resonator having a negative resistor or gain, there will be one or three resonant frequencies, depending on the coupling strength, k, and sensor resistance. That is, there are one or three resonant frequencies, at which the imaginary part of the input impedance falls to zero. The impedance at these frequencies is therefore is purely real and related to the sensor resistance which can be exploited for resistive sensing. Accordingly, if the loss presented by the sensor resistance to the reader is balanced with equal gain through the negative resistance, the system turns into an oscillator and will self-oscillate at one of the above-mentioned resonant frequencies.

A nonlinear gain is implemented (block 1102) using an MOS cross-coupled pair, enabling this gain/loss equalization via compressive saturation of its negative resistance. As the amplitude of oscillations grows, the nonlinear resistance experiences compression until gain and loss in the circuit are balanced, at which point amplitude growth stops and the amplitude becomes constant. The saturated negative resistance at the steady state will be equal to the real part of the input impedance at the frequency of oscillation; this value is equal to the sensor resistance when the sensor and reader resonators have equal inductance/capacitance values. The amplitude of oscillations is measured (block 1104) by means of an amplitude detector. The negative resistance provided by the MOS cross-coupled pair of the reader resonator may then be determined (block 1106), e.g., by a processor receiving the measured amplitude of oscillations from the amplitude detector, based on the amplitude of oscillations at steady state. The resistance of the resistor of the sensor resonator may then be determined (block 1108), e.g., by the processor, based on the determined negative resistance of the reader resonator when the amplitude of oscillations reaches steady state.

Additionally, as discussed herein, so long as the reader and sensor have equal resonant frequencies, beyond a certain coupling strength (primarily determined by the sensor resistance), the real part of the impedance remains constant with variations in the coupling strength. This enables a distance and orientation-independent measurement of the sensor resistance. This coupling-independence is achieved when both sensor and reader have the same topology (series/series or parallel/parallel); mixed sensor-reader topologies do not, however, offer this advantage.

Self-oscillation still occurs when resonant frequencies are unequal and sensor measurements can be made, albeit with some error due to variations in distance (˜10% over the operation range ˜1 cm). Accordingly, in some examples, the method 1100 may further include making multiple discrete measurements of both the amplitude and frequency of self-oscillation at different distances between the reader resonator and the sensor resonator in order to improve the k-dependence to ˜1% within the operation range ˜1 cm.

### Conclusions

The present disclosure shows that PT-symmetric operation of a system of two coupled resonators allows for coupling-independent, real-time wireless resistive sensing. The present disclosure introduces a monotonically compressive nonlinearity in the negative resistance using MOS transistors whose steady-state voltage amplitude tracks the sensor resistance. These techniques obviate the need for parameter sweeps, enabling a low-complexity, handheld reader with real-time sensing capability.

The system is analyzed in two time scales: a fast-time governing the modes and gain/loss balance; and a slow-time during which the amplitude envelope settles. The theoretical framework provided herein generalizes system analyses to arbitrary coupling and loss conditions, boosting the sensing dynamic range and accuracy. Additionally, the present disclosure shows that although self-oscillation persists even absent PT-symmetric conditions, error is introduced from the resulting coupling dependence. A correction algorithm based on the fast-time analysis reduces this measurement error by an order of magnitude. A hardware prototype validates these theoretical findings and demonstrates wireless single-point measurement of a fully passive resistive sensor. The theoretical framework, nonlinear method, correction algorithm, and simple reader/sensor implementation provided herein will ultimately offer an alternative to conventionally available technologies such as radio-frequency identification (RFID) and near-field communication (NFC), simplifying the measurement of fully passive sensors.

### Example Stamp-Sized Reader for Distance-Independent Wireless Interrogation of Fully Passive RLC Sensors

Fully passive sensors (FPS) consist of a sensing element (resistor or capacitor) and an LC tank. Owing to their simple implementation and battery-free operation, FPSs are employed in many telemetry applications, especially where long-term measurements or extremely low-cost sensors (consumer sensing or food safety) are required. Typically, sensor measurements are performed through near-field inductive coupling (NFIC). Unlike the sensor, the reader design is challenging-existing implementations are power hungry and bulky, therefore not suitable for handheld applications. Moreover, they do not address the distance-dependency of measurements due to NFIC. The present disclosure provides a dual-mode LC oscillator-based reader operating at the point of mode switching which minimizes distance-dependency.

Consider two coupled parallel-parallel RLC resonators with resonance frequencies of f₁ and f₂ which are connected to a negative resistance (FIG. 12A-12D). This circuit can exhibit up to two parallel resonance frequencies, f_{H} and f_{L}, depending on coupling coefficient (k), Rₛ and tank Q (Qₜₐₙₖ). If k<kₘᵢₙ (weak coupling region) only f_{L} (<f_{1,2}) exists and if k>kₘᵢₙ (strong coupling region) both f_{H} (>f_{1,2}) and f_{L} are possible (FIGS. 12A-12D) where kₘᵢₙ is inversely proportional to Rₛ. The input impedance at f_{L,H} is purely real (Zᵢₙ=Rᵢₙ^{L,H}) and if connected to a negative resistance, the resulting dual-mode oscillator selects the frequency with the higher loop gain (gₘRᵢₙ^{L,H}). If Qₜₐₙₖ→∞ and f₁=f₂, Rᵢₙ^{L,H}=L₁ Rₛ/L₂ independent of the coupling coefficient (k) and the oscillator will operate at either f_{L,H} with equal probability. Since k is determined by distance/orientation of coils, this provides a robust measure of the sensor resistance independent of k variations (k-insensitive) so long as k>kₘᵢₙ. This behavior occurs in a series-series configuration as well. However, in practice Qₜₐₙₖ is finite and f₁≠f₂ due to PVT variations or dielectric loading of the coils. Both effects introduce k-sensitivity in measurements. FIGS. 12A-12D illustrate Rᵢₙ^{L,H} and its sensitivity function as a function of k with finite Qₜₐₙₖ and frequency mismatch, showing the higher k-sensitivity compared to the ideal case.

FIGS. 12A-12D suggest that for some Δf=f₁−f₂>0, Rᵢₙ^{L} and Rᵢₙ^{H} branches cross (i.e., ΔR(k)=Rᵢₙ^{L}−Rᵢₙ^{H}=0) which suggests a change in the oscillation frequency (mode switching) from f_{H} to f_{L}. This crossing occurs for all k>kₘᵢₙ at

$$Δ {f}^{C} = \frac{{f}_{s} ( \frac{{Q}_{s}}{{Q}_{tank}} ) ( \frac{{k}^{2}}{1 - {k}^{2}} )}{1 - ( \frac{{Q}_{s}}{{Q}_{tank}} ) ( \frac{{k}^{2}}{1 - {k}^{2}} )} \qquad ( 12 )$$

The input resistance at this crossing point is given by

$${R}_{in}^{C} \approx {R}_{s} \frac{1 + \frac{2 δ}{k}}{1 + \frac{2 {Q}_{s} ( 1 + δ )}{{Q}_{tank} ( 1 + k )}} \qquad ( 13 )$$

where δ=−Δf^{C}/f₁. Rᵢₙ^{C} exhibits a lower k-sensitivity compared to the Rᵢₙ^{L} branch at Δf=0, allowing for a more robust resistive FPS measurement by operating at this crossing point (FIGS. 12A-12D). This crossing point exhibits two unique properties: (1) it has the lowest Rᵢₙ value across Δf and k, and (2) it is the point of mode switching between f_{H}, f_{L}, both of which can be used to detect and lock to this point. The voltage swing of the oscillator is proportional to Rᵢₙ and is required for resistive sensing measurement while detecting the frequency jump however requires extra circuitry (buffers, counter). Therefore, the amplitude property may be used to detect the crossing point. The reader frequency, f₁, is swept until the minimum in swing is detected, the circuit then locks to this point and continuously measures the FPS.

The block diagram of the system is shown in FIG. 13. The VCO is a tail-biased CMOS core with a programmable bias current to provide the required swing range for different ranges of Rₛ. To allow for the largest swing range, thick-oxide devices are used in the VCO core which support up to 3.3V. A 6-bit binary weighted capacitive DAC with LSB of 0.4 pF is used with differential switch and pull-down resistors (FIG. 13), to maintain a reasonable trade-off between varactor Q (Qᵥₐᵣ) and DAC settling time. In this design, the worst case Qᵥₐᵣ corresponds to the smallest capacitor. The free-running frequency of the VCO is selected at the peak of Qₜₐₙₖ (FIGS. 14A-14D). This ensures maintaining a low Qₛ/Qₜₐₙₖ even as f_{L,H} change with k. The inductor of the LC tank is implemented off-chip using copper traces on a flex PCB (polyimide substrate, ε=3.5). The outer dimension of the coil is chosen based on the application and desired readout distance. The coil geometry (width, number of turns, spacing) is optimized to maximize Q (FIGS. 14A-14D). The ED is implemented using a differential PMOS source follower stage in weak inversion (FIGS. 14A-14D). The gate bias of the ED is programmable using a 3-bit R-DAC which keeps the transistors in subthreshold region and sets the output dc voltage of the ED. The bandwidth of the ED is 25 kHz resulting in a settling time of ˜200 us and ripple rejection of >60 dB.

If f₂ or k change, for example, due to the change in the measurement distance or environment (dielectric loading), the reader deviates from the dip in FIGS. 12A-12D, introducing k-sensitivity. An on-chip automatic extremum seeking loop (AESL) mechanism is employed, which sweeps f₁ in discrete steps and calculates the difference between consecutive measurements of the ED output voltage (ΔA). The AESL samples the ED output once per CLK cycle and then produces producing ΔAₙ=A(n)−A(n+1) using a strong-arm latch comparator (FIGS. 14A-14D). A 6-bit positive edge-triggered up/down counter sweeps the 6-bit cap DAC. Upon power-on reset, the counter first up-counts. With each rising edge of the clock, the cap DAC is incremented by one LSB until the sign of AA is flipped, at which point mode switching has occurred. The AESL is a bang-bang controller and upon locking, the signal will toggle indefinitely with each clock edge creating a large ripple on the VCO output because of the asymmetric behavior of Rᵢₙ vs. Δf (FIGS. 12A-12D). To eliminate this ripple, AESL is turned off after locking, then reset and enabled for the next measurement. The clock signal for the counter is generated using a current starved ring oscillator (RO) with a tunable frequency which determines the overall sweep time.

After locking to the optimum point, the measured amplitude is transmitted to a smart phone using ultrasound (US) data communication which offers order of magnitude lower power consumption in the TX compared to RF due to lower carrier frequency. The ED output is applied a current-regulated RO whose frequency is proportional to the ED output (FIGS. 14A-14D). Therefore, the measured data is modulated in the carrier frequency. The 16-20 KHz frequency band was used as the transmit frequency (f_{TX}), where human hearing is about 20 dB weaker compared to 1-10 kHz, but a microphone can still pick up the signal. A commercially available thin film piezoelectric (PZ) is used with dimensions of 0.6 cm×0.6 cm which conforms to curvature, minimizes the cost, and simplifies the design of the PZ TX. f_{TX} is much lower than the thin-film PZ resonance frequency which lowers the TX efficiency, however, since TX only consumes 2% of the total P_{dc} (FIGS. 14A-14D), a low TX efficiency can be tolerated.

The circuit harvests its energy from the near-field communication (NFC) signal of a smart phone in polling mode (FIGS. 15A-15C). The NFC antenna for power harvesting is implemented on the flex PCB. In this application the reader is attached to the back of the phone, the received NFC power can exceed 10 mW, causing large voltage swings (>4V) at the input of the rectifier with nominal load power (chip). A Zener diode (V_{Z}=3.3V) is used to avoid breakdown. The harvested supply powers the bandgap reference (BGR) and two low-drop out regulators, one using an NMOS pass transistor for digital supply (DLDO) and one with a PMOS pass transistor for 3V analog supply (ALDO). On-chip bypass capacitors compensate the former while the latter requires a 1 μF off-chip capacitor. The power-on reset detects the output of the ALDO and issues a ready signal which turns on the AESL and TX RO after ˜5 ms to ensure steady-state in the VCO. The PMU consumes 30 μA of current. The reader operates with a duty cycle of 10%, active for 100 ms every 1 s (from NFC waveform).

The chip was implemented in 40 nm TSMC CMOS technology with an area of 1 mm². Resistive FPS sensing has been demonstrated using a variable resistor on a coil identical to the reader coil. FIGS. 16A-16D illustrate the salient waveforms of the reader in wireless powering setup. The free-running VCO frequency was 33 MHz. The FPS causes a peak in the ED output; the peak value depends on the Rₛ while the DAC value depends on f₂ and k. With the current setup, each full sweep takes about 75 ms (without AESL). The operation with the AESL is also shown in FIG. 16B, in which the loop locks to the dip in Rᵢₙ (peak in ED output). The US signal is received on the smart phone. The FFT of the received audio signal for 4 different Rₛ values is shown in FIG. 16C. To verify robustness of the reader, the distance between the reader and sensor was varied and measurements were repeated, and the FFT of the received audio signals are shown in FIG. 16D for 4 different Rₛ values. Results suggest robust measurements of the sensor resistance within k>kₘᵢₙ.

### Example Robust Wireless Interrogation of Fully-Passive RLC Sensors

### Note

As discussed with respect to this example (“Example Robust Wireless Interrogation of Fully-Passive RLC Sensors”), Cₛ corresponds to C₂ as used elsewhere in this disclosure. Additionally, as discussed with respect to this example: Rᵢₙ corresponds to R_{eff} as used elsewhere in this disclosure and is proportional to 1/g₁; 2πf corresponds to w as used elsewhere in this disclosure; 1/Qₛ corresponds to γ₂ as used elsewhere in this disclosure; and Ω corresponds to ω_{λ} as used elsewhere in this disclosure.

### INTRODUCTION

Fully passive sensors (FPS) are RLC tanks which consist of a sensing element (resistor and/or capacitor) whose value changes in response to a parameter of interest and an inductor (in parallel or series) used to communicate the measured value. Such sensors are chipless and battery-free. Due to their simple implementation, low cost, small size, and weight, they have been demonstrated in many data telemetry applications to measure pH, pressure, humidity, temperature, strain, and many other parameters. Although fully-passive sensors offer considerable lower complexity compared to their active counterparts, they are versatile and can be made flexible and/or biodegradable, making them well-suited for many sensing applications.

Wireless measurement of an FPS is done through near-field inductive coupling as shown in FIG. 19. FPSs provide information through their impedance profile such as resistance, Rₛ, and resonance frequency,

$${f}_{s} = \frac{1}{2 π \sqrt{{L}_{2} {C}_{s}}} ,$$

which correspond to resistive or capacitive sensing, respectively. The reader can be a single coil (non-resonant) or an LC tank (resonant). Because of the operation in the near-field, the sensor impedance alters that of the reader depending on the coupling strength, k, which depends on the relative position between the sensor and reader coils. Therefore, variations in measurement distance act as an undesired disturbance to the system, referred to as k-sensitivity. If k<<1, changes in sensor parameters (Rₛ or Cₛ) are only weakly coupled to the reader and their effects can become too small to detect, posing sensor detectability challenges. Thus, k-sensitivity and sensor detectability determine overall reader robustness.

In a non-resonant reader, the detection of fₛ is performed by monitoring: (1) the dip in the phase, or (2) the peak of the magnitude (or real part) of the input impedance. With a known L₂ the unknown sensor capacitance, Cₛ, can be calculated.

FIG. 20A shows the phase of the input impedance vs. frequency for different coupling strengths, k, suggesting the position of the phase dip is k-sensitive. Therefore, this measurement is not robust if the readout distance or orientation changes. FIG. 20B depicts the real part of the input impedance vs. frequency for different k, which exhibits a peak at a small offset from fₛ if the sensor quality factor is large Qₛ>>1. The frequency at which this peak occurs is k-insensitive and therefore preferred over the phase dip.

Both techniques require measurement of the input impedance across frequency, necessitating a frequency-swept excitation and a complex impedance readout. As such, the reader implementation either includes lab equipment such as a vector network analyzer or an impedance analyzer, or requires complicated frequency synthesis (using direct digital synthesis) and coherent demodulation. Attempts to reduce to the number of sweeps have resulted in more complicated measurement procedures or more complex readers. Another major disadvantage of a non-resonant reader arises from the parasitic resonance of the reader inductor, which introduces k-sensitivity.

The resonant reader, on the other hand, converts the system into two coupled resonators, adding more degrees of freedom. Depicted in FIG. 21A, such a coupled system exhibits one resonance frequency in the weak coupling regime (roughly, k<Qₛ⁻¹) and three resonance frequencies in the strong coupling regime (roughly, k>Qₛ⁻¹). The topology in FIG. 21A has been widely used in wireless power transfer and sensing, and achieves enhanced performance with equal reader and sensor resonance frequencies. In the weak coupling regime, sensor measurement is performed by sweeping the frequency of the applied excitation through VNA (FIG. 21A) and observing the frequency of S₁₁ dip; or sweeping C₁ (or, f₁) in a self-oscillating topology (FIG. 21B) and measuring the dip in the amplitude. As depicted in FIG. 21C, the input resistance of the resonant reader, Rₙₒᵣₘ reaches a minimum (dip) at f₁=fₛ (if Qₛ>>1) in weak coupling. This dip is independent of k, allowing for k-insensitive capacitive sensing in this regime. Since k<<1, sensor detectability can be challenging. Nonetheless, Re{Zᵢₙ} itself is k-sensitive (FIG. 21C) preventing robust resistive sensing in this regime. In the strong coupling regime, three resonance frequencies exist and mode-splitting occurs. Sensor measurement can be done by observing the frequency of S₁₁ dips (corresponding to resonance frequencies); however, their locations are k-sensitive. Therefore, sensing using S₁₁ dips is not robust. A technique for robust resistive sensing in strong coupling by measuring the amplitude of oscillations in a dual-mode LC oscillator has previously been proposed. However, the analysis in previous proposals ignores circuit non-idealities, such as finite coil Q and tank frequency mismatch, both of which deteriorate robustness.

As discussed in this example, the focus is on the resonant reader, with expressions derived for the resonance frequencies and input resistance at finite coil Q and tank frequency mismatch in both weak and strong coupling regimes. The effect of finite coil Q and tank frequency mismatch on the performance of the reader, which is largely ignored in the literature, is examined in this example. The insight and trade-offs provided by the analysis allow for a design with improved robustness.

### Analysis of Resonant Reader Topology

The reader and sensor resonators can have four different configurations, depending on whether the RLC tank is connected in series or parallel. Identical reader-sensor tank configurations (i.e., parallel-parallel and series-series) offer robust resistive sensing in strong coupling. Therefore, this example does not focus on hybrid configurations used in the literature (shown in FIGS. 21A-21C). Consider the schematic shown in FIG. 22A, in which the reader and sensor resonators have a parallel configuration with resonance frequencies of f₁=(2π\sqrt{L₁C₁})⁻¹ and fₛ=(2π\sqrt{L₂Cₛ})⁻¹, respectively. A finite Q is assumed for the reader and sensor inductors, denoted by Q₁=Z₁/r₁ and Q₂=Z₂/r₂, where Z₁=\sqrt{L₁/C₁} and Z₂=\sqrt{L₂/Cₛ} are the characteristic impedance of each tank. We define the coupling strength as k=M/\sqrt{L₁L₂}, where M is the mutual inductance between L₁ and L₂, and the inductance and capacitance ratios as μ=\sqrt{L₁/L₂} and χ=\sqrt{C₁/Cₛ}, respectively. At resonance frequencies (or modes), fᵣₑₛ, we have Im{Zᵢₙ(fᵣₑₛ)}=0, and the input resistance at each mode is Rᵢₙ=Re{Zᵢₙ(fᵣₑₛ)}. The coupled second-order ordinary differential equations (ODEs) are derived from FIG. 22A. The two second-order ODEs can be decomposed into four first-order ODEs in the form d/dτI= [symbol] I, where where I=[i₁ i₂ \Doti₁ \Doti₂]^{T}, and the matrix [symbol] is given by Eq. 14, in which Qₛ≙Rₛ/Z₂ is the equivalent sensor quality factor.

$$ℒ = [ \begin{matrix}0 & 0 & 1 & 0 \\ 0 & 0 & 0 & 1 \\ \frac{1 - \frac{{r}_{1}}{{R}_{in}}}{1 - {k}^{2}} & \frac{k {μχ}^{2} ( 1 + \frac{1}{{Q}_{2} {Q}_{s}} )}{1 - {k}^{2}} & \frac{\frac{{k}^{2} μχ}{{Q}_{s}} + \frac{{Z}_{1}}{{R}_{in}} - \frac{1}{{Q}_{1}}}{1 - {k}^{2}} & \frac{k χ ( \frac{1}{{Q}_{s}} + \frac{1}{{Q}_{2}} ) + \frac{{kZ}_{1}}{μ {R}_{in}}}{1 - {k}^{2}} \\ \frac{k μ ( 1 - \frac{{r}_{1}}{{R}_{in}} )}{1 - {k}^{2}} & \frac{- {μ}^{2} {χ}^{2} ( 1 + \frac{1}{{Q}_{s} {Q}_{2}} )}{1 - {k}^{2}} & \frac{- k μ ( \frac{{Z}_{1}}{{R}_{in}} - \frac{1}{{Q}_{1}} ) - \frac{{μ}^{2} χ k}{{Q}_{2}}}{( 1 - {k}^{2} )} & \frac{- \frac{{k}^{2} {Z}_{1}}{{R}_{in}} - μχ ( \frac{1}{{Q}_{s}} + \frac{1}{{Q}_{2}} )}{1 - {k}^{2}}\end{matrix} ] \qquad ( 14 )$$

Assuming steady-state solutions with e^{jΩt} dependency, where Ω=2πfᵣₑₛ/fₛ is the normalized angular frequency, the solutions may be found by forming the characteristic polynomial as det( [symbol] −jΩI)=0. Equating the real and the imaginary parts of the resulting equation to zero and substituting one into the other yields fᵣₑₛ and Rᵢₙ. The resulting expression can be reduced to a third-order equation, suggesting one or three (fᵣₑₛ⁽ⁿ⁾, Rᵢₙ⁽ⁿ⁾) pairs depending on the system parameters k, Q₁, Q₂, Qₛ, and ρ, where the superscript n denotes the mode index. The Rᵢₙ is of particular interest as it provides a direct measurement of Rₛ. The expression for Rᵢₙ can be readily found by setting the real part of the characteristic polynomial to zero as

$${R}_{in} = {Q}_{s} {Z}_{1} \frac{{Ω}^{2} ( 1 - {k}^{2} ) - {ρ}^{2} ( 1 + \frac{1}{{Q}_{s} {Q}_{2}} ) - ρ ( \frac{1}{{Q}_{1} {Q}_{2}} + \frac{1}{{Q}_{1} {Q}_{s}} )}{ρ [ {Ω}^{2} ( 1 - {k}^{2} ) - 1 + \frac{ρ}{{Q}_{1} {Q}_{2}} ] + \frac{{Q}_{s} ( {Ω}^{2} - {ρ}^{2} )}{{Q}_{1}} + \frac{{Q}_{s} ρ ( {Ω}^{2} - 1 )}{{Q}_{2}}} \qquad ( 15 )$$

in which ρ=μχ=fₛ/f₁. This analysis emphasizes on k-dependency of Rᵢₙ and fᵣₑₛ which is well-suited for FPS sensing. To gain insight on the behavior of Rᵢₙ, three cases are considered below.
Ideal case: ρ=1 and Q₁, Q₂→∞

In this case, the three resonance frequencies are given by

$${f}_{res}^{( 1 , 2 )} = {f}_{s} \sqrt{\frac{2 - \frac{1 - {k}^{2}}{{Q}_{s}^{2}} ∓ \sqrt{{( 2 - \frac{1 - {k}^{2}}{{Q}_{s}^{2}} )}^{2} - 4 ( 1 - {k}^{2} )}}{2 ( 1 - {k}^{2} )}} \qquad ( 16 a )$$

$${f}_{res}^{( 3 )} = \frac{{f}_{s}}{\sqrt{1 - {k}^{2}}} , \qquad ( 16 b )$$

and the corresponding input resistances are

$${R}_{in}^{( 1 , 2 )} = {Q}_{s} {Z}_{1} = {R}_{s} \frac{{Z}_{1}}{{Z}_{2}} = {R}_{s} \frac{μ}{χ} , \qquad ( 17 a )$$

$${R}_{in}^{( 3 )} = \frac{{Z}_{1}}{{Q}_{s}} \frac{1 - {k}^{2}}{{k}^{2}} . \qquad ( 17 b )$$

As can be seen from Eq. (17a), Rᵢₙ^{(1,2)} are k-insensitive. If Z₁=Z₂, or equivalently χ=μ, then Rᵢₙ^{(1,2)}=Rₛ.

Noting that the expressions under the square root in Eq. (16a) should remain positive, it is possible to find a lower bound for k. This minimum value of coupling, kₘᵢₙ is given by

$${k}_{min} = \sqrt{1 - 2 ( {Q}_{s}^{2} + {Q}_{s}^{4} ) + 2 {Q}_{s}^{4} \sqrt{1 + \frac{2}{{Q}_{s}^{2}}}} . \qquad ( 18 )$$

For Qₛ>>1, Eq. (18) suggests kₘᵢₙ≈Qₛ⁻¹ and Eq. (16a) can be approximated by

$${f}_{res}^{( 1 , 2 )} = \frac{{f}_{s}}{\sqrt{1 \pm k}} \cdot k > {k}_{min}$$

is referred to as the strong coupling region in which three resonance frequencies exist. For k<kₘᵢₙ, which is referred to as the weak coupling region, only the third mode exists. Eq. (17b) gives the value of the resistance at the dips in FIG. 21C which is k-sensitive, making the weak coupling region ill-suited for robust resistive sensing. However, when k<<kₘᵢₙ, fᵣₑₛ⁽³⁾≈fₛ, which corresponds to the normalized frequency of the dip (close to 1) in FIG. 21C, yielding robust capacitive sensing. FIGS. 23A and 23B depict the three resonance frequencies, their corresponding input resistances, and regions of operation for the ideal case.
Non-ideal case: ρ=1 and finite coil Q (Q_{1,2}>>Qₛ)

The assumption on Q_{1,2} is to prevent loading of the sensor resistance (Qₛ) by coil loss. In this case, Eq. (15) can be approximated by:

$${R}_{in} \approx {Q}_{s} {Z}_{1} \frac{{Ω}^{2} ( 1 - {k}^{2} ) - 1 - \frac{1}{{Q}_{s}} ( \frac{1}{{Q}_{2}} + \frac{1}{{Q}_{1}} )}{{Ω}^{2} ( 1 - {k}^{2} ) - 1 + {Q}_{s} ( {Ω}^{2} - 1 ) ( \frac{1}{{Q}_{1}} + \frac{1}{{Q}_{2}} )} . \qquad ( 19 )$$

Using Eq. (19) the corresponding fᵣₑₛ along with Rᵢₙ at each mode are found and plotted in FIGS. 23C and 23D. As can be seen from FIG. 23C, the resonance frequencies in the non-ideal case closely follow those in the ideal case, especially for k>kₘᵢₙ, giving a first order approximation for modes as fᵣₑₛ^{(1,2)}=fₛ/\sqrt{1±k}. Unlike Eq. (17a), Eq. (19) and FIG. 23D suggest that Rᵢₙ branches are k-sensitive. It is possible to derive an approximation for Rᵢₙ(k) assuming Ω^{(1,2)}=1/\sqrt{1±k} and k>>(QₛQ_{eff})⁻¹ (reasonable in strong coupling), where Q_{eff}⁻¹=Q₁⁻¹+Q₂⁻¹ as

$$\begin{matrix}{R}_{in}^{( 1 )} ( k ) \approx {Z}_{1} \frac{1 + {Q}_{s} {Q}_{eff} k}{{Q}_{eff} k + {Q}_{s} \frac{k}{1 + k}} \\ \approx \frac{{Q}_{s} {Z}_{1}}{1 + \frac{{Q}_{s}}{{Q}_{eff}} \frac{1}{1 + k}} \\ \approx {Q}_{s} {Z}_{1} ( 1 - \frac{{Q}_{s}}{{Q}_{eff}} \frac{1}{1 + k} )\end{matrix} , \qquad ( 20 a )$$

$${R}_{in}^{( 2 )} ( k ) \approx \frac{{Q}_{s} {Z}_{1}}{1 + \frac{{Q}_{s}}{{Q}_{eff}} \frac{1}{1 - k}} , \qquad ( 20 b )$$

$${R}_{in}^{( 3 )} ( k ) \approx \frac{{Z}_{1} {Q}_{1}}{1 + \frac{{Q}_{1} {Q}_{2} {Q}_{s}}{{Q}_{2} + {Q}_{2}} \frac{{k}^{2}}{{( 1 - {k}^{2} )}^{2}} \frac{1}{{f}_{res}^{{( 3 )}^{2}}}} , \qquad ( 20 c )$$

$$where$$

$${f}_{res}^{( 3 )} \approx {f}_{s} \sqrt{\frac{1 + \frac{{Q}_{s}}{{Q}_{eff}}}{1 - {k}^{2} + \frac{{Q}_{s}}{{Q}_{eff}}}} . \qquad ( 21 )$$

Eq. (20a) suggests that Rᵢₙ⁽¹⁾(k)<QₛZ₁(=Rₛ) due to loading from the coils by a scaled version of Q_{eff}, i.e. (1+k)Q_{eff}. This branch is a weak function of k according to FIG. 23D and the k-sensitivity can be minimized when Q_{eff}>>Qₛ. Eq. (20b) suggests that Rᵢₙ⁽²⁾ suffers from more variation with k due to the (1−k)Q_{eff} term in the denominator, which explains the behavior of this branch in FIG. 23D.

kₘᵢₙ may be approximated by equating Eqs. (17b) and (20a) and solving for k, which yields

$${k}_{min} \approx \frac{1}{{Q}_{s}} \sqrt{1 + \frac{{Q}_{s}}{{Q}_{eff}}} . \qquad ( 22 )$$

According to Eq. (22), the kₘᵢₙ is larger than that for the ideal case, which is also validated by FIGS. 23C and 23D. Below kₘᵢₙ, the circuit exhibits one resonance frequency given by Eq. (21) with its corresponding input resistance given by Eq. (20c). The detectability challenge for the Rᵢₙ⁽³⁾(k) branch in weak coupling can be seen from Eq. (20c) since the only dependence on Qₛ is in the denominator where it is attenuated by k².
General case: ρ≠1 and Q_{1,2}>>Qₛ

Using the same approximation as in the non-ideal case,

$${Ω}^{( 1 , 2 )} = \frac{1}{\sqrt{1 \pm k}} , and k ≫ {( {Q}_{s} {Q}_{eff} )}^{- 1} ,$$

$${R}_{in}^{( 1 )} ( k , ρ ) \approx {Q}_{s} {Z}_{1} \frac{k - 1 + {ρ}^{2}}{ρ k + \frac{{Q}_{s}}{{Q}_{eff}^{( 1 )}}} , \qquad ( 23 a )$$

$${R}_{in}^{( 2 )} ( k , ρ ) \approx {Q}_{s} {Z}_{1} \frac{k + 1 - {ρ}^{2}}{ρ k + \frac{{Q}_{s}}{{Q}_{eff}^{( 2 )}}} , \qquad ( 23 b )$$

$${R}_{in}^{( 3 )} ( k , ρ ) \approx \frac{{Z}_{1} {Q}_{1}}{1 + \frac{{Q}_{1} {Q}_{2} {Q}_{s}}{{Q}_{2} + {Q}_{2}} \frac{{k}_{2}}{\begin{matrix}{[ {k}^{2} + σ ( \frac{1}{β} - ρ ) {Q}^{′2} ( 1 - {k}^{2} ) ]}^{2} + \\ \frac{{[ 1 + σ ( \frac{1}{β} - ρ ) {Q}^{′2} ]}^{2}}{{Q}^{′2}}\end{matrix}}} , \qquad ( 23 c )$$

$$where$$

$${{Q}_{eff}^{( 1 )} = [ \frac{1}{{Q}_{1}} ( {ρ}^{2} - \frac{1}{1 + k} ) + \frac{1}{{Q}_{2}} \frac{ρ k}{1 + k} ) ]}^{- 1} , \qquad ( 24 a )$$

$${{Q}_{eff}^{( 2 )} = [ \frac{1}{{Q}_{1}} ( \frac{1}{1 - k} - {ρ}^{2} ) + \frac{1}{{Q}_{2}} \frac{ρ k}{1 - k} ) ]}^{- 1} , \qquad ( 24 b )$$

$$and β = \sqrt{1 - \frac{1 - {k}^{2}}{{Q}^{′2}}} , σ = {k}^{2} {Q}^{′2} \sqrt{1 - {k}^{2} {Q}^{′2}} ,$$

Q′=Q₁∥Q₂∥Qₛ. In this case, kₘᵢₙ is a function of ρ, and for small ρ, can be approximated by

$${k}_{min} \approx \frac{1}{{Q}_{s}} \sqrt{1 + \frac{{Q}_{s}}{{Q}_{eff}} + 2 {Q}_{s} ρ \vert 1 - {ρ}^{2} \vert} , \qquad ( 25 )$$

predicting a larger kₘᵢₙ compared to the non-ideal case. Similar to the non-ideal case, Rᵢₙ⁽³⁾, which only exists in weak coupling, suffers from a detectability challenge. FIGS. 24A-24B summarize the resonance frequencies, their corresponding input resistances, and regions of operation. FIGS. 24A-24B clearly demonstrate that frequency mismatch exacerbates k-sensitivity and hence the robustness of FPS sensing, compared to the non-ideal case.

The analysis in this section reveals that operation in strong coupling region can provide robust FPS sensing. As such, in the remainder of this example, the focus is on operation in strong coupling.

### Stable Oscillation Frequency

The system of two coupled resonators in FIG. 21A is effectively an LC oscillator whose steady-state amplitude and oscillation frequency can provide for resistive and capacitive sensing, respectively. The oscillations build up and sustain at the resonance frequency with a higher Rᵢₙ as it experiences a higher loop gain. The analysis in the previous section (FIGS. 23A-23D and 24A-24B) showed that in the strong coupling region, Rᵢₙ⁽³⁾<Rᵢₙ^{(1,2)}. As such, in the strong coupling region, fᵣₑₛ⁽³⁾ will never be selected by the oscillator. In order to determine which of the fᵣₑₛ^{(1,2)} is the stable oscillation frequency, a parameter is defined below:

$$Δ ( k , ρ ) = \frac{{R}_{in}^{( 1 )} ( k , ρ ) - {R}_{in}^{( 2 )} ( k , ρ )}{{Q}_{s} {Z}_{1}} . \qquad ( 26 )$$

If Δ>0, then f_{osc}=fᵣₑₛ and if Δ<0, then f_{osc}=fᵣₑₛ⁽²⁾, where f_{osc} is the oscillation frequency. Therefore, focusing on the dependency of the sign of Δ(k, ρ) on ρ, first, for Q₁, Q₂→∞, Q_{eff}⁽¹⁾, Q_{eff}⁽²⁾→∞ and one can write

$$Δ ( k , ρ ) = 2 \frac{{ρ}^{2} - 1}{ρ k} . \qquad ( 27 )$$

$$Therefore ,$$

$$\{ \begin{matrix}ρ > 1 \to Δ ( k , ρ ) > 0 \to {f}_{osc} = {f}_{res}^{( 1 )} \\ ρ < 1 \to Δ ( k , ρ ) < 0 \to {f}_{osc} = {f}_{res}^{( 2 )}\end{matrix} . \qquad ( 28 )$$

Eq. (28) suggests that oscillation at fᵣₑₛ⁽¹⁾ or fᵣₑₛ⁽²⁾ is independent of k and only determined by ρ. Therefore, sweeping ρ and measuring f_{osc} can be potentially used for robust capacitive sensing.

However, as suggested by Eq. (23b) finite Q_{1,2} causes Q_{eff}⁽²⁾ to become heavily loaded, especially at moderate to high values of k. This is because for a large enough k, (1−k)⁻¹+ρ²>>1 in Eq. (24b). This reduces Rᵢₙ⁽²⁾(k, ρ) and can make Δ(k, ρ)>0 even when ρ<1, in stark contrast to what Eq. (28) predicted. This means that the ρ at which the mode switches (from fᵣₑₛ⁽¹⁾ to fᵣₑₛ⁽²⁾ or vice versa) will become k-sensitive. As will be explained below, this prevents robust capacitive sensing. This is a direct consequence of finite coil Q.

To illustrate this, FIGS. 25A-25B depict A (k, ρ) for infinite and finite Q₁, Q₂, respectively, as ρ varies. The shaded regions correspond to the condition for which a certain frequency branch is selected by the oscillator based on the sign of Δ(k, ρ). As suggested by FIG. 25B, for ρ<1, finite Q_{1,2} pushes Δ(k, ρ) to negative values for some values of k. Below are some design guidelines on how to reduce k-sensitivity in capacitive FPS sensing.

### Sensor Readout Mechanism

### Resistive Testing

For resistive sensing, it is assumed that Cₛ, and therefore fₛ are fixed and any variations in fₛ is due to dielectric loading of L₂. As shown above, when ρ=1, the stable oscillation frequency corresponds to Rᵢₙ⁽¹⁾ and the input resistance can be measured with a weak dependence on k (see, e.g., Eq. (23a) and FIG. 23A-23D). To quantify the dependence on k, the k-sensitivity of Rᵢₙ⁽¹⁾ is defined using Eq. (23a) as

$$\begin{matrix}\vert {S}_{k}^{{R}_{in}^{( 1 )}} \vert = \vert \frac{\partial {R}_{in}^{( 1 )}}{\partial k} \frac{k}{{R}_{in}^{( 1 )}} \vert \\ = \vert \frac{k}{k + \frac{2}{{Q}_{s} {Q}_{0}}} - \frac{1 + \frac{2 {Q}_{s}}{{Q}_{0}} \frac{1}{{( 1 + k )}^{2}}}{1 + \frac{2 {Q}_{s}}{{Q}_{0}} \frac{1}{1 + k}} \vert\end{matrix} , \qquad ( 29 )$$

in which Q₁=Q₂=Q₀ for simplicity.

In the presence of frequency imbalance, for example ρ=1+δ, where |δ|<<1, Rᵢₙ exhibits an additional dependence on ρ and a stronger dependence on k (general case above). Accordingly,

$$\{ \begin{matrix}Δ ( k , ρ ) > 0 \to {R}_{in} = {R}_{in}^{( 1 )} \approx {Q}_{s} {Z}_{1} \frac{1 + \frac{2 δ}{k}}{1 + \frac{{Q}_{s}}{{Q}_{0}} \frac{2}{1 + k}} , \\ Δ ( k , ρ ) < 0 \to {R}_{in} = {R}_{in}^{( 2 )} \approx {Q}_{s} {Z}_{1} \frac{1 - \frac{2 δ}{k}}{1 + \frac{{Q}_{s}}{{Q}_{0}} \frac{2}{1 - k}} .\end{matrix} \qquad ( 30 )$$

In this case, it is relevant to calculate the sensitivity for both input resistances:

$$\vert {S}_{k}^{{R}_{in}^{( 1 )}} \vert = \vert \frac{\frac{2 {Q}_{s}}{{Q}_{0}} \frac{k}{{( 1 + k )}^{2}} ( 1 + \frac{2 δ}{k} ) - \frac{2 δ}{k} ( 1 + \frac{2 {Q}_{s}}{{Q}_{0}} \frac{1}{1 + k} )}{( 1 + \frac{2 δ}{k} ) ( 1 + \frac{2 {Q}_{s}}{{Q}_{0}} \frac{1}{1 + k} )} \vert \qquad ( 31 a )$$

$$\vert {S}_{k}^{{R}_{in}^{( 2 )}} \vert = \vert \frac{\frac{2 δ}{k} ( 1 + \frac{2 {Q}_{s}}{{Q}_{0}} \frac{1}{1 - k} ) - \frac{2 {Q}_{s}}{{Q}_{0}} \frac{k}{{( 1 - k )}^{2}} ( 1 - \frac{2 δ}{k} )}{( 1 - \frac{2 δ}{k} ) ( 1 + \frac{2 {Q}_{s}}{{Q}_{0}} \frac{1}{1 - k} )} \vert \qquad ( 31 b )$$

Eq. (31a) and (31b) show that Rᵢₙ⁽²⁾ suffers from more sensitivity due to the (1−k) term. Specifically, for δ<0 (ρ<1) it is possible to have Rᵢₙ⁽²⁾<Rᵢₙ⁽¹⁾ for some k>k_{c}.

FIGS. 26A-26B depict the above sensitivities for two values of Qₛ/Q₀ and suggest that resistive sensing without frequency imbalance achieves the best sensitivity (non-ideal case). Introduction of frequency imbalance changes the sensitivity differently depending on the sign of δ and the value of k (general case). When δ<0, the branch switching behavior can be clearly observed by the discontinuity at k=k_{c} in FIGS. 26A-26B. For moderate to high k values, a δ>0 results in a better sensitivity compared to the ideal case; however, the overall sensitivity varies by an order of magnitude over k. As such, Sₖ^{R}^{ᵢₙ} for δ=0 exhibits the best behavior. FIGS. 27A-27D depict the resistive sensing error as a function of p for four different cases of Qₛ and Q₀. FIGS. 27A-27D illustrate that the error is smaller in the ρ>1 region which corresponds to the Rᵢₙ⁽¹⁾ branch. Resistive sensing therefore can be performed by measuring the Rᵢₙ⁽¹⁾ branch.

### Capacitive Sensing

Measuring f_{osc} and detecting the point of mode switching offers a means of measuring Cₛ. For each value of k>kₘᵢₙ, one can find the ρ for which Δ(k, ρ)=0 (the point of mode switching). Setting Eq. (26) to zero, yields:

$$2 {ρ}^{2} ( 1 + α ) + 2 ρ {k}^{2} α + α ( {k}^{2} - 2 ) - 2 = 0 , \qquad ( 32 )$$

$$where$$

$$α = \frac{{Q}_{s}}{{Q}_{0}} \frac{1}{1 - {k}^{2}} . \qquad ( 33 ) .$$

The solution to Eq. (32) is:

$$ρ \approx \frac{1}{\sqrt{1 + α k}} . \qquad ( 34 )$$

In order to perform capacitive sensing, sweeping of f₁, or equivalently ρ=fₛ/f₁, would cause a jump from one frequency branch to another at the ρ given by Eq. (34). If L₂=L₁ is known, then one can write C₁=Cₛ(1+αk)⁻¹ from Eq. (34). As such, the error in the measured capacitance is approximately given by ΔC=αkCₛ for a small α.

FIGS. 28A-28D show the frequency of oscillation as a function of ρ for different values of k. As shown in FIGS. 28A-28D (dashed lines), with infinite Q₀, the frequency jump always occurs at ρ=1 for k>kₘᵢₙ. However, with finite Q₀, ρ follows Eq. (34). The k-sensitivity for capacitive sensing is given by:

$$\vert {S}_{k}^{{C}_{1}} \vert = \vert \frac{{Q}_{s}}{{Q}_{0}} \frac{1 + {k}^{2}}{( 1 - {k}^{2} )} \frac{k}{1 + \frac{{Q}_{s} k}{{Q}_{0} 1 - {k}^{2}}} \vert , \qquad ( 35 )$$

revealing that as k increases, the oscillation frequency will be more biased toward fᵣₑₛ⁽¹⁾, requiring a smaller ρ to cause the frequency branch jump, and hence increasing ΔC. Eq. (35) suggests this k-sensitivity can be reduced by minimizing Qₛ/Q₀ and limiting the readout range to medium range of k. We conclude from FIGS. 26A-26B that capacitive sensing exhibits the worst sensitivity especially at moderate to high values of k. FIGS. 26A-26B show that a smaller Qₛ/Q₀ results in a lower sensitivity for all cases (except when δ>0 for Sₖ^{R}^{ᵢₙ}).

### Design Tradeoffs and Guidelines

As discussed above, the important parameter that determines the robustness of both sensing modalities is

$$\frac{{Q}_{s}}{{Q}_{0}} = \frac{{R}_{s} {r}_{0}}{{Z}_{0}^{2}} , \qquad ( 36 )$$

where r₀ is the series resistance of the coils and Z₀=Z₁=Z₂. Eq. (36) suggests that minimizing Qₛ/Q₀ can be achieved by reducing r₀, increasing Z₀, and lowering Rₛ. The design should therefore seek to minimize coil losses. To this end, the coil geometry should be optimized, for example by selecting thick and wide metal traces on a low-loss substrate. In order to double Z₀ while maintaining the same fₛ, L₂ should be doubled while Cₛ halved. This causes r₀ to increase but with a factor less than two depending on L₂ doubling strategy, which causes Qₛ/Q₀ to scale down by more than a factor of two. As such, where possible, Cₛ should be selected to be as small as possible.

In resistive sensing, Rₛ is mainly dictated by the sensor range and cannot be set arbitrarily. However, since Cₛ can be selected freely, the circuit parasitics (of the oscillator and envelope detector) determine C_{1,min}(=C_{s,min}). In capacitive sensing, the presence of a load resistance is not necessary as the information is in Cₛ. Without Rₛ, Qₛ→∞, which severely deteriorates the k-sensitivity (FIGS. 28A-28D). To resolve this issue, de-Q-ing can be employed by deliberately loading the sensor coil by a resistor. Further, reducing Cₛ in order to increase Z₀ limits the capacitive sensing range.

Both de-Q-ing and increasing Z₀ result in a lower Qₛ(=RₛZ₀⁻¹) and since kₘᵢₙ∝Qₛ⁻¹, this also calls for a larger kₘᵢₙ. The coupling coefficient between two coils can be estimated by

$$k ( d ) = {( \frac{{r}_{s} {r}_{r}}{{d}^{2} + {r}_{s}^{2} + {r}_{r}^{2}} )}^{\frac{3}{2}} cos θ , \qquad ( 37 )$$

where rₛ and rᵣ are the sensor and reader coil radii, d is the distance between the two, and θ is the angle between the planes. Eq. (37) suggests that dₘₐₓ∝kₘᵢₙ⁻¹, where dₘₐₓ is the largest d for which operation in strong coupling can be achieved. As such, lowering Qₛ decreases the readout distance. The forgoing discussion points to the range-robustness trade-off in FPS sensing.

The range of resistance variations is determined by two conditions. The upper limit should be chosen such that Qₛ/Q₀ is small enough to yield a reasonable k-sensitivity (measurement error in FIGS. 27A-27D) for the application. The lower limit is determined by two considerations: (1) the readout distance; a lower Rₛ corresponds to a smaller Qₛ and requires a larger kₘᵢₙ and hence a smaller dₘₐₓ, (2) power consumption of the reader; the minimum required loop gain of the oscillator for start-up and hard switching. The capacitive sensing range is determined by the required range of the varactors on the reader as well as the coil Q at the corresponding fₛ.

### Hardware Prototypes

### Coil Design

Although wire-wound coils yield a higher quality factor, they cannot be batch-fabricated, mass-produced or miniaturized without the use of custom machinery. As such, it can be envisioned that coils employed in widespread sensing applications will be fabricated as planar structures on a substrate (rigid or flexible), making them amenable to easier implementation and optimization. Here, we have opted for a flexible substrate (polyimide) that can conform to surface curvature. We employ two metal layers and a circular design to maximize area to perimeter ratio of the coils. Copper trace thickness of 55 μm (1.5 oz) is chosen in this example, which requires a substrate thickness of 200 μm.

The inductance value is a strong function of the outer dimension of the coils, Dₒᵤₜ, and the number of turns, N. The Dₒᵤₜ of the coils is selected primarily according to the application and directly affects the measurement range dₘₐₓ (Eq. (37)). Assuming rᵣ=rₛ=r, dₘₐₓ can be approximated by

$${d}_{max} \approx r \sqrt{{Q}_{s}^{\frac{2}{3}} - 2.} \qquad ( 38 )$$

Implantable biomedical devices (IMDs) have stringent requirements on size, while other consumer remote telemetry devices are more relaxed, for example, humidity or pH sensors, among others. In this example, two sets of coils are developed, one for IMD applications (set 1) and another for consumer remote telemetry (set 2).

The sensor outer dimension was selected to be D_{out,s}=1 cm for set 1. The optimization leads to increasing trace width, W, while reducing the number of turns, N, to maintain the same Dₒᵤₜ, both of which result in a small L₂. Next, the dimensions of the reader coil should be determined. To this end, we examine the effect of coil dimensions on k with distance and lateral misalignment which is important for IMD applications. FIG. 29A shows the conceptual configuration of the reader and sensor coils while FIG. 29B shows k vs. d for D_{out,s}=2rₛ=1 cm and different D_{out,r} values. As can be seen from FIG. 29B, identical coils have larger k at short distance, however, as d increases, pairs with unequal Dₒᵤₜ achieve a larger k. Additionally, coupling is attenuated with lateral misalignment, Δy. FIG. 29C shows k vs. Δy for D_{out,s}=1 cm and different D_{out,r} values at d=1 cm. FIG. 29C illustrates that with identical coils, Δy causes further k degradation. Considering both observations, D_{out,r}=2 cm is selected for the reader coil in this case. The W and N are selected with the same optimization process done for the sensor coil.

The dimensions of the optimized coils for set 1 is shown in FIG. 30, where r₀ and Cₚ denote the series resistance and parallel parasitic capacitance of the coils. Cₚ will be directly absorbed by the tank capacitances (C₁ and Cₛ in FIG. 22A).

Set 2 coils are designed with identical dimensions of Dₒᵤₜ=2 cm (similar to the reader coil of set 1). This allows for a larger Q (at lower frequency) as well as a longer readout distance (Eq. (38)). The coil parameters such as L, r₀, Q, and self-resonance frequency (SRF) have been approximated using methods for optimization and then verified using full-wave simulation (HFSS).

The frequency of oscillation is related to k and the tank resonance frequency and should be selected such that a reasonable Q_{eff} is achieved over the range of k variations (i.e., between f₀ and f₀/\sqrt{1+k}). In some cases, the parasitic capacitance of the reader or the explicit sensing capacitance may result in f_{osc}<fₘₐₓ, where fₘₐₓ is the frequency at which Q peaks (Qₘₐₓ). In this scenario, the maximum possible f_{osc} should be chosen based on the parasitics to limit Q degradation. In resistive sensing, this translates to not employing any explicit capacitor on the reader resonator (C₁=0) such that all the reader capacitance come from the parasitics. In practice, due to the finite tolerance in Cₛ, some additional C₁≠0 is required to ensure ρ→1. In capacitive sensing, the range of Cₛ variations is dictated from the application and some Q-degradation due to this frequency offset is inevitable. With proper coil and f_{osc} optimization, the Q-degradation due to these effects can be limited.

### Choice of Sensing Modality

As discussed above, a coil with small area achieves a modest Q at tens of MHz. Moreover, for IMD applications, k is further attenuated according to k∝e^{-γd}, where γ is the attenuation constant of the medium, due to the tissue.

Additionally, as discussed above, resistive FPS sensing offers more robustness. As such, the resistive modality for the IMD application is employed in this example. The IMD FPS is coated with clear epoxy to reduce the effect of quality factor and dielectric loading when implanted in the tissue.

For the IMD case, μ≠1 since the coils have different sizes. If ρ=1 to achieve the lowest k-sensitivity, then μ=χ⁻¹ and Eq. (20a) can be written as

$${R}_{in}^{( 1 )} ( k ) \approx {R}_{s} {μ}^{2} ( 1 - \frac{{Q}_{s}}{{Q}_{eff}} \frac{1}{1 + k} ) , \qquad ( 39 )$$

for Qₛ<Q_{eff}. Eq. (39) suggests that a scaled version of Rₛ is presented to the oscillator.

Capacitive FPS sensing, on the other hand, requires a more careful design and operation. Unlike resistive modality in which k-sensitivity varies only slightly with k (see FIGS. 26A-26B) the capacitive sensing error exacerbates drastically at larger k. However, in most practical applications, k will not exceed 0.6-0.7. Therefore, the capacitive modality may be used for the general non-implantable application which is not as area-limited, allowing for larger coils. Increasing coil size enables a higher Q which enhances the robustness of sensing.

### Circuit Implementation

The circuit prototype is built using off-the-shelf components on a flexible substrate. A bipolar cross-coupled oscillator core is selected in this design, as shown in FIG. 31. For a tail-biased cross-coupled oscillator with hard switching, the peak differential swing is given by

$${V}_{p} = \frac{2}{π} {I}_{EE} {R}_{in} , \qquad ( 40 )$$

where I_{EE} is the tail bias current. I_{EE} should be selected large enough to have enough loop gain and hard switching occur for the smallest sensor resistance, where the latter is a more stringent requirement. In practice, the peak voltage may deviate from Eq. (40) since the current waveform is not an ideal square. Further calibration can be performed using a sensor with known resistance for higher accuracy.

In order to prevent forward-biasing the base-collector diode of T_{1,2}, the base is accoupled from the collector, as shown in FIG. 31. V_{B} is selected to allow enough headroom for T_{1,2} and the tail current source, M₃. The maximum output differential swing is equal to V_{DD,osc}−V_{B}+V_{BC,sat}, where V_{BC,sat} is the base-collector saturation voltage. In this design, V_{B}=1.1V and the oscillator can support up to a differential swing of 2.4Vₚ, which corresponds to R_{in,max}≈2.7 kΩ.

As shown in FIG. 31, a differential diode-based envelope detector (ED) is employed which is followed by a differential-to-single ended buffer with embedded low-pass filtering (LPF). The measured amplitude at the output of the buffer is equal to Vₚ−2V_{D,on}, where V_{D,on} is the on-voltage of the diodes. V_{D,on} is a function of the current through the diode which depends on Vₚ. In order to minimize this effect, R_{D} and R_{3,4} should be large which also prevents loading of the tank. However, this increases the amplitude settling time. Amplitude ripple, V_{R}, should be minimized so that its effect becomes insignificant compared to the variations of the amplitude (equivalently, Rᵢₙ) over the range kₘᵢₙ<k<1. Specifically, V_{R} may be chosen such that when converted to variations in Rᵢₙ, it remains much smaller than the variation of Rᵢₙ(k) within kₘᵢₙ<k<1, which translates to

$${V}_{R} ≪ \frac{{I}_{EE} {Z}_{1} {Q}_{S}^{2}}{π {Q}_{eff}} . \qquad ( 41 )$$

Together with C_{D} and C_{F}, R_{D} and R_{3,4} should be chosen based on the trade-off between the diode on-voltage and ripple attenuation (robustness) on one hand and settling time (measurement sampling rate) on the other. The two stages of LPF provide >60 dB ripple rejection with τ=200 μs, allowing for a measurement rate of <1kSps.

Due to the nonlinearity profile of the cross-coupled pair, a hysteresis effect is observed when the frequency of the oscillator is being continuously swept (by varying C₁). The oscillator resists to switch to the frequency branch with a higher loop gain, preventing mode switching to happen according to FIGS. 28A-28D. Cycling the oscillator off and on (through M_{5,6} in FIG. 31) resets the oscillator and suppresses this hysteresis. This will increase the overall sweeping time for capacitive sensing, but will not cause an issue for resistive sensing as it does not require frequency sweeping. The varactor along with the digital-to-analog converter allows for sweeping the tank capacitance to perform capacitive sensing.

To measure the frequency of oscillations, a divider is used to lower the frequency to the range compatible with the microcontroller. The oscillator can be tuned from 30 MHz to 55 MHz by sweeping the varactor.

### Measurement Results

The circuit shown in FIG. 31 and the FPSs were implemented using discrete components on a flexible PCB, shown in FIG. 32. The microcontroller was used to set the reader capacitance value, generate the reset signals (used when frequency sweeps are performed), and record the amplitude and f_{osc}.

In order to demonstrate measurement of resistive FPS, four different load resistances were soldered on identical sensor coils, all with the same resonance frequency of 53 MHZ (±1%, due to finite tolerance of ceramic capacitors). The reader oscillation frequency was tuned to 53 MHz. This value is slightly off from the optimum frequency of operation at which Q_{eff} peaks (55 MHZ), however, the Q-degradation effect is negligible (<1%). It was determined from simulation that the maximum achievable coupling was kₘₐₓ≈0.13 with perfect alignment and minimum distance between the coils of set 1. This translates to a Rₛ≈350Ω from Eq. (22). As such, the smallest sensor resistance equal to 470Ω was selected in order to demonstrate k-insensitive measurements up to slightly below kₘₐₓ.

The distance between the reader and sensor was varied while frequency and amplitude of oscillations were measured. The measured data (resistance and frequency) was used to find k by matching the corresponding points to simulation results. FIG. 33A shows the measured and calculated normalized oscillation frequency. FIG. 33B depicts the measured amplitude, which can be converted to Rᵢₙ using Eq. (40). However, owing to the mismatch in the coil inductances of set 1, the measured resistance is expected to be a scaled version of Rₛ according to Eq. (39). From FIG. 30, μ=\sqrt{2}, Q_{eff}≈53, Qₛ=11.4, which results in R_{in,meas}=1.63Rₛ at kₘₐₓ for R_{s,min}=470Ω. The scaling factor is measured to be 1.663 Rₛ which is extremely close to the calculated value. FIG. 33B also illustrates the input resistance measured for each Rₛ normalized to 1.663R_{s,min}=782Ω, i.e. R_{meas,n}=R_{in, meas}/(1.663R_{s,min}). For comparison, the calculated Rᵢₙ above in this example is normalized by the same factor and plotted with dashed lines in FIG. 33B as well, suggesting a close agreement with measurement results. FIGS. 33A-33B confirm the analysis discussed above with respect to this example for: ρ=1; fᵣₑₛ⁽¹⁾ and Rᵢₙ⁽¹⁾ emerges as the stable oscillation mode.

Since the scaling factor given by Eq. (39) depends on Rₛ, the measured resistance, Rᵢₙ⁽¹⁾(k), does not scale by the same factor as Rₛ, as evident from FIG. 33B. Therefore, the reader should be calibrated using a known sensor resistance at any k>kₘᵢₙ (or, d<dₘₐₓ) to provide a baseline measurement for each Rₛ. The results can be stored in a look-up table and used to convert the measured amplitude to a resistance value directly. FIG. 33B clearly shows that the maximum amplitude of oscillations is limited to 2.2V. This is 200 mV lower than the expected value discussed above with respect to this example, mainly due to a lower V_{BC,sat} than that reported in the datasheet.

Another resistive FPS was prepared with a thermistor as sensing element with fₛ≈53 MHz. The sample was encapsulated using clear epoxy and implanted subcutaneously under chicken thigh skin. In order to emulate temperature variation, we generated local heat around the FPS by placing a 10-Ω high-power rating resistor and applying a dc voltage to it. As a baseline measurement, a digital temperature sensor was implanted next to the FPS and the heat generating resistor. The reader in this case operated from a 3.7V/120 mAh coin battery and the amplitude of oscillation was measured and wirelessly transmitted from the microcontroller to a PC using Bluetooth Low-Energy for post-processing. The reader was held on top of the implant to the extent possible since exact alignment between the reader and sensor coils cannot be guaranteed as the sensor is small and will conform to the curvature of the meat. The measurement range is each consecutive measurement will be slightly different since the reader is held by hand, but it covers a range from directly on the skin up to 1.2 cm above the skin. FIGS. 34A-34C show the measurement setup in this case. The local temperature of the heat generating resistor was measured using a thermal camera (FLIR) to verify its functionality. FIG. 35 shows the measured temperature from the reader and that measured from the digital sensor continuously, suggesting that the reader follows the temperature variations closely to within ±1° C. As can be seen from FIG. 35, the temperature measured at the FPS and the digital temperature sensor is lower than the local temperature at the heat generating resistor.

To perform capacitive FPS sensing, two identical coils are used. A trimmable capacitor is used on the FPS to emulate a capacitive sensor. The frequency on the reader is swept through the DAC and the oscillation frequency with and without the FPS was measured while the distance between the two was varied. The measured frequency and amplitude was used to extract the k from simulation. To illustrate the effect of Qₛ/Q_{eff}, the same measurement was taken using two Rₛ values which are listed in FIG. 37. The value of ρ for which frequency branch jump occurs is shown in FIGS. 36A-36B, along with the theoretical values. The error in the capacitance value is |ΔC/Cₛ|=|1−ρ²]. FIGS. 36A-36B demostrate that de-Q-ing the FPS does not completely eliminate the k-sensitivity, but it makes the measurement more robust, however, it increases kₘᵢₙ at the same time (in this case by a factor 1.7). Since capacitive modality suffers from more k-sensitivity, it should be employed only in applications where the error is acceptable.

### Conclusions

In this example, a self-oscillating coupling-independent passive sensor measurement technique was presented, which measures both capacitance and resistance of a FPS. The resonance frequencies, input resistance, and regions of operation were derived assuming a finite Q for the sensor and reader inductors and frequency mistuning. The example illustrates that resonators with identical configuration (parallel-parallel or series-series) are capable of k-insensitive impedance transformation which can be applied to FPS sensing.

In the PP configuration, finite inductor Q and frequency mistuning deteriorate robustness and introduce coupling-dependency in the measured resistance and capacitance. Design guidelines on how to suppress the former are provided herein. The dual of the PP configuration, that is, the SS configuration, is robust to the effect of finite inductor Q, its implementation is not straightforward for a self-oscillating solution. The main challenge is the design of a negative resistance which can oscillate exactly at the series resonance frequency of the coupled resonators. Cross-coupled or three-point oscillators cannot be employed since the resulting circuit will not oscillate at the right frequency.

The analysis discussed with respect to this example provides an alternative understanding of the dual-resonator system, with focus on k-dependence of the input impedance while accounting for the system non-idealities. This analysis can be extended and applied to optimized wireless power transfer as well as impedance transformation.

### Appendix A: Fast-time Scale Derivations

Here, the real modes (eigenfrequencies) and effective resistances, R_{eff} seen by the negative resistance are derived for four resonator combinations shown in FIG. 38A-D. These results are confirmed by circuit impedance analyses.

### A.1. Parallel-Parallel Resonator Topology Derivations

First, the parallel-parallel topology, as shown in FIG. 38A, is considered. Capacitor currents may be written as

$${iC}_{n} = \frac{{dq}_{n}}{dt}$$

and resistor currents may be written as

$${i}_{{R}_{1}} = - \frac{{v}_{1}}{{R}_{1}} = - {g}_{1}^{p} {ω}_{1} {q}_{1}$$

and i_{R}_{₂}=γ₂^{p}ω₂q₂, where superscript “p” signifies parallel topology. KCL yields

$${i}_{{L}_{1}} = {g}_{1}^{p} {ω}_{1} {q}_{1} - \frac{{dq}_{1}}{dt} , \qquad ( SA . 1 a )$$

$${i}_{{L}_{2}} = {γ}_{2}^{p} {ω}_{2} {q}_{2} - \frac{{dq}_{2}}{dt} , \qquad ( SA . 1 b )$$

and the i-v relationships at the inductors are given by

$${v}_{1} = \frac{{q}_{1}}{{C}_{1}} = {L}_{1} \frac{{di}_{{L}_{1}}}{dt} + M \frac{{di}_{{L}_{2}}}{dt} \to {ω}_{1}^{2} {q}_{1} = \frac{{di}_{{L}_{1}}}{dt} + \frac{κ}{μ} \frac{{di}_{{L}_{2}}}{dt} , \qquad ( SA . 2 a )$$

$${v}_{2} = \frac{{q}_{2}}{{C}_{2}} = {L}_{2} \frac{{di}_{{L}_{2}}}{dt} + M \frac{{di}_{{L}_{2}}}{dt} \to {ω}_{2}^{2} {q}_{2} = \frac{{di}_{{L}_{2}}}{dt} + κμ \frac{{di}_{{L}_{1}}}{dt} . \qquad ( SA . 2 a )$$

Time is normalized by τ=ω₁t, and substitute Eqs. SA.1 into Eqs. SA.2 to obtain Eqs. 1,

$$\frac{{d}^{2} {q}_{1}}{d {τ}^{2}} = - \frac{1}{1 - {κ}^{2}} {q}_{1} + \frac{κμχ}{1 - {κ}^{2}} {q}_{2} + {g}_{1}^{p} \frac{{dq}_{1}}{d τ} , \qquad ( SA . 3 a )$$

$$\frac{{d}^{2} {q}_{2}}{d {τ}^{2}} = - \frac{κμ}{1 - {κ}^{2}} {q}_{1} - \frac{{μ}^{2} {χ}^{2}}{1 - {κ}^{2}} {q}_{2} - {γ}_{2}^{p} μχ \frac{{dq}_{2}}{d τ} . \qquad ( SA . 3 b )$$

These equations can be re-written using the Liouvillian formalism:

$$\frac{d}{d τ} [ \begin{matrix}{q}_{1} \\ {q}_{2} \\ {\dot{q}}_{1} \\ {\dot{q}}_{2}\end{matrix} ] = [ \begin{matrix}0 & 0 & 1 & 0 \\ 0 & 0 & 0 & 1 \\ - \frac{1}{1 - {κ}^{2}} & \frac{{κμχ}^{2}}{1 - {κ}^{2}} & {g}_{1}^{p} & 0 \\ \frac{κμ}{1 - {κ}^{2}} & - \frac{{μ}^{2} {χ}^{2}}{1 - {κ}^{2}} & 0 & - {γ}_{2}^{p} μχ\end{matrix} ] [ \begin{matrix}{q}_{1} \\ {q}_{2} \\ {\dot{q}}_{1} \\ {\dot{q}}_{2}\end{matrix} ] = ℒ [ \begin{matrix}{q}_{1} \\ {q}_{2} \\ {\dot{q}}_{1} \\ {\dot{q}}_{2}\end{matrix} ] . \qquad ( SA . 4 )$$

The real and imaginary parts of the characteristic equation for the Liouvillian matrix are,

$$( 1 - {κ}^{2} ) {ω}_{λ}^{4} + {ω}_{λ}^{2} [ {g}_{1 , ∞}^{p} {γ}_{2}^{p} ρ ( 1 - {κ}^{2} ) - 1 - {ρ}^{2} ] + {ρ}^{2} = 0 , \qquad ( SA . 5 a )$$

$${g}_{1 , ∞}^{p} = {γ}_{2}^{p} ρ \frac{1 - {ω}_{λ}^{2} ( 1 - {κ}^{2} )}{{ρ}^{2} - {ω}_{λ}^{2} ( 1 - {κ}^{2} )} . \qquad ( SA . 5 b )$$

Substituting Eq. SA.5b into Eq. SA.5a yields

$${{ω}_{λ}^{6} ( 1 - {κ}^{2} )}^{2} - {ω}_{λ}^{4} [ ( 1 - {κ}^{2} ) ( 1 + 2 {ρ}^{2} ) - {{ρ}^{2} ( {γ}_{2}^{p} )}^{2} {( 1 - {κ}^{2} )}^{2} ] - {ω}_{λ}^{2} \{ {ρ}^{2} ( 1 - {κ}^{2} ) [ {( {γ}_{2}^{p} )}^{2} - 1 ] - {ρ}^{2} - {ρ}^{4} \} - {ρ}^{4} = 0 \qquad ( SA . 6 )$$

Eq. SA.6 is the characteristic polynomial whose solutions are the real steady-state modes. Since R_{eff}=(g_{1,∞}^{p})⁻¹\sqrt{L₁/C₁}, Eq. SA.5b can be rewritten to define R_{eff} as

$${R}_{eff} = \frac{{R}_{2}}{{χ}^{2}} \frac{{ρ}^{2} - {ω}_{λ}^{2} ( 1 - {κ}^{2} )}{1 - {ω}_{λ}^{2} ( 1 - {κ}^{2} )} . \qquad ( SA \text{.7} )$$

In the PT-symmetric case, ρ=χ=1. Assuming ω₁≠±\sqrt{1/(1−κ²)}, Eq. SA.5b yields g_{(l,h)}^{p}=γ₂^{p}. Substituting this condition into Eq. SA.5a, the real modes ω_{(l,h)} in Eq. 5c may be calculated. The third mode, ω₍ₘ₎, is found by noting that Eq. SA.6 assumes the denominator of Eq. SA.5b cannot be zero, which occurs at ω₍ₘ₎=±\sqrt{1/(1−κ²)}. Back-substituting this into Eq. SA.5a gives the gain

$${g}_{( m )}^{p} = ( 1 / {γ}_{2}^{p} ) [ \frac{1}{( 1 - {κ}^{2} )} - 1 ] ,$$

which when κ<<1 can be approximated by

$${g}_{( m )}^{p} \approx \frac{{κ}^{2}}{{γ}_{2}^{p}} .$$

In order to reach steady-state oscillation, the required gain cancels the effective loss seen by the negative resistance. From FIG. 39A-39B, mode-splitting occurs above a minimum coupling coefficient, κ_{EP}; coupling-independent operation is only possible above κ_{EP}. Based on derivations for γ₂^{p} at the exceptional point, κ_{EP} is derived by setting the term under the outer square root in Eq. 5c greater than or equal to zero, and solving for the conditions that allow this,

$${κ}_{EP} = \sqrt{1 - \frac{2 [ {( {γ}_{2}^{p} )}^{2} + 1 ] - 2 \sqrt{2 {( {γ}_{2}^{p} )}^{2} + 1}}{{( {γ}_{2}^{p} )}^{4}}} , {γ}_{2}^{p} \geq 0. \qquad ( SA \text{.8} )$$

As shown in FIG. 4A, κ_{EP}≤γ₂ when ρ=1. For κ>κ_{EP}, the effective resistance is coupling independent and constant at R_{eff}=R₂ for the two modes, ω_{(l,h)}. Conditions where κ≤κ_{EP} are henceforth defined as under-coupled; in this case, the only real mode is ω₍ₘ₎ and g₍ₘ₎ (and hence R_{eff,(m)}) is coupling-dependent.

### A.2. Middle Mode Energy Conservation

The middle mode does not obey energy conservation under mode-splitting and can therefore never sustain oscillations. This can be shown by assuming sinusoidal steady-state dependence, v₁∝e^{iω}^{_{λ}}^{τ} and v₂∝e^{iω}^{_{λ}}^{τ}. In this case, after substituting qₙ=CVₙ in Eqs. SA.3, the tuned (ρ=χ=μ=1) coupled-rate equations become,

$$- {ω}_{λ}^{2} {v}_{1} = - \frac{1}{1 - {κ}^{2}} {v}_{1} + \frac{κ}{1 - {κ}^{2}} {v}_{2} + i {ω}_{λ} {g}_{1 , ∞}^{p} {v}_{1} , \qquad ( SA \text{.9} a )$$

$$- {ω}_{λ}^{2} {v}_{2} = - \frac{1}{1 - {κ}^{2}} {v}_{2} + \frac{κ}{1 - {κ}^{2}} {v}_{1} + i {ω}_{λ} {g}_{2}^{p} {v}_{2} . \qquad ( SA \text{.9} b )$$

Eqs. SA.9 may be re-arranged to give two unique expressions for the voltage intensity ratio,

$$\frac{{\vert {v}_{1} \vert}^{2}}{{\vert {v}_{2} \vert}^{2}} = \frac{\frac{{κ}^{2}}{{( 1 - {κ}^{2} )}^{2}}}{{( \frac{1}{1 - {κ}^{2}} - {ω}_{λ}^{2} )}^{2} + {{ω}_{λ}^{2} ( {g}_{1 , ∞}^{p} )}^{2}} , \qquad ( SA \text{.10} a )$$

$$\frac{{\vert {v}_{1} \vert}^{2}}{{\vert {v}_{2} \vert}^{2}} = \frac{{( \frac{1}{1 - {κ}^{2}} - {ω}_{λ}^{2} )}^{2} + {{ω}_{λ}^{2} ( {γ}_{2}^{p} )}^{2}}{\frac{{κ}^{2}}{{( 1 - {κ}^{2} )}^{2}}} . \qquad ( SA \text{.10} b )$$

From Eqs. SA.10, the ratio of g_{1,∞}^{p} and γ₂^{p} can be solved for as follows:

$$\frac{{g}_{1 , ∞}^{p}}{{γ}_{2}^{p}} = \frac{{\vert {v}_{2} \vert}^{2}}{{\vert {v}_{1} \vert}^{2}} = \sqrt{\frac{\frac{{κ}^{2}}{{( 1 - {κ}^{2} )}^{2}} - {\frac{{\vert {v}_{1} \vert}^{2}}{{\vert {v}_{2} \vert}^{2}} [ \frac{1}{1 - {κ}^{2}} - {ω}_{λ}^{2} ]}^{2}}{\frac{{κ}^{2}}{{( 1 - {κ}^{2} )}^{2}} - {\frac{{\vert {v}_{2} \vert}^{2}}{{\vert {v}_{1} \vert}^{2}} [ \frac{1}{1 - {κ}^{2}} - {ω}_{λ}^{2} ]}^{2}}} . \qquad ( SA \text{.11} )$$

Substituting the middle eigenfrequency, ω₍ₘ₎=\sqrt{1/(1−κ²)} into Eq. SA.11 gives,

$$\frac{{g}_{( m )}^{p}}{{γ}_{2}^{p}} = \frac{{\vert {v}_{2} \vert}^{2}}{{\vert {v}_{1} \vert}^{2}} . \qquad ( SA \text{.12} )$$

Since |v₁|² and |v₂|² correspond to the energy stored in either resonator, conservation of energy stipulates |v₂|²≤|v₁|², or g₍ₘ₎^{p}/γ₂^{p}≤1. Therefore,

$$\frac{{\vert {v}_{2} \vert}^{2}}{{\vert {v}_{1} \vert}^{2}} = \frac{{g}_{( m )}^{p}}{{γ}_{2}^{p}} = \frac{1}{{( {γ}_{2}^{p} )}^{2}} ( \frac{1}{1 - {κ}^{2}} - 1 ) < 1. \qquad ( SA \text{.13} )$$

Eq. SA.13 translates to

$$κ < \sqrt{\frac{{( {γ}_{2}^{p} )}^{2}}{1 + {( {γ}_{2}^{p} )}^{2}}} . \qquad ( SA \text{.14} )$$

FIG. 40 depicts κ_{EP} as a function of γ₂^{p} (dashed line) and the red shaded region is where Eq. SA.14 (or equivalently, conservation of energy) is violated. The values of κ that satisfy Eq. SA.14 are essentially upper-bounded by κ_{EP} and, hence, the exact phase of PT-symmetry. Therefore, ω₍ₘ₎ violates conservation of energy in the exact phase of PT-symmetry, but not in under-coupled conditions, where it is the only stable mode.

### A.3. Series-Series Resonator Topology Derivations

Now, consider the series-series resonator topology, as shown in FIG. 38B. Applying KVL, the Liouvillian is obtained,

$$\frac{d}{d τ} [ \begin{matrix}{q}_{1} \\ {q}_{2} \\ {\dot{q}}_{1} \\ {\dot{q}}_{2}\end{matrix} ] = [ \begin{matrix}0 & 0 & 1 & 0 \\ 0 & 0 & 0 & 1 \\ - \frac{1}{1 - {κ}^{2}} & \frac{{κμχ}^{2}}{1 - {κ}^{2}} & \frac{{g}_{1}^{s}}{1 - {κ}^{2}} & \frac{{γ}_{2}^{s} κχ}{1 - {κ}^{2}} \\ \frac{κμ}{1 - {κ}^{2}} & - \frac{{μ}^{2} {χ}^{2}}{1 - {κ}^{2}} & - \frac{{g}_{1}^{s} κμ}{1 - {κ}^{2}} & - \frac{{γ}_{2}^{s} μχ}{1 - {κ}^{2}}\end{matrix} ] [ \begin{matrix}{q}_{1} \\ {q}_{2} \\ {\dot{q}}_{1} \\ {\dot{q}}_{2}\end{matrix} ] = ℒ [ \begin{matrix}{q}_{1} \\ {q}_{2} \\ {\dot{q}}_{1} \\ {\dot{q}}_{2}\end{matrix} ] . \qquad ( SA \text{.15} )$$

Note that for series resonators, due to duality, g₁^{s}=R₁\sqrt{C₁/L₁} and γ₂^{s}=R₂\sqrt{C₂/L₂}. The real and imaginary parts of the characteristic equation for this Liouvillian matrix are,

$$( 1 - {κ}^{2} ) {ω}_{λ}^{4} + {ω}_{λ}^{2} ( {g}_{1 , ∞}^{s} {γ}_{2}^{s} ρ - 1 - {ρ}^{2} ) + {ρ}^{2} = 0 , \qquad ( SA \text{.16} a )$$

$${g}_{1 , ∞}^{s} = {γ}_{2}^{s} ρ \frac{1 - {ω}_{λ}^{2}}{{ρ}^{2} - {ω}_{λ}^{2}} . \qquad ( SA \text{.16} b )$$

Eq. SA. 16b can be rewritten to define R_{eff} as

$${R}_{eff} = {R}_{2} {μ}^{2} \frac{1 - {ω}_{λ}^{2}}{{ρ}^{2} - {ω}_{λ}^{2}} . \qquad ( SA \text{.17} )$$

As suggested by Eq. SA.17, if ρ=1 (exact PT-symmetry), R_{eff}=R₂μ², which is independent of κ, and if μ=1, then R_{eff}=R₂. Substituting Eq. SA.16b into Eq. SA.16a yields the following mode solutions,

$${ω}_{( h , l )} = \pm \sqrt{\frac{2 - {( {γ}_{2}^{s} )}^{2} \pm \sqrt{{[ 2 - {( {γ}_{2}^{s} )}^{2} ]}^{2} - 4 ( 1 - {κ}^{2} )}}{2 ( 1 - {κ}^{2} )}} \qquad ( SA \text{.18} )$$

assuming ω_{γ}≠1. This ω_{λ} is the third mode, ω₍ₘ₎=±1; back substituting this mode into Eq. SA.16a gives the required gain, g₍ₘ₎^{s}=κ²/γ₂^{s}. FIGS. 41A-41B show these modes, illustrating one real mode for κ<κ_{EP} and three for κ>κ_{EP}. In the mode-split regime, the third mode, ω₍ₘ₎ is unstable and will only exist for κ<κ_{EP}. Eq. SA.18 gives the following minimum coupling and loss range for mode-splitting,

$${κ}_{EP} = \frac{1}{2} \sqrt{4 {( {γ}_{2}^{s} )}^{2} - {( {γ}_{2}^{s} )}^{4}} , 0 \leq {γ}_{2}^{s} \leq \sqrt{2} . \qquad ( SA \text{.19} )$$

This implies that κ_{EP}<γ₂^{s}. Similar to the parallel-parallel case, the effective resistance under mode-splitting is coupling-independent and constant at R_{eff}=R₂ for the two modes ω_{(l,h)} in Eq. SA.18 (see FIG. 41B).

### A.4. Sensing Range for Parallel-Parallel and Series-Series Resonator Topologies

Input impedances of the series and the parallel sensor resonators are shown in FIGS. 42A-42B. For the series resonator, the complex impedance magnitude, |Zₛ|=|Rₛ+i[ωL−1/(ωC)]|, is minimized at resonance whereas for the parallel resonator, the complex impedance magnitude,

$$\vert {Z}_{p} \vert = \vert {[ \frac{1}{{R}_{p}} + i ( ω C - \frac{1}{ω L} ) ]}^{- 1} \vert ,$$

is maximized at resonance as shown in FIGS. 42C-42D; the inverse relationship is a consequence of duality.

Coupling-independent sensor measurement requires operation beyond κ_{EP} which is determined by the loss parameter

$$( {γ}^{p} = {( {R}_{p} )}^{- 1} \sqrt{\frac{L}{C}}$$

and γ^{s}=Rₛ\sqrt{C/L} for the parallel and series resonators, respectively). This translates to a maximum sensing distance, dₘₐₓ, that determines the range of measurable resistance. Since the loss parameters of the two resonators are inversely related, the sensing dynamic range also exhibits opposing trends: R_{2,max}<Rₚ<∞ and 0<Rₛ<R_{2,min} for the parallel and series resonators, respectively, as shown in FIGS. 42C-42D. This suggests that the parallel resonator is well-suited for larger resistance values, while the series resonator is better-suited for smaller resistances. Due to the infinite maximum range, the parallel resonator offers a wider sensing dynamic range than the series resonator. FIG. 3B further illustrates this through the respective κ_{EP} for the parallel-parallel and series-series resonator topologies, assuming the same resistance.

### A.5. Series-Parallel and Parallel-Series Resonator Topologies Derivations

First, consider the series-parallel topology as shown in FIG. 38C. Using KVL and KCL, the Liouvillian is obtained,

$$\frac{d}{d τ} [ \begin{matrix}{q}_{1} \\ {q}_{2} \\ {\dot{q}}_{1} \\ {\dot{q}}_{2}\end{matrix} ] = [ \begin{matrix}0 & 0 & 1 & 0 \\ 0 & 0 & 0 & 1 \\ - \frac{1}{1 - {κ}^{2}} & - \frac{{κμχ}^{2}}{1 - {κ}^{2}} & \frac{{g}_{1}^{s}}{1 - {κ}^{2}} & 0 \\ - \frac{κμ}{1 - {κ}^{2}} & - \frac{{μ}^{2} {χ}^{2}}{1 - {κ}^{2}} & \frac{{g}_{1}^{s} κμ}{1 - {κ}^{2}} & - {γ}_{2}^{p} μχ\end{matrix} ] [ \begin{matrix}{q}_{1} \\ {q}_{2} \\ {\dot{q}}_{1} \\ {\dot{q}}_{2}\end{matrix} ] = ℒ [ \begin{matrix}{q}_{1} \\ {q}_{2} \\ {\dot{q}}_{1} \\ {\dot{q}}_{2}\end{matrix} ] . \qquad ( SA \text{.20} )$$

The real and imaginary parts of the characteristic equation for this Liouvillian matrix are,

$$( 1 - {κ}^{2} ) {ω}_{λ}^{4} + {ω}_{λ}^{2} ( {g}_{1 , ∞}^{s} {γ}_{2}^{p} ρ - 1 - {ρ}^{2} ) + {ρ}^{2} = 0 , \qquad ( SA \text{.21} a )$$

$${g}_{1 , ∞}^{s} = {γ}_{2}^{p} ρ \frac{1 - {ω}_{λ}^{2} ( 1 - {κ}^{2} )}{{ρ}^{2} - {ω}_{λ}^{2}} . \qquad ( SA \text{.21} b )$$

Eq. SA.21b can be re-written to define R_{eff} as,

$${R}_{eff} = \frac{{L}_{1}}{{R}_{2} {C}_{2}} \frac{1 - {ω}_{λ}^{2} ( 1 - {κ}^{2} )}{{ρ}^{2} - {ω}_{λ}^{2}} \qquad ( SA \text{.22} )$$

Assuming ρ=1 and substituting Eq. SA.21b into Eq. SA.21a yields the solutions for real modes under exact PT-symmetry since g_{1,∞}^{s} is now a function of ω_{λ}, a closed-form solution is no longer instructive. Instead, the numerical solutions are shown in FIGS. 43A-43B.

From FIGS. 43A-43B, the presence of mode-splitting occurs only above the minimum coupling coefficient, κ_{EP}. However, unlike the parallel-parallel and series-series cases where κ_{EP}≤γ₂^{p,2}, minimum coupling occurs for κ_{EP}>γ₂^{p}. Additionally, the effective resistance under mode-splitting is no longer constant for any of the three modes. Therefore, for any κ, the effective resistance is coupling-dependent, rendering the series-parallel resonator topology ineffective for coupling-independent resistive sensing.

Next, consider the series-parallel topology as shown in FIG. 38D. Using KVL and KCL, the Liouvillian is obtained,

$$\frac{d}{d τ} [ \begin{matrix}{q}_{1} \\ {q}_{2} \\ {\dot{q}}_{1} \\ {\dot{q}}_{2}\end{matrix} ] = [ \begin{matrix}0 & 0 & 1 & 0 \\ 0 & 0 & 0 & 1 \\ - \frac{1}{1 - {κ}^{2}} & - \frac{{κμχ}^{2}}{1 - {κ}^{2}} & {g}_{1}^{p} & - \frac{{γ}_{2}^{s} κχ}{1 - {κ}^{2}} \\ - \frac{κμ}{1 - {κ}^{2}} & - \frac{{μ}^{2} {χ}^{2}}{1 - {κ}^{2}} & 0 & - \frac{{γ}_{2}^{s} μχ}{1 - {κ}^{2}}\end{matrix} ] [ \begin{matrix}{q}_{1} \\ {q}_{2} \\ {\dot{q}}_{1} \\ {\dot{q}}_{2}\end{matrix} ] = ℒ [ \begin{matrix}{q}_{1} \\ {q}_{2} \\ {\dot{q}}_{1} \\ {\dot{q}}_{2}\end{matrix} ] . \qquad ( SA \text{.23} )$$

The real and imaginary parts of the characteristic equation for this Liouvillian matrix are,

$$( 1 - {κ}^{2} ) {ω}_{λ}^{4} + {ω}_{λ}^{2} ( {g}_{1 , ∞}^{p} {γ}_{2}^{s} ρ - 1 - {ρ}^{2} ) + {ρ}^{2} = 0 , \qquad ( SA \text{.24} a )$$

$${g}_{1 , ∞}^{p} = {γ}_{2}^{s} ρ \frac{1 - {ω}_{λ}^{2}}{{ρ}^{2} - {ω}_{λ}^{2} ( 1 - {κ}^{2} )} . \qquad ( SA \text{.24} b )$$

Eq. SA.24b can be re-written to define R_{eff} as,

$${R}_{eff} = \frac{{L}_{2}}{{R}_{2} {C}_{1}} \frac{{ρ}^{2} - {ω}_{λ}^{2} ( 1 - {κ}^{2} )}{1 - {ω}_{λ}^{2}} \qquad ( SA \text{.25} )$$

Assuming ρ=1 and substituting Eq. SA.24b into Eq. SA.24a yields the solutions for the steady-state, real modes under exact PT-symmetry. The g_{1,∞}^{p} is now a function of ω_{λ}, numerical solutions are thus shown in FIGS. 44A-44B.

From FIGS. 44A-44B, the presence of mode-splitting occurs only above the minimum coupling coefficient, κ_{EP}. However, unlike the other topologies, a maximum coupling is observed, past which mode splitting no longer occurs. Additionally, the effective resistance within mode-split region is not constant for any of the three modes. Therefore, for any κ, the effective resistance is coupling-dependent, rendering the parallel-series resonator topology ineffective for coupling-independent resistive sensing.

### Appendix B: Error-Correction Algorithm for Detuned Conditions Using Multiple Discrete Measurements

The governing equations for the parallel-parallel resonator topology are given by Eqs. 3. These equations are converted to include the circuit element parameters, arriving at the following functions, f₁ and f₂,

$${f}_{1} = ( 1 - {κ}^{2} ) {ω}_{λ}^{4} - {ω}_{λ}^{2} [ {ω}_{1}^{2} + {ω}_{2}^{2} - \frac{{ω}_{1}^{2} {ω}_{2}^{2} {L}_{1} {L}_{2} ( 1 - {κ}^{2} )}{{R}_{1} {R}_{2}} ] + {ω}_{1}^{2} {ω}_{2}^{2} = 0 \qquad ( SB \text{.1} a )$$

$${f}_{2} = {R}_{1} - {{R}_{2} ( \frac{{ω}_{1}}{{ω}_{2}} )}^{2} \frac{{L}_{1}}{{L}_{2}} \frac{{ω}_{2}^{2} - {ω}_{λ}^{2} ( 1 - {κ}^{2} )}{{ω}_{1}^{2} - {ω}_{λ}^{2} ( 1 - {κ}^{2} )} = 0 \qquad ( SB \text{.1} b )$$

For each measurement point, assuming non-PT-symmetric conditions, there are three known parameters, R₁=R_{eff}, from the amplitude measurement; ω_{λ}, from the frequency measurement; and ω₁, the resonant frequency of the reader, known a priori by design. Additionally, identical sensor and reader coils are assumed (L₁=L₂). There are, therefore, three unknowns: κ, R₂, and ω₂, temporarily rendering the problem unsolvable. Nonetheless, performing measurements at two different coupling strengths, κ₁ and κ₂, results in a system of four equations and four unknowns (κ₁, κ₂, R₂, and ω₂) which can be solved using the generalized Newton-Raphson method. Using Eqs. SB.1, functions f₁₁, f₁₂ are defined corresponding to the first measurement and f₂₁, f₂₂ are defined corresponding to the second measurement as,

$${f}_{11} = ( 1 - {κ}_{1}^{2} ) {ω}_{11}^{4} - {ω}_{11}^{2} ( {ω}_{1}^{2} + {ω}_{2}^{2} - \frac{{ω}_{1}^{2} {ω}_{2}^{2} {L}_{1} {L}_{2} ( 1 - {κ}_{1}^{2} )}{{R}_{11} {R}_{2}} ) + {ω}_{1}^{2} {ω}_{2}^{2} = 0 \qquad ( SB \text{.2} )$$

$${f}_{12} = {R}_{11} - {{R}_{2} ( \frac{{ω}_{1}}{{ω}_{2}} )}^{2} \frac{{L}_{1}}{{L}_{2}} \frac{{ω}_{2}^{2} - {ω}_{11}^{2} ( 1 - {κ}_{1}^{2} )}{{ω}_{1}^{2} - {ω}_{11}^{2} ( 1 - {κ}_{1}^{2} )} = 0$$

$${f}_{21} = ( 1 - {κ}_{2}^{2} ) {ω}_{21}^{4} - {ω}_{21}^{2} ( {ω}_{1}^{2} + {ω}_{2}^{2} - \frac{{ω}_{1}^{2} {ω}_{2}^{2} {L}_{1} {L}_{2} ( 1 - {κ}_{2}^{2} )}{{R}_{21} {R}_{2}} ) + {ω}_{1}^{2} {ω}_{2}^{2} = 0$$

$${f}_{22} = {R}_{21} - {{R}_{2} ( \frac{{ω}_{1}}{{ω}_{2}} )}^{2} \frac{{L}_{1}}{{L}_{2}} \frac{{ω}_{2}^{2} - {ω}_{21}^{2} ( 1 - {κ}_{2}^{2} )}{{ω}_{1}^{2} - {ω}_{21}^{2} ( 1 - {κ}_{2}^{2} )} = 0$$

in which (R₁₁, ω₁₁) and (R₂₁, ω₂₁) correspond to the resistance and the frequency measured from the first and second measurements, respectively. f is defined as f=[f₁₁ f₁₂ f₂₁ f₂₂]^{T}. This method requires the computation of the Jacobian matrix,

$$J = [ \begin{matrix}{J}_{11} & {J}_{12} & {J}_{13} & {J}_{14} \\ {J}_{21} & {J}_{22} & {J}_{23} & {J}_{24} \\ {J}_{31} & {J}_{32} & {J}_{33} & {J}_{34} \\ {J}_{41} & {J}_{42} & {J}_{43} & {J}_{44}\end{matrix} ] = [ \begin{matrix}\frac{\partial {f}_{11}}{\partial {R}_{2}} & \frac{\partial {f}_{11}}{\partial {ω}_{2}} & \frac{\partial {f}_{11}}{\partial {κ}_{1}} & 0 \\ \frac{\partial {f}_{12}}{\partial {R}_{2}} & \frac{\partial {f}_{12}}{\partial {ω}_{2}} & \frac{\partial {f}_{12}}{\partial {κ}_{1}} & 0 \\ \frac{\partial {f}_{21}}{\partial {R}_{2}} & \frac{\partial {f}_{21}}{\partial {ω}_{2}} & 0 & \frac{\partial {f}_{21}}{\partial {κ}_{2}} \\ \frac{\partial {f}_{22}}{\partial {R}_{2}} & \frac{\partial {f}_{22}}{\partial {ω}_{2}} & 0 & \frac{\partial {f}_{22}}{\partial {κ}_{2}}\end{matrix} ] . \qquad ( SB \text{.3} )$$

The vector of initial conditions, x⁽⁰⁾=[R₂ ω₂ κ₁ κ₂]^{T}, is calculated by assuming R=400 Ω, ω₁=ω₂,

$${κ}_{1} = \vert {( \frac{{ω}_{1}}{{ω}_{11}} )}^{2} - 1 \vert , and {κ}_{2} = \vert {( \frac{{ω}_{1}}{{ω}_{21}} )}^{2} - 1 \vert .$$

Then, it is possible to compute

$$Δ {x}^{( 0 )} = - {[ {J}^{( 0 )} ]}^{- 1} f ( {x}^{( 0 )} ) \qquad ( SB \text{.4} )$$

and write x⁽¹⁾=x⁽⁰⁾+Δx⁽⁰⁾ which gives the updated vector x; the iteration is then continued ten times to achieve a sufficiently small variation in x. This process can be applied to more than two measurements, in which the computed value from the previous measurement is used as initial condition for the next measurement.

### Appendix C: Nonlinear Gain Theory

The g₁(·) in Eq. 1a is described by the nonlinear i-v relationship of the negative resistance created by the cross-coupled MOS pair in FIG. 45A. The negative resistance is defined by the differential voltage, v_{od}=vₒ₂−vₒ₁, and the current through the drain of M₁, i_{d1}. This current may be examined as a function of the input differential voltage for an MOS differential pair. Using KVL and assuming identical transistors with identical threshold voltages, Vₜₕ₁=Vₜₕ₂, vᵢ₁−v_{gs1}+v_{gs2}−vᵢ₂=0→v_{id}=vᵢ₁−vᵢ₂=V_{od1}−V_{od2}, where v_{id} is the input differential voltage and V_{od,n} is the overdrive voltage for transistor Mₙ. Here, since the transistors are identical,

$${[ {μ}_{n} {C}_{ox} ( \frac{W}{L} ) ]}_{1} = {[ {μ}_{n} {C}_{ox} ( \frac{W}{L} ) ]}_{2} = 2 k ,$$

and v_{id} can be defined as,

$${v}_{id} = \sqrt{\frac{{i}_{d 1}}{k}} - \sqrt{\frac{{i}_{d 2}}{k}} . \qquad ( SC \text{.1} )$$

i_{d1}, i_{d2}, and I_{Tail} can be related using KCL: i_{d1}+i_{d2}=I_{Tail}→i_{d2}=I_{Tail}−i_{d1}. Solving for i_{d1} yields,

$${i}_{d 1} = \frac{{I}_{Tail}}{2} + {v}_{id} \sqrt{\frac{{kI}_{Tail}}{2}} \sqrt{1 - {( \sqrt{\frac{k}{2 {I}_{Tail}}} {v}_{id} )}^{2}} . \qquad ( SC . 2 )$$

The overdrive voltage of each transistor when v_{id}=−v_{od}=0, is Vₒᵥ=\sqrt{I_{Tail}/(2k)} and the transconductance of the transistors is gₘₒ=\sqrt{2kI_{Tail}}. v_{id}=−v_{od}=−v₁ is replaced and the quiescent dc current, I_{Tail}/2, is removed to solve for the ac contribution, arriving at

$${i}_{d 1} = - {v}_{1} \frac{{g}_{mo}}{2} \sqrt{1 - {( \frac{{v}_{1}}{2 {V}_{ov}} )}^{2}} = {v}_{1} \frac{1}{{R}_{1 , 0}} \sqrt{1 - {( \frac{{v}_{1}}{2 {V}_{ov}} )}^{2}} , \qquad ( SC . 3 )$$

where R_{1,0}=−2/gₘₒ is the initial negative resistance. Eq. SC.3 assumes both transistors are in saturation. However, when |v₁|>\sqrt{2}Vₒᵥ, one transistor enters the cut-off region and the ac current swings at ±I_{Tail}/2 resulting in the following piece-wise i-v relationship,

$${i}_{d 1} = \{ \begin{matrix}\frac{{I}_{Tail}}{2} , & {v}_{1} < - \sqrt{2} {V}_{ov} \\ \frac{{v}_{1}}{{R}_{1 , 0}} \sqrt{1 - {( \frac{{v}_{1}}{2 {V}_{ov}} )}^{2}} , & - \sqrt{2} {V}_{ov} \leq {v}_{1} \leq \sqrt{2} {V}_{ov} \\ - \frac{{I}_{Tail}}{2} , & \sqrt{2} {V}_{ov} < {v}_{1}\end{matrix} . \qquad ( SC . 4 )$$

In the tuned case (ρ=χ=μ=1),

$${g}_{1 , 0}^{p} = - {( {R}_{1 , 0 )} )}^{- 1} \sqrt{\frac{L}{C}} = ( \frac{{g}_{mO} )}{2} ) \sqrt{\frac{L}{C}} .$$

### Therefore,

$${g}_{1}^{p} ( {v}_{1} ) = ( \frac{{g}_{m} ( {v}_{1} )}{2} ) \sqrt{\frac{L}{C}} .$$

### Additionally,

$${g}_{m} ( {v}_{1} ) = \frac{{di}_{d 1}}{{dv}_{1}} ,$$

where v₁=q₁/C₁. Consequently, g₁^{p}(·), is the voltage (or, equivalently, charge) derivative of the i-v relationship,

$${g}_{1}^{p} ( {v}_{1} ) = \{ \begin{matrix}0 , & {v}_{1} < - \sqrt{2} {V}_{ov} \\ {g}_{1 , 0}^{p} \frac{1 - {( \frac{{v}_{1}}{\sqrt{2} {V}_{ov}} )}^{2}}{\sqrt{1 - {( \frac{{v}_{1}}{2 {V}_{ov}} )}^{2}}} , & - \sqrt{2} {V}_{ov} \leq {v}_{1} \leq \sqrt{2} {V}_{ov} \\ 0 , & \sqrt{2} {V}_{ov} < {v}_{1}\end{matrix} . \qquad ( SC . 5 )$$

The piece-wise nature of these i-v relationships, however, gives rise to numerical integration issues in MATLAB's ordinary differential equation (ODE) suite when the first or second derivatives are discontinuous. In this case, the second derivative is not continuous at the boundaries v₁=±\sqrt{2}Vₒᵥ. In order to solve this issue, the discontinuous i-v relationship of the MOS cross-coupled pair is approximated with that of a BJT pair (see FIG. 45B). To this end, the i-v relationship of a BJT cross-coupled pair is derived, in which the collector current is related to v₁ through,

$${i}_{c 1} = \frac{{I}_{Tail}}{2} tan h [ \frac{{v}_{1}}{2 {V}_{T}} ] , \qquad ( SC . 6 )$$

where V_{T}≈25 mV is the thermal voltage. For the BJT, gₘₒ=i_{c1}/V_{T} where i_{c1}=I_{Tail}/2 is the dc current through transistor Q₁. Eq. SC.6 can be re-written in terms of the initial design value of the negative resistance, R_{1,0}=−2/gₘ₀,

$${i}_{c 1} = \frac{2 {V}_{T}}{{R}_{1 , 0}} tan h [ \frac{{v}_{1}}{2 {V}_{T}} ] . \qquad ( SC . 7 )$$

The nonlinear gain is found as the voltage (or, charge) derivative of the i-v relationship,

$${g}_{1}^{p} ( {v}_{1} ) = {g}_{1 , 0}^{p} {sech}^{2} [ \frac{{v}_{1}}{2 {V}_{T}} ] , \qquad ( SC . 8 )$$

where the initial gain may be written in a number of equivalent forms,

$${g}_{1 , 0}^{p} = - {( {R}_{1 , 0} )}^{- 1} \sqrt{\frac{L}{C}} = {I}_{Tail} / ( 4 {V}_{T} ) \sqrt{L / C} .$$

Now, we check how well the MOS i-v curve is approximated by the BJT i-v curve. From the experimental setup, k=0.23611 A/V², I_{Tail}=1.78 mA, L=2.3 μH, C=220 pF, resulting in g_{1,0}^{p}=\sqrt{(kI_{Tail})/2}\sqrt{L/C}≈1.5; using these same numbers with the BJT implementation gives

$${g}_{1 , 0}^{p} = {I}_{Tail} / ( 4 {V}_{T} ) \sqrt{\frac{L}{C}} \approx 1.8 .$$

The normalized i-v and g₁^{p}-v curves in FIGS. 46A-46B verify that not only do the BJT and MOS cases saturate at the same values of drain/collector current, they also exhibit very similar characteristics in the linear region. Therefore, the hyperbolic tangent response of the BJT implementation is predictive of the MOS circuit behavior; as an added bonus, the function is smooth, avoiding numerical integration issues.

One way to verify the steady-state gain predicted by the fast-time solution (Eq. 2b), is to examine the steady-state reader-side voltage amplitude. The compressive i-v relationship given by Eq. SC.5 results in drain currents that are approximately square waves; the action of the coupled resonators then filters these square waves to their fundamental components. From Fourier Analysis, the resulting sinusoid has an amplitude that is 4/π larger than the amplitude, A, of the square wave (see FIG. 45C). Assuming the cross-coupled pair sees an effective resistance, R_{eff}, presented by the lossy resonator through the coupling mechanism (neglecting parasitic capacitances of the MOS transistors and assuming ρ=χ=μ=1), the amplitude of the output differential voltage is,

$${V}_{1} = \frac{4}{π} {I}_{Tail} \frac{{R}_{eff}}{2} . \qquad ( SC . 9 )$$

Here, the factor of 2 is due to the fact that R_{eff} is the differential resistance. The I_{Tail} may be re-written using one of the equivalent forms of g_{1,0}^{p},

$${V}_{1} = \frac{8 {V}_{T} {g}_{1 , 0}^{p}}{π} {R}_{eff} \sqrt{C / L} . \qquad ( SC . 10 )$$

In steady state, R_{eff}=(g_{1,∞}^{p})⁻¹\sqrt{L/C}, resulting in a formula for the expected effective resistance based on the measured voltage amplitude, V₁,

$$\frac{{g}_{1 , ∞}^{p}}{{γ}_{2}^{p}} = \frac{8 {V}_{T}}{π} \frac{{g}_{1 , 0}^{p}}{{V}_{1} {γ}_{2}^{p}} \to \frac{{R}_{eff}}{{R}_{2}} = \frac{π}{8 {V}_{T}} \frac{{V}_{1} {γ}_{2}^{p}}{{g}_{1 , 0}^{p}} . \qquad ( SC . 11 )$$

FIG. 6A shows the transient evolution of R_{eff}, suggesting that the normalized resistance in Eq. SC.11 settles at unity in steady-state for κ>κ_{EP}.

### Appendix D: Implementation and Setup

FIGS. 47A and 47B show the reader and sensor implementation for the real-time single-point sensing measurement, while FIGS. 47C and 47D illustrate the setup for wireless temperature sensing measurement. The measured settling behavior of the reader is shown in FIG. 48, in which the resulting self-oscillation waveform and the measured amplitude are presented when a transition is made from R₂=302Ω to R₂=477Ω. FIG. 48 confirms the real-time sensing capability given the output voltage of the negative resistance settles within roughly 4 μs after the sensor's resistance is altered, matching the fast-settling behavior seen in transient simulations (see FIG. 6B). The envelope detector (ED) takes longer to settle (approximately 40 μs); this is due to the choice of R_{ED} and C_{ED} in FIG. 7 as a trade-off between settling time and power consumption and attenuation of the higher order harmonics.

### Aspects

1. A system, comprising: a coupled pair of resonators including a sensor resonator and a reader resonator, the sensor resonator including a resistor, and the sensor resonator having a loss associated with the resistor, and the reader resonator including a metal-oxide-semiconductor (MOS) cross-coupled pair, wherein the MOS cross-coupled pair is configured to implement a nonlinear gain of the reader resonator via compressive saturation of negative resistance; an amplitude detector configured to measure an amplitude of oscillations associated with the reader resonator; a processor; and a memory storing instructions, that, when executed by the processor, cause the processor to: receive the measured amplitude of oscillations associated with the reader resonator from the amplitude detector; determine the negative resistance provided by the MOS cross-coupled pair based on the measured amplitude of oscillations associated with the reader resonator when the measured amplitude of oscillations associated with the reader resonator reaches a steady state; and determine the resistance associated with the resistor of the sensor resonator based on the determined negative resistance provided by the MOS cross-coupled pair when the measured amplitude of oscillations associated with the reader resonator reaches the steady state.

2. The system of aspect 1, wherein the sensor resonator has a series topology and the reader resonator also has a series topology.

3. The system of aspect 1, wherein the sensor resonator has a parallel topology and the reader resonator also has a parallel topology.

4. The system of any of aspects 1-3, wherein the resistor of the sensor resonator is a resistive sensor.

5. The system of aspect 4, wherein the instructions, when executed by the processor, further cause the processor to determine an indication of a measurement made by the resistive sensor based on the determined negative resistance provided by the MOS cross-coupled pair when the measured amplitude of oscillations associated with the reader resonator reaches the steady state.

6. The system of any of aspects 1-5, wherein the sensor resonator further includes a capacitor.

7. The system of aspect 6, wherein the capacitor is a capacitive sensor.

8. The system of aspect 7, wherein the instructions, when executed by the processor, further cause the processor to determine an indication of a measurement made by the capacitive sensor based on the determined negative resistance provided by the MOS cross-coupled pair when the measured amplitude of oscillations associated with the reader resonator reaches the steady state.

9. The system of any of aspects 1-8, further comprising a divider configured to measure a frequency of oscillations associated with the reader resonator.

10. The system of aspect 9, wherein the instructions, when executed by the processor, further cause the processor to: receive respective measured amplitudes of oscillations associated with the reader resonator from the amplitude detector when the reader resonator and sensor resonator are placed at each of a plurality of distances apart; receive respective measured frequencies of oscillations associated with the reader resonator from the divider when the reader resonator and sensor resonator are placed at each of the plurality of distances apart; and determine an error in the determined resistance based on the respective measured amplitudes and respective measured frequencies at each of the plurality of distances apart.

11. A method, comprising: implementing, by a metal-oxide-semiconductor (MOS) cross-coupled pair, a nonlinear gain in a reader resonator, of a coupled pair including the reader resistor and a sensor resistor, via compressive saturation of negative resistance, wherein the sensor resonator includes a resistor and has a loss associated with the resistor; measuring, by an amplitude detector, an amplitude of oscillations associated with the reader resonator; determining, by a processor, the negative resistance provided by the MOS cross-coupled pair based on the measured amplitude of oscillations associated with the reader resonator when the measured amplitude of oscillations associated with the reader resonator reaches a steady state; and determining, by a processor, the resistance associated with the resistor of the sensor resonator based on the determined negative resistance provided by the MOS cross-coupled pair when the measured amplitude of oscillations associated with the reader resonator reaches the steady state.

12. The method of aspect 11, wherein the sensor resonator has a series topology and the reader resonator also has a series topology.

13. The method of aspect 11, wherein the sensor resonator has a parallel topology and the reader resonator also has a parallel topology.

14. The method of any of aspects 11-13, wherein the resistor of the sensor resonator is a resistive sensor.

15. The method of aspect 14, further comprising determining an indication of a measurement made by the resistive sensor based on the determined negative resistance provided by the MOS cross-coupled pair when the measured amplitude of oscillations associated with the reader resonator reaches the steady state.

16. The method of any of aspects 11-15, wherein the sensor resonator further includes a capacitor.

17. The method of aspect 16, wherein the capacitor is a capacitive sensor.

18. The method of aspect 17, further comprising determining an indication of a measurement made by the capacitive sensor based on the determined negative resistance provided by the MOS cross-coupled pair when the measured amplitude of oscillations associated with the reader resonator reaches the steady state.

19. The method of any of aspects 11-18, further comprising measuring, by a divider, a frequency of oscillations associated with the reader resonator.

20. The method of aspect 19, further comprising: receiving respective measured amplitudes of oscillations associated with the reader resonator from the amplitude detector when the reader resonator and sensor resonator are placed at each of a plurality of distances apart; receiving respective measured frequencies of oscillations associated with the reader resonator from the divider when the reader resonator and sensor resonator are placed at each of the plurality of distances apart; and determining an error in the determined resistance based on the respective measured amplitudes and respective measured frequencies at each of the plurality of distances apart.

What is claimed is:

1. A system, comprising:
a coupled pair of resonators including a sensor resonator and a reader resonator, the sensor resonator including a resistor, and the sensor resonator having a loss associated with the resistor, and the reader resonator including a metal-oxide-semiconductor (MOS) cross-coupled pair, wherein the MOS cross-coupled pair is configured to implement a nonlinear gain of the reader resonator via compressive saturation of negative resistance;
an amplitude detector configured to measure an amplitude of oscillations associated with the reader resonator;
a processor; and
a memory storing instructions, that, when executed by the processor, cause the processor to:
receive the measured amplitude of oscillations associated with the reader resonator from the amplitude detector;
determine the negative resistance provided by the MOS cross-coupled pair based on the measured amplitude of oscillations associated with the reader resonator when the measured amplitude of oscillations associated with the reader resonator reaches a steady state; and
determine the resistance associated with the resistor of the sensor resonator based on the determined negative resistance provided by the MOS cross-coupled pair when the measured amplitude of oscillations associated with the reader resonator reaches the steady state.

2. The system of claim 1, wherein the sensor resonator has a series topology and the reader resonator also has a series topology.

3. The system of claim 1, wherein the sensor resonator has a parallel topology and the reader resonator also has a parallel topology.

4. The system of claim 1, wherein the resistor of the sensor resonator is a resistive sensor.

5. The system of claim 4, wherein the instructions, when executed by the processor, further cause the processor to determine an indication of a measurement made by the resistive sensor based on the determined negative resistance provided by the MOS cross-coupled pair when the measured amplitude of oscillations associated with the reader resonator reaches the steady state.

6. The system of claim 1, wherein the sensor resonator further includes a capacitor.

7. The system of claim 6, wherein the capacitor is a capacitive sensor.

8. The system of claim 7, wherein the instructions, when executed by the processor, further cause the processor to determine an indication of a measurement made by the capacitive sensor based on the determined negative resistance provided by the MOS cross-coupled pair when the measured amplitude of oscillations associated with the reader resonator reaches the steady state.

9. The system of claim 1, further comprising a divider configured to measure a frequency of oscillations associated with the reader resonator.

10. The system of claim 9, wherein the instructions, when executed by the processor, further cause the processor to:
receive respective measured amplitudes of oscillations associated with the reader resonator from the amplitude detector when the reader resonator and sensor resonator are placed at each of a plurality of distances apart;
receive respective measured frequencies of oscillations associated with the reader resonator from the divider when the reader resonator and sensor resonator are placed at each of the plurality of distances apart; and
determine an error in the determined resistance based on the respective measured amplitudes and respective measured frequencies at each of the plurality of distances apart.

11. A method, comprising:
implementing, by a metal-oxide-semiconductor (MOS) cross-coupled pair, a nonlinear gain in a reader resonator, of a coupled pair including the reader resistor and a sensor resistor, via compressive saturation of negative resistance,
wherein the sensor resonator includes a resistor and has a loss associated with the resistor;
measuring, by an amplitude detector, an amplitude of oscillations associated with the reader resonator;
determining, by a processor, the negative resistance provided by the MOS cross-coupled pair based on the measured amplitude of oscillations associated with the reader resonator when the measured amplitude of oscillations associated with the reader resonator reaches a steady state; and
determining, by a processor, the resistance associated with the resistor of the sensor resonator based on the determined negative resistance provided by the MOS cross-coupled pair when the measured amplitude of oscillations associated with the reader resonator reaches the steady state.

12. The method of claim 11, wherein the sensor resonator has a series topology and the reader resonator also has a series topology.

13. The method of claim 11, wherein the sensor resonator has a parallel topology and the reader resonator also has a parallel topology.

14. The method of claim 11, wherein the resistor of the sensor resonator is a resistive sensor.

15. The method of claim 14, further comprising determining an indication of a measurement made by the resistive sensor based on the determined negative resistance provided by the MOS cross-coupled pair when the measured amplitude of oscillations associated with the reader resonator reaches the steady state.

16. The method of claim 11, wherein the sensor resonator further includes a capacitor.

17. The method of claim 16, wherein the capacitor is a capacitive sensor.

18. The method of claim 17, further comprising determining an indication of a measurement made by the capacitive sensor based on the determined negative resistance provided by the MOS cross-coupled pair when the measured amplitude of oscillations associated with the reader resonator reaches the steady state.

19. The method of claim 11, further comprising measuring, by a divider, a frequency of oscillations associated with the reader resonator.

20. The method of claim 19, further comprising:
receiving respective measured amplitudes of oscillations associated with the reader resonator from the amplitude detector when the reader resonator and sensor resonator are placed at each of a plurality of distances apart;
receiving respective measured frequencies of oscillations associated with the reader resonator from the divider when the reader resonator and sensor resonator are placed at each of the plurality of distances apart; and
determining an error in the determined resistance based on the respective measured amplitudes and respective measured frequencies at each of the plurality of distances apart.
